(19) United States
(12) Patent Application Publication
(10) Pub. No.: US 2020/0302422 A1
(43) Pub. Date: Sep. 24, 2020

(54) ELECTRONIC SETTLEMENT SYSTEM, ELECTRONIC SETTLEMENT SERVER, NEGOTIABLE-VALUE PROVIDING APPARATUS, MOBILE COMMUNICATION TERMINAL, AND ELECTRONIC SETTLEMENT METHOD

(71) Applicant: Universal Entertainment Corporation, Tokyo (JP)

(72) Inventor: Nobuyuki NONAKA, Tokyo (JP)

(21) Appl. No.: 16/897,943

(22) Filed: Jun. 10, 2020

Related U.S. Application Data
(62) Division of application No. 12/596,564, filed on Mar. 8, 2010.

(30) Foreign Application Priority Data
Apr. 19, 2007 (JP) 2007-110213
May 23, 2007 (JP) 2007-136194

(51) Int. Cl. G06Q 20/32; G07F 17/32; G06Q 20/40; G06Q 20/34; G06Q 20/04; G06Q 20/10

(52) U.S. Cl. CPC G06Q 20/32; G06Q 20/327; G07F 17/3244; G06Q 20/40; G06Q 20/10; G06Q 20/352; G06Q 20/322; G06Q 20/045; G07F 17/32

(57) ABSTRACT

The present invention provides an electronic settlement system which is similar to cash settlement and which is available even in a game hall. The present invention provides an electronic settlement system including an electronic settlement server, a mobile communication terminal, and a negotiable-value providing apparatus. In the electronic settlement system, the mobile communication terminal acquires, from the negotiable-value providing apparatus, an equipment ID identifying the negotiable-value providing apparatus. The mobile communication terminal then generates a settlement request message containing a user ID identifying a user, a transfer amount corresponding to consideration for a negotiable value, and the equipment ID. The mobile communication terminal then transmits the message to the electronic settlement server. According to the result of a check of the user's credit status, the electronic settlement server instructs the negotiable-value providing apparatus to provide a negotiable value corresponding to the transfer amount. The electronic settlement server further requests a transfer of an amount corresponding to the transfer amount from the user's account to a predetermined account. Upon receiving the instruction to provide the negotiable value from the electronic settlement server, the negotiable-value providing apparatus provides the user with rental balls, rental medals, or the like corresponding to the transfer amount.

### CROSS REFERENCE TO RELATED APPLICATIONS

This application is a Divisional of U.S. patent application Ser. No. 12/596,564, filed Oct. 9, 2009 and having a 35 USC 371(c) completion date of Mar. 8, 2010, which application is a National Stage application of International Pat. App. No. PCT/JP2008/051686, filed Feb. 1, 2008, which application claims priority to Japanese Pat. App. Nos. 2007-110213, filed Apr. 19, 2007, and 2007-136194, filed May 23, 2007, respectively. Each of the above-identified applications is incorporated herein by reference.

### TECHNICAL FIELD

The present invention relates to an electronic settlement system, an electronic settlement server, a negotiable-value providing apparatus, a mobile communication terminal, and an electronic settlement method, and more specifically, to an electronic settlement system, an electronic settlement server, a negotiable-value providing apparatus, a mobile communication terminal, and an electronic settlement method which enable electronic settlement corresponding to cash settlement.

### BACKGROUND ART

With recent advanced information processing and communication techniques and prevailing communication infrastructures, a payment method has been diversified, and various methods replacing payment in cash have been proposed and utilized.

The methods replacing payment in cash include credit cards of what is called a deferred payment type, prepaid cards, and debit cards, which are of an immediate payment type.

For payment in game halls such as pachinko parlors, casinos, ticket counters for bicycle and horse races, and various lottery stands (hereinafter referred to as game halls), a payment method other than cash payment is expected to improve users' (players') convenience and to increase the operation rate of game machines and thus the sales of the game halls.

### DISCLOSURE OF THE INVENTION

### Problems to be Solved by the Invention

However, in order to regulate players' excessive borrowing, the use of credit cards in game halls is generally limited. Furthermore, given that a settlement method using credit cards in game halls is permitted, a record on the usage of credit is sent to the player's home or a credit company calls the player to confirm the player's identity. This is cumbersome to the player. Moreover, personal information may leak because the player needs to let the game hall know the player's credit card number and personal identification number for settlement, with the record of the personal information remaining inside the game hall. The player may thus have a considerable resistance to this. Therefore, the utilization and prevalence of settlement with credit cards in game halls is difficult.

Furthermore, for payment with prepaid card, another settlement method other than cash payment, if the player spends all of the player's cash as a result of the game, the player cannot buy an additional prepaid card. Even if the player desires to play a little more or to eat some food or buy something in the game hall after spending all of the player's cash for the game, no settlement method is presently available for meeting such a demand. Thus, the game hall simply has to throw away an opportunity to capitalize on such a potential demand.

Furthermore, to utilize a settlement method other than cash payment, the user conventionally needs to sign a prior written contract with a settlement company that undertakes settlement. Thus, inconveniently, the user cannot immediately utilize the settlement method other than cash payment.

An object of the present invention is to provide an electronic settlement scheme that is similar to cash settlement and available in gale halls.

Another object of the present invention is to provide an electronic settlement scheme allowing signing of a contract enabling what is called the online utilization of an electronic settlement scheme.

### Means for Solving the Problems

Means for solving the above-described problems according to the present invention is characterized as follows. A first aspect of the present invention proposes an electronic settlement system comprising an electronic settlement server, a mobile communication terminal capable of communicating with the electronic settlement server, and a negotiable-value providing apparatus capable of communicating with the electronic settlement server and the mobile communication terminal.

The electronic settlement system is further characterized as follows. The mobile communication terminal acquires equipment identification information (for example, an equipment ID) identifying the negotiable-value providing apparatus, from a negotiable-value providing apparatus, generates a settlement request message containing user identification information (for example, a user ID) identifying a user, a transfer amount corresponding to consideration for provision of a negotiable value, and the equipment identification information, and transmits the settlement request message to the electronic settlement server. According to a result of a check of a credit status of the user identified based on the user identification information, the electronic settlement server transmits, to the negotiable-value providing apparatus, a provision instruction message instructing the negotiable-value providing apparatus to provide a negotiable value corresponding to the transfer amount, and transmits a transfer request message requesting a transfer of an amount corresponding to the transfer amount from the user's account to a predetermined account. Upon receiving the provision instruction message from the electronic settlement server, the negotiable-value providing apparatus provides a negotiable value corresponding to the transfer amount (for example, rental balls, rental medals, prepaid cards, house cards that are valid only in the game hall, and casino chips; hereinafter referred to as the negotiable value).

The electronic settlement system allows even a user having no cash in hand to easily and securely buy a negotiable value.

A second aspect of the present invention proposes an electronic settlement server that is an apparatus carrying out an electronic settlement scheme according to the present invention. The electronic settlement server is characterized in that upon receiving, from a mobile communication terminal, a settlement request message containing user identification information (for example, a user ID) identifying a user, a transfer amount corresponding to consideration for provision of a negotiable value, and equipment identification information (for example, an equipment ID), which is information identifying a negotiable-value providing apparatus from which the user has requested provision of the negotiable value, from a mobile communication terminal, the electronic settlement server transmits, according to a result of a check of a credit status of the user, a provision instruction message instructing the negotiable-value providing apparatus identified based on the equipment identification information to provide a negotiable value corresponding to the transfer amount, and transmits a transfer request message requesting a transfer of an amount corresponding to the transfer amount from the user's account to a predetermined account.

The electronic settlement server allows even a user having no cash in hand to easily and securely buy a negotiable value.

A third aspect of the present invention proposes a negotiable-value providing apparatus carrying out an electronic settlement scheme according to the present invention. The negotiable-value providing apparatus is characterized by transmitting equipment identification information (for example, an equipment ID) identifying the negotiable-value providing apparatus to a mobile communication terminal, and upon receiving a provision instruction message transmitted in response to a settlement request message containing user identification information (for example, a user ID) identifying a user, a transfer amount corresponding to consideration for a negotiable value, and the equipment identification information, providing the negotiable value corresponding to the transfer amount.

The negotiable-value providing apparatus allows even a user having no cash in hand to easily and securely buy a negotiable value.

A fourth aspect of the present invention proposes a mobile communication terminal that is an apparatus carrying out an electronic settlement scheme according to the present invention. The mobile communication terminal is characterized by acquiring equipment identification information (for example, an equipment ID) identifying a negotiable-value providing apparatus, from the negotiable-value providing apparatus, generating a settlement request message containing user identification information (for example, a user ID) identifying a user, a transfer amount corresponding to consideration for provision of a negotiable value, and the equipment identification information, transmitting the settlement request message to the electronic settlement server, and according to a result of a check of a credit status of the user carried out by the electronic settlement server, allowing the electronic settlement server to transmit, to the negotiable-value providing apparatus, a provision instruction message instructing the negotiable-value providing apparatus to provide a negotiable value corresponding to the transfer amount.

The mobile communication terminal allows even a user having no cash in hand to easily and securely buy a negotiable value.

A fifth aspect of the present invention proposes an electronic settlement method for carrying out an electronic settlement scheme according to the present invention. The electronic settlement method is characterized by comprising a step of receiving equipment identification information identifying a negotiable-value providing apparatus, a step of generating a settlement request message containing user identification information identifying a user, a transfer amount corresponding to consideration for a negotiable value, and the equipment identification information, and transmitting the settlement request message, a step of, in response to the settlement request message, inquiring about a credit status of the user, and according to a result for the inquiry of the user's credit status, transmitting, to a negotiable-value providing apparatus identified by the equipment identification information, a provision instruction message instructing the negotiable-value providing apparatus to provide a negotiable value corresponding to the transfer amount, a step of transmitting a transfer request message requesting a transfer of an amount corresponding to the transfer amount from an account of the user identified by the user identification information to a predetermined account, and a step of, according to the provision instruction message, providing the negotiable value corresponding to the transfer amount to the negotiable-value providing apparatus.

The electronic settlement method allows even a user having no cash in hand to easily and securely buy a negotiable value.

A sixth aspect of the present invention proposes an electronic settlement system characterized by comprising an electronic settlement server capable of requesting a charge accommodating network (for example, a multi-payment network operated in Japan; not particularly limited; hereinafter referred to as a charge accommodating network) managing a user account, a settlement company account, and a game hall company account to carry out a transfer between the accounts and storing a user retained amount and a game hall company retained amount, a mobile communication terminal (for example, a cellular phone with a non-contact IC card; hereinafter referred to as a mobile communication terminal), and a negotiable-value providing apparatus (for example, a ball renting machine, a prepaid card issuing machine, a house card issuing machine, or a casino chip providing machine; hereinafter referred to as a negotiable-value providing apparatus).

In the electronic settlement system, the mobile communication terminal communicates with the negotiable-value providing apparatus via short-distance communication means (for example, a non-contact IC card and a reader/writer therefor, infrared communication, or radio communication means such as Bluetooth; hereinafter referred to as the short-distance communication means) to acquire equipment identification information (for example, an equipment ID) identifying the negotiable-value providing apparatus, generates a payment request message containing user identification information (for example, a user ID) identifying a user and the equipment identification information, and transmits the payment request message to the electronic settlement server. Furthermore, the electronic settlement server adds a user transfer amount (for example, a transfer amount minus a charge to be paid to a settlement company) corresponding to an amount transferred from the user account to the settlement company account, to the user retained amount, instructs, according to the payment request message, the negotiable-value providing apparatus to provide a negotiable value corresponding to a user payment amount (for example, a rental ball charge of 1,000 yen), subtracts an amount corresponding to the user payment amount from the user retained amount, while adding an amount corresponding to the user payment amount to a game hall company retained amount, and requests the charge accommodating network to transfer an amount (for example, the game hall company retained amount minus the charge to be paid to the settlement company) corresponding to the game hall company retained amount from the settlement company account to the game hall company account. Additionally, upon receiving the instruction (for example, a provision instruction message) to provide the negotiable value from the electronic settlement server, the negotiable-value providing apparatus provides the negotiable value corresponding to the user payment amount.

The electronic settlement system enables provision of a new settlement method replacing existing settlement methods such as credit cards and debit cards.

A seventh aspect of the present invention proposes an electronic settlement server capable of requesting a charge accommodating network managing a user account, a settlement company account, and a game hall company account to carry out a transfer between the accounts, and instructing a negotiable-value providing apparatus to provide a negotiable value corresponding to a user payment amount (for example, a rental ball charge of 1,000 yen) according to a payment request message from a mobile communication terminal.

The electronic settlement server is characterized by comprising storage means (for example, a database unit) for storing a user retained amount and a game hall company retained amount, transfer request processing means (for example, a transfer request processing unit) for adding the user transfer amount corresponding to the transfer amount from the user account to the settlement company account, to the user retained amount, payment request processing means (for example, payment request processing unit) for, according to the payment request message, subtracting the amount corresponding to the user payment amount from the user retained amount, while adding the amount corresponding to the user payment amount to the game hall company retained amount, and requesting the charge accommodating network to transfer the amount corresponding to the game hall company retained amount from the settlement company account to the game hall company account, and provision instructing means (for example, provision instructing unit) for instructing the negotiable-value providing apparatus to provide the negotiable value corresponding to the user payment amount.

The electronic settlement system enables provision of a new settlement method replacing existing settlement methods such as credit cards and debit cards.

A third aspect of the present invention proposes a mobile communication terminal for an electronic settlement system. The mobile communication terminal carries out communication via short-distance communication means to acquire equipment identification information identifying a negotiable-value providing apparatus from the negotiable-value providing apparatus, generates a payment request message containing user identification information identifying a user and the equipment identification information, and transmits the payment request message to an electronic settlement server to allow the electronic settlement server to instruct to provide a negotiable value corresponding to a user payment amount (for example, a rental ball charge of 1,000 yen).

The mobile communication terminal functions as a terminal apparatus implementing a new settlement method replacing existing settlement methods such as credit cards and debit cards.

An eighth embodiment of the present invention proposes an electronic settlement method.

The electronic settlement method is characterized by comprising a step (for example, a process S204 of transmitting a transfer request) of requesting a charge accommodating network to transfer a transfer amount specified by a user from a user account to a settlement company account, a step (for example, a retained amount data process S207) of adding a user transfer amount corresponding to the transfer amount, to a user retained amount for storage, a step (for example, S303) of receiving a payment request message containing equipment identification information acquired through communication with a negotiable-value providing apparatus via short-distance communication means and identifying the negotiable-value providing apparatus and user identification information identifying the user, a step (for example, a process S305 of transmitting a provision instruction message) of according to the payment request message, instructing the negotiable-value providing apparatus to provide a negotiable value corresponding to a user payment amount (for example, a rental ball charge of 1,000 yen), a step (for example, a transfer process S307) of subtracting an amount corresponding to the user payment amount from the user retained amount, while adding the amount corresponding to the user payment amount to a game hall company retained amount, and a step (for example, a process S402 of transmitting a transfer request) of requesting the charge accommodating network to transfer an amount corresponding to the game hall company retained amount from the settlement company account to the game hall company account.

The electronic settlement system enables provision of a new settlement method replacing existing settlement methods such as credit cards and debit cards.

A ninth aspect of the present invention proposes an electronic settlement system intended mainly for a single game hall company and comprising an electronic settlement server capable of requesting a charge accommodating network managing a user account, a settlement company account, and a game hall company account to carry out a transfer between the accounts, the electronic settlement server being capable of storing a user retained amount, a mobile communication terminal, and a negotiable-value providing apparatus.

In the electronic settlement system, the mobile communication terminal communicates with the negotiable-value providing apparatus via short-distance communication means to acquire equipment identification information (for example, an equipment ID) identifying the negotiable-value providing apparatus, generates a payment request message containing user identification information (for example, a user ID) identifying a user and the equipment identification information, and transmits the payment request message to the electronic settlement server. The electronic settlement server adds a user transfer amount (for example, a transfer amount minus a charge to be paid to a settlement company) corresponding to an amount transferred from the user account to the settlement company account, to the user retained amount and requests the charge accommodating network to transfer an amount (for example, the user transfer amount minus a charge to be paid to the settlement company) corresponding to the transfer amount from the settlement company account to the game hall company account, then according to the payment request message, instructs the negotiable-value providing apparatus to provide a negotiable value corresponding to a user payment amount (for example, a rental ball charge of 1,000 yen), and subtracts an amount corresponding to the user payment amount from the user retained amount. Upon receiving the instruction to provide the negotiable value from the electronic settlement system, the negotiable-value providing apparatus provides the negotiable value corresponding to the user payment amount.

The electronic settlement system enables provision of a new settlement method replacing existing settlement methods such as credit cards and debit cards.

A tenth aspect of the present invention proposes a an electronic settlement server intended mainly for a single game hall company and which is capable of requesting a charge accommodating network managing a user account, a settlement company account, and a game hall company account to carry out a transfer between the accounts, and according to a payment request message from a mobile communication terminal, instructing a negotiable-value providing apparatus to provide a negotiable value corresponding to a user payment amount (for example, a rental ball charge of 1,000 yen).

The electronic settlement server is characterized by comprising storage means (for example, a database unit) for storing a user retained amount, transfer request processing means (for example, a transfer request processing unit) for adding a user transfer amount corresponding to a transfer amount from the user account to the settlement company account, to the user retained amount and requesting the charge accommodating network to transfer an amount corresponding to the transfer amount from the settlement company account to the game hall company account, payment request processing means (for example, a payment request processing unit) for, according to the payment request message, subtracting an amount corresponding to the user payment amount from the user retained amount, and provision instructing means (for example, a provision instructing unit) for instructing the negotiable-value providing apparatus to provide the negotiable value corresponding to the user payment amount.

The electronic settlement server enables provision of a new settlement method replacing existing settlement methods such as credit cards and debit cards.

An eleventh aspect of the present invention proposes an electronic settlement method.

The electronic settlement method is characterized by comprising a step (for example, a process S504 of transmitting a transfer request) of requesting a charge accommodating network to transfer a transfer amount specified by a user from a user account to a settlement company account, a step (for example, a process S507 of transmitting the transfer request) of requesting the charge accommodating network to transfer an amount corresponding to the transfer amount from the settlement company account to a game hall company account, a step (for example, a retained amount data process S510) of adding a user transfer amount corresponding to the transfer amount from the user account to the settlement company account, to a user retained amount for storage, a step (for example, S603) of receiving a payment request message containing equipment identification information acquired through communication with a negotiable-value providing apparatus via short-distance communication means and identifying the negotiable-value providing apparatus and user identification information identifying the user, a step (for example, a process S605 of transmitting a provision instruction message) of, according to the payment request message, instructing the negotiable-value providing apparatus to provide a negotiable value corresponding to a user payment amount (for example, a rental ball charge of 1,000 yen), and a step (for example, a subtraction process S607) of subtracting an amount corresponding to the user payment amount from the user retained amount.

The electronic settlement method enables provision of a new settlement method replacing existing settlement methods such as credit cards and debit cards.

The present invention is further characterized as follows.

Before transmitting the provision instruction message and the transfer request message, the electronic settlement server stores a computerized contract document for a contract signed between the user and the settlement company serving as an operator of the electronic settlement system, the contract specifying that the settlement company withdraws the specified amount from the user account, as well as a computerized contract document storage original attached to the computerized contract document and having the verified user's electronic signature and settlement company's electronic signature.

Furthermore, the electronic settlement server transmits the computerized contract document storage original for a bank in which the user account to be dealt with is present.

Additionally, the electronic settlement method according to the present invention further comprises a step of receiving a computerized contract document for a contract signed between the user and the settlement company serving as an operator of the electronic settlement system, the contract specifying that the settlement company withdraws the specified amount from the user account, as well as the user's electronic signature and electronic certificate both attached to the contract document, a step of verifying the user's electronic signature and electronic certificate and according to a result of the verification, transmitting a computerized contract document and an electronic signature and an electronic certificate of the settlement company, and a step of receiving and storing the computerized contract document, the user's electronic signature and the settlement company's electronic signature both attached to the computerized contract document, and a computerized contract document storage original including a time stamp.

According to the present invention having these additional features, the user can immediately utilize the settlement method other than cash payment without the need for a prior written contact between the settlement company and the user.

### Advantages of the Invention

The present invention allows implementation of electronic settlement replacing cash settlement and which can be utilized in game halls.

Another aspect of the present invention allows implementation of easy and secure electronic settlement which can be utilized in game halls.

### BRIEF DESCRIPTION OF THE DRAWINGS

FIG. 1 is a network diagram showing an example of an electronic settlement system;

FIG. 2 is a function block diagram showing an example of the configuration of a negotiable-value providing apparatus and a mobile communication terminal;

FIG. 3 is a diagram showing an example of information stored in a payment request generating unit;

FIG. 4 is a function block diagram showing an example of the configuration of an electronic contract applying unit;

FIG. 5 is a function block diagram showing an example of the configuration of an electronic settlement server;

FIG. 6 is a diagram showing an example of the configuration of a user table stored in a database unit;

FIG. 7 is a diagram of an example of the configuration of a negotiable-value providing apparatus table stored in the database unit;

FIG. 8 is a function block diagram showing an example of the configuration of an electronic contract processing unit;

FIG. 9 is a sequence diagram showing an example of the operation of the electronic settlement system;

FIG. 10 is a sequence diagram continued from FIG. 9 and showing an example of the operation of the electronic settlement system;

FIG. 11 is a sequence diagram continued from FIG. 10 and showing an example of the operation of the electronic settlement system;

FIG. 12 is a sequence diagram continued from FIG. 11 and showing an example of the operation of the electronic settlement system;

FIG. 13 is a sequence diagram continued from FIG. 12 and showing an example of the operation of the electronic settlement system;

FIG. 14 is a diagram showing an example of an input screen displayed in an output unit;

FIG. 15 is a diagram showing an example of the data configuration of a settlement request message generated by the payment request generating unit;

FIG. 16 is a diagram showing an example of the data configuration of a transfer request message;

FIG. 17 is a network diagram showing an example of an electronic settlement system according to the present invention;

FIG. 18 is a block diagram showing a general configuration of a charge accommodating network;

FIG. 19 is a function block diagram showing an example of the configuration of a negotiable-value providing apparatus and a mobile communication terminal;

FIG. 20 is a function block diagram showing an example of the configuration of an electronic settlement server;

FIG. 21 is a diagram showing an example of the configuration of a user table stored in a database unit;

FIG. 22 is a diagram showing an example of the configuration of user retained amount data stored in the database unit;

FIG. 23 is a diagram showing an example of the configuration of a game hall company table stored in the database unit;

FIG. 24 is a diagram showing an example of the configuration of game hall company retained amount data stored in the database unit;

FIG. 25 is a diagram showing an example of the configuration of a negotiable-value providing apparatus table stored in the database unit;

FIG. 26 is a function block diagram showing an example in which an electronic settlement server has a distributed server configuration;

FIG. 27 is a sequence diagram showing an example of the operation of the electronic settlement system;

FIG. 28 is a sequence diagram continued from FIG. 27 and showing an example of the operation of the electronic settlement system;

FIG. 29 is a sequence diagram continued from FIG. 28 and showing an example of the operation of the electronic settlement system;

FIG. 30 is a sequence diagram continued from FIG. 29 and showing an example of the operation of the electronic settlement system;

FIG. 31 is a diagram illustrating an example of an operation performed between the electronic settlement server and a charge accommodating network when a user transfer amount is processed;

FIG. 32 is a diagram continued from FIG. 31 and illustrating an example of the operation performed between the electronic settlement server and the charge accommodating network when the user transfer amount is processed;

FIG. 33 is a diagram continued from FIG. 32 and illustrating an example of the operation performed between the electronic settlement server and the charge accommodating network when the user transfer amount is processed;

FIG. 34 is a sequence diagram showing an example of the operation of the electronic settlement system performed during communication between the mobile communication terminal and the negotiable-value providing apparatus via short-distance communication means;

FIG. 35 is a diagram showing a state observed after the processing between step S1301 and step S1307 following the state shown in FIG. 33;

FIG. 36 is a sequence diagram showing an example of a process of a transfer to a game hall company account in the electronic settlement system;

FIG. 37 is a diagram showing the result of execution of steps S1401 to S1405 following the state shown in FIG. 35;

FIG. 38 is a sequence diagram showing an example of the operation of an electronic settlement system performed when a transfer from a user account to a settlement company account is requested according to a third embodiment;

FIG. 39 is a diagram showing an example of a state observed before a user transmits a transfer request message to an electronic settlement server;

FIG. 40 is a diagram showing a state observed after the user has transmitted a transfer request message requesting a transfer of a user transfer amount of 10,000 yen, from the mobile communication terminal to the electronic settlement server, wherein the transmission follows the state shown in FIG. 39;

FIG. 41 is a diagram showing a state observed after the user has transmitted a transfer request message requesting a transfer of game hall company transfer amount, from a mobile communication terminal to the electronic settlement server and a charge accommodating network has executed a transfer process corresponding to the message, wherein the transmission and execution follow the state shown in FIG. 40;

FIG. 42 is a diagram showing a state observed after execution of a retained amount data process by the electronic settlement server following the state shown in FIG. 41;

FIG. 43 is a sequence diagram showing an example of the operation of an electronic settlement system 1A performed during communication between the mobile communication terminal and a negotiable-value providing apparatus via short-distance communication means;

FIG. 44 is a diagram showing a state observed after the processing between step S1601 and step S1607 following the state shown in FIG. 42;

FIG. 45 is a block diagram showing an example of the configuration of an electronic settlement system according to a fourth embodiment;

FIG. 46 is a function block diagram showing an example of the configuration of a negotiable-value providing apparatus and a mobile communication terminal according to a fourth embodiment;

FIG. 47 is a block diagram showing an example of the configuration of an electronic settlement server according to a fourth embodiment;

FIG. 48 is a diagram showing an example of an addition process executed by the electronic settlement system according to the fourth embodiment;

FIG. 49 is a diagram continued from FIG. 48 and showing the example of the addition process executed by the electronic settlement system according to the fourth embodiment;

FIG. 50 is a diagram continued from FIG. 49 and showing the example of the addition process executed by the electronic settlement system according to the fourth embodiment;

FIG. 51 is a diagram showing an example of an addition process executed by the electronic settlement system according to the fourth embodiment and which is different from the addition process shown in FIG. 48;

FIG. 52 is a diagram continued from FIG. 51 and showing the example of the addition process executed by the electronic settlement system according to the fourth embodiment; and

FIG. 53 is a diagram continued from FIG. 52 and showing the example of the addition process executed by the electronic settlement system according to the fourth embodiment.

### DESCRIPTION OF SYMBOLS

1, 1A, 1B . . . Electronic settlement systems
10, 10A, 10B . . . Electronic settlement servers
20, 20A, 20B . . . Mobile communication terminals
30, 30A, 30B . . . Negotiable-value providing apparatuses
40 . . . Financial institution system
40A . . . Charge accommodating network
41 . . . User account
42 . . . Settlement company account
43 . . . Game hall company account
206 . . . Electronic contract applying unit
402, 402A . . . Payment request processing units
403, 403A . . . Database units
404 . . . Credit check unit
404A . . . Transfer request processing unit
405 . . . Transfer request unit
405A . . . Clearing processing unit
406, 406A . . . Provision instructing units
408, 409A . . . Electronic contract processing unit
410B . . . Addition request processing unit

### BEST MODE FOR CARRYING OUT THE INVENTION

Embodiments of the present invention will be described below with reference to the drawings.

### I. First Embodiment

### I.1. Example of Configuration of the Electronic Settlement System

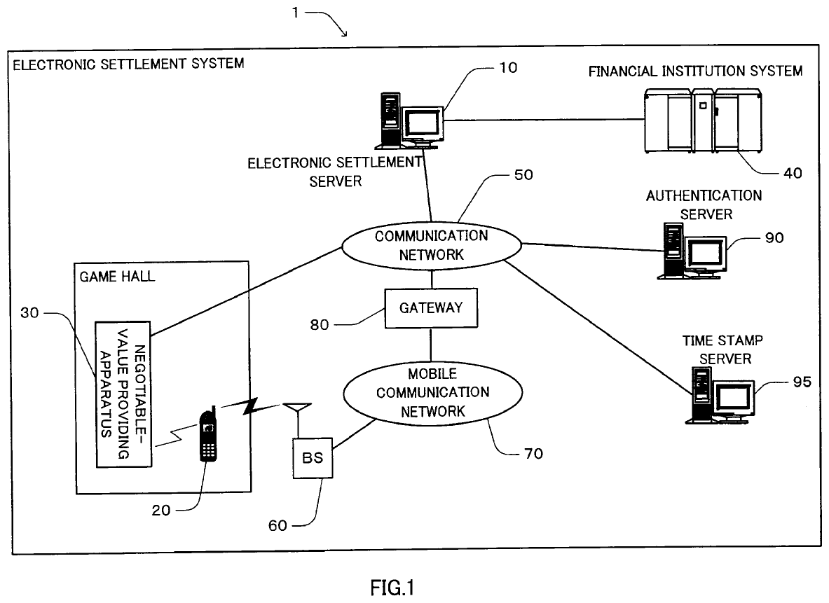

FIG. 1 is a network diagram showing an example of an electronic settlement system according to a first embodiment of the present invention.

In an example shown in FIG. 1, an electronic settlement system 1 has an electronic settlement server 10, a mobile communication terminal 20, a negotiable-value providing apparatus 30, an authentication server 90, and a time stamp server 95. The electronic settlement server 10 is connected to a financial institution system 40 checking credits and executing a process of transferring a specified amount from a user's account to a specified destination account based on an instruction from the electronic settlement server 10. Furthermore, the electronic settlement server 10 is connected to a communication network 50 and can communicate with the negotiable-value providing apparatus 30 via the communication network 50. The mobile communication terminal 20 can communicate with the electronic settlement server 10 via a base station 60, a mobile communication network 70, and a gateway 80 connecting the mobile communication network 70 and the communication network 50 together. The mobile communication terminal 20 can also communicate with the negotiable-value providing apparatus 30 via short-distance communication means. The authentication server 90 can be connected to the electronic settlement server 10 and the mobile communication terminal 20 via the communication network 70. The time stamp server 95 can be connected to the mobile communication terminal 20 via the communication network. The components of the electronic settlement system 1 will be described below.

### I.1.1. Negotiable-Value Providing Apparatus

The negotiable-value providing apparatus 30 provides a prepared negotiable value (a tangible object or an intangible object that can be bought with money) to a user as consideration for electronic settlement carried out by the user using the mobile communication terminal 20. The negotiable-value providing apparatus 30 in the present embodiment need not necessarily provide a negotiable value directly to a user. The negotiable-value providing apparatus 30 may be an apparatus such as a CAT terminal for debit cards which provides a negotiable value indirectly to a user by notifying a shop of the possibility of electronic settlement to allow the shop to deliver an article to the user.

Furthermore, the negotiable-value providing apparatus 30 may output, transmit, or write electronic data to another apparatus or a storage medium as a negotiable value. For example, the negotiable-value providing apparatus 30 may transmit a message or a command requesting a playing machine or a game machine connected to the negotiable-value providing apparatus 30 via a network to provide a play or a game. In this case, the user can enjoy, through the negotiable-value providing apparatus 30, a play or a game for a play or game charge paid utilizing the electronic settlement system 1. Additionally, the negotiable-value providing apparatus 30 may write electronic data such as the number of times the game machine can be utilized and the amount for which the game machine can be utilized, to a cellular phone including an IC card or an IC card function or a storage medium such as a USB memory. The user allows a playing machine, a game machine, an issuing machine, a clearing machine, or the like to read electronic data from the storage medium to which the negotiable-value providing apparatus 30 has written the electronic data. The user can thus acquire a product or a service provided by these apparatuses.

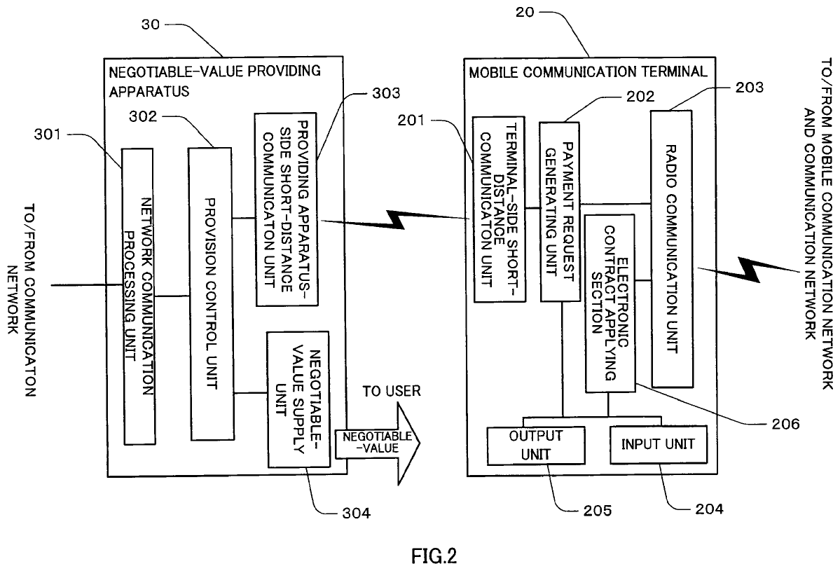

FIG. 2 is a function block diagram showing an example of the configuration of the negotiable-value providing apparatus 30 and the mobile communication terminal 20. The configuration of the negotiable-value providing apparatus 30 will be described below with reference to FIG. 2.

The negotiable-value providing apparatus 30 has a network communication processing unit 301, a provision control unit 302, a providing apparatus-side short-distance communication unit 303, and a negotiable-value supply unit 304. The network communication processing unit 301 has a function of communicating with the electronic settlement server 10 via the communication network 50. The network communication processing unit 301 is, for example, a communication board with a protocol stack mounted thereon.

The provision control unit 302 has the function of instructing and controlling the operation of the network communication processing unit 301, the providing apparatus-side short-distance communication unit 303, and the negotiable-value supply unit 304. The provision control unit 302 is, for example, a microcomputer with a program installed thereon allowing the negotiable-value providing apparatus 30 to be implemented.

The providing apparatus-side short-distance communication unit 303 has the function of communicating with a terminal-side short-distance communication unit 201 mounted in the mobile communication terminal 20. The providing apparatus-side short distance communication unit 303 is, for example, a reader/write for a non-contact IC card. A communication scheme used by the providing apparatus-side short-distance communication unit 303 need not be limited to radio communication but may be infrared communication. Furthermore, the present invention can be implemented by a method of using the mobile communication terminal 20 to optically read a bar code displayed by the negotiable-value providing apparatus 30 to pass data. Additionally, the communication scheme need not necessarily be of a non-contact type. The present invention can be implemented by a communication scheme using connection with a communication cable or a USB socket.

The negotiable-value supply unit 304 has the function of providing a negotiable value to a user according to an instruction from the provision control unit 302. The negotiable-value supply unit 304 is, for example, a rental ball output unit of a ball renting machine, a medal hopper of a medal renting machine, a casino chip renting machine, a display of an authentication terminal (CAT terminal), or a printer. The negotiable value is anything than can be bought with money. The negotiable value is rental balls, rental medals, casino chips, prepaid cards, on-value cards (house cards), or equivalents.

### I.1.2. Mobile Communication Terminal

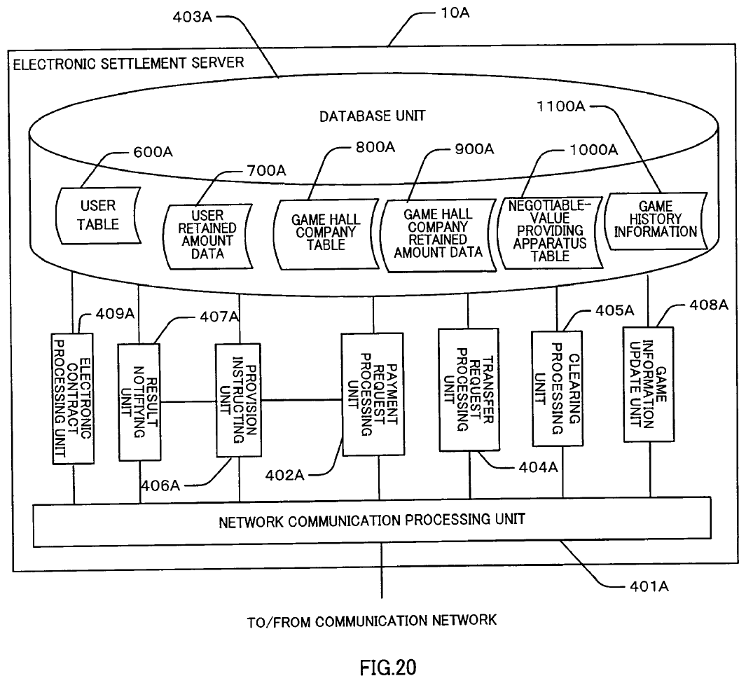

Now, the mobile communication terminal 20 will be described with reference to FIG. 20. The mobile communication terminal 20 is a terminal apparatus that can communicate with the electronic settlement server 10 via the communication network 50 and also with the negotiable-value providing apparatus 30. The mobile communication terminal 20 is, for example, a cellular phone having a non-contact IC card (for example, FeliCa: Sony Corporation's registered trademark) function, a cellular phone with short-distance communication means and radio communication means mounted thereon, PDA (Personal Data Assistant), a portable game machine, or an IP telephone including a radio LAN communication apparatus. The mobile communication terminal 20 has the terminal-side short-distance communication unit 201 allowing communication with the above-described providing apparatus-side short-distance communication unit 303, a payment request generating unit 202, a radio communication unit 203, an input unit 204, an output unit 205, and an electronic contract applying unit 206.

The terminal-side short-distance communication unit 201 has the function of communicating with the providing apparatus-side short-distance communication unit 303. The terminal-side short-distance communication unit 201 is, for example, an IC card chip and an antenna.

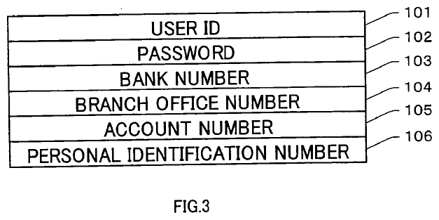

The payment request processing unit 202 has the function of generating a settlement request message requesting the electronic settlement server 10 to pay consideration (charge) for the negotiable value provided by the negotiable-value providing apparatus 30. The payment request processing unit 202 is, for example, a microcomputer with an i appli (“i appli”: NTTDoCoMo, Inc.'s registered trademark; an application downloaded into a cellular phone to allow a value-added function to be added and not particularly limiting an OS; hereinafter referred to as the i appli) mounted thereon. The payment request generating unit 202 has the function of storing information used for the user's payment. FIG. 3 shows an example of information stored in the payment request generating unit 202. In the present example, the payment request generating unit 202 stores a user ID 101 that is information uniquely identifying the user registered as the user of the mobile communication terminal 20, a password 102 required for the electronic settlement server to authenticate the user, and a bank number 103, a branch office number 104, and an account number 105 all identifying an account from which the user withdraws money to be paid, and a personal identification number 106 set for the account. During installation of an application such as the i appli allowed to function as the payment request generating unit 202 by the mobile communication terminal 20 according to the user's instruction or user registration for making services for the present electronic settlement available, the user is requested by the input unit 204 to input these pieces of information, particularly the bank number 103, branch office number 104, account number 105, and personal identification number 106. The input information is stored in advance as the pieces of information 101 to 106. The pieces of information 101 to 106 are used to generate a settlement request message requesting payment of consideration (charge) for provision of a negotiable value. The pieces of information 101 to 106 are transmitted to the electronic settlement server 10 as a part of the settlement request message.

FIG. 2 is referred to again, and the mobile communication terminal 20 will be continuously described.

The radio communication unit 203 has the function of allowing the mobile communication terminal 20 to connect to the mobile communication network 70 via the base station 60 to communicate via the mobile communication network 70. The radio communication unit 203 is, for example, a radio communication circuit having a modulation circuit and a demodulation circuit. The mobile communication network 70 may be a communication network for common cellular phones or for WIMAX or a radio LAN.

The input unit 204 has the function of converting the user's instruction into an electric signal and passing the electric signal to the payment request generating unit 202. The input unit 204 is, for example, keys of a cellular phone, a touch pen and a touch panel, or a pointing device.

The output unit 205 has an information output function of allowing the mobile communication terminal 20 to communicate information to the user. The output unit 205 is, for example, a liquid crystal panel of a cellular phone, a liquid crystal panel of a CAT terminal, or a small-sized printer.

The electronic contract applying unit 206 has the function of executing a process of electronically signing a contract between the user and the operator, administrator, or the like (hereinafter referred to as a settlement company) of the electronic settlement system 1 before the utilization of the electronic settlement system 1; according to the contract, the settlement company withdraws a specified amount from the user account.

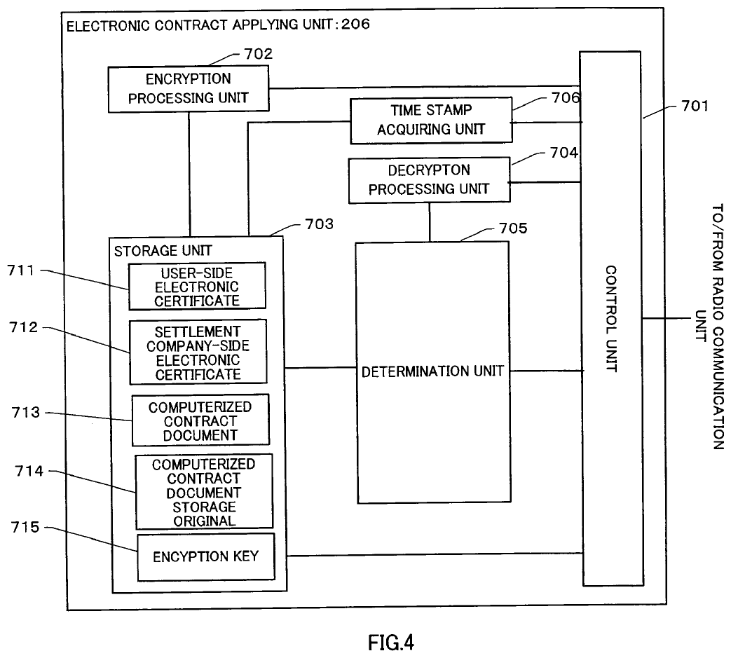

FIG. 4 is a function block diagram showing an example of the configuration of the electronic contract applying unit 206. As shown in FIG. 4, the electronic contract applying unit 206 has a control unit 701, an encryption processing unit 702, a storage unit 703, a decryption processing unit 704, a determination unit 705, and a time stamp acquiring unit 706.

The control unit 701 has the function of integrally controlling the operation of the encryption processing unit 702, storage unit 703, decryption processing unit 704, determination unit 705, and time stamp acquiring unit 706 to order starting of each of these units, input and output of data to and from each unit, and the like.

The encryption processing unit 702 has the function of generating an electronic signature by a predetermined encryption method using an encryption key 715.

The storage unit 703 has the function of storing a user-side electronic certificate 711, a settlement company-side electronic certificate 712, a computerized contract document 713, a computerized contract document original 714, the encryption key 715, and the like.

The user-side electronic certificate 711 is electronic data certifying that one of the signees of the computerized contract document 713 is the user himself. The user-side electronic certificate 711 is electronic data defined in, for example, X.509 of ITU-T Recommendations and includes information on the user (an organization to which the user belongs, the user's identification name and name, and the like), a public key, an expiration date, a serial number, and a signature. In the present example, the user-side electronic certificate 711 is electronic data issued by the authentication server 90.

According to the present embodiment, the following can also be used as the user-side electronic certificate 711. [0144] a) A password or the like issued when a contract for the mobile terminal is signed with a financial institution having the user account, [0145] b) A serial number (user ID) written to the mobile communication terminal at the same time when the user downloads an application such as the i appli from the electronic settlement 10, [0146] c) The manufacture number of the mobile communication terminal 20, [0147] d) The serial number of an SIM (Subscriber Identity Module Card), [0148] e) The telephone number of the mobile communication terminal 20, [0149] f) A common ID for the standards typified by OpenID, and

g) One or more of the results of a logical calculation or encryption of the pieces of information a) to f) and information describing the date and the amount.

The “OpenID” is a standard for the common ID, is in a URL format, and can be commonly utilized in OpenID-compatible sites (see http://openid.net/).

The settlement company-side electronic certificate 712 is electronic data certifying that the other of the signees of the electronic contract document 713 is the settlement company. The settlement company-side electronic certificate 712 is electronic data defined in, for example, X.509 of ITU-T Recommendations and includes information on the user (an organization to which the user belongs, the user's identification name and name, and the like), a public key, an expiration date, a serial number, and a signature. In the present example, the settlement company-side electronic certificate 712 is electronic data issued by the authentication server 90.

The computerized contract document 713 is electronic data describing the contents a contract signed between the user and the settlement company, the operator of the system and specifying that the settlement company withdraws a specified amount from the user amount and the bank in which the user's account is present agrees that the settlement company withdraws the specified amount from the user's account or the bank is requested to permit the settlement company to withdraw the specified amount from the user's account.

The computerized contract document original 714 is electronic data corresponding to the computerized contract document 713 with the user's electronic signature, the settlement company's electronic signature, and the time stamp. The computerized contract document original 714 corresponds to a sealed contract document between the parties concerned.

The encryption key 715 is used by the user to generate an electronic signature or to decrypt encrypted information transmitted by the electronic settlement server 10. The encryption key 715 is, for example, a secrete key for a public key scheme or a common encryption key for a common key scheme.

The user-side electronic certificate 711 and the encryption key 715 may be pre-acquired from the authentication server 90, that is, a certification authority (CA), for storage or installed in the mobile communication terminal 20 by a manufacturer or a vender before shipment thereof.

The computerized contract document 713 and the settlement company-side electronic certificate 712 are acquired from the electronic settlement server 10 during downloading of an application such as the i appli described below. Of course, the computerized contract document 713 and the settlement company-side electronic certificate 712 may be acquired by a different method.

The decryption processing unit 704 has the function of decrypting the settlement company's electronic signature transmitted by the electronic settlement server 10.

The determination unit 705 has the function of verifying the settlement company's electronic certificate and electronic signature transmitted by the electronic settlement server 10 together with the computerized contract document.

The time stamp acquiring unit 706 has the following function provided if the determination unit 705 determines that the computerized contract document is electronically signed by the settlement company, based on the settlement company's electronic certificate and electronic signature transmitted by the electronic settlement server. The time stamp acquiring unit 706 requests and acquires the time stamp on the computerized contract document with the electronic signature, from the time stamp server 95, and transmits the computerized contract document with the electronic signature to the electronic settlement server together with the time stamp acquired. Furthermore, the time stamp and the computerized contract document with the electronic signature are stored in the storage unit 703 as a computerized signed contract document original.

The electronic contract applying unit 206 and the mobile communication terminal 20 have been described.

### I.1.3 Electronic Settlement Server

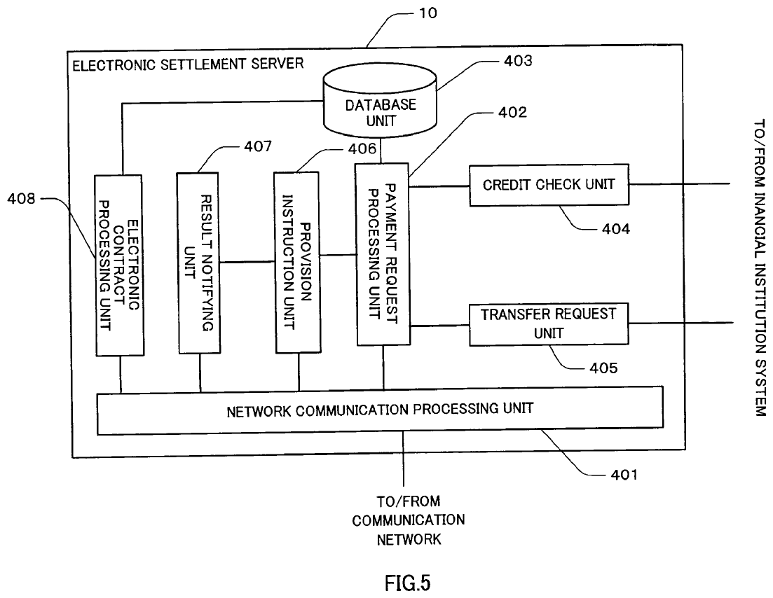

Now, the electronic settlement server 10 will be described with reference to FIG. 5. FIG. 5 is a function block diagram showing an example of the configuration of the electronic settlement server 10.

The electronic settlement server 10 is an apparatus including an central processing unit (CPU), a main memory (RAM), a read only memory (ROM), an I/O device (I/O), and an external storage device such as a hard disk device as required. The electronic settlement server 10 is, for example, an information processing apparatus such as a computer or a workstation. The ROM or the hard disk device stores a program allowing the information processing apparatus to function as the electronic settlement server 10 or a program allowing an electronic settlement method to be executed by a computer. The program is placed on the main memory and executed by the CPU to implement the electronic settlement server 10 or to execute the electronic settlement method. Furthermore, the program need not necessarily be stored in the storage device in the information processing apparatus. The program may be provided by an external apparatus (for example, a server such as an ASP (Application Service Provider)) and placed on the main memory. Moreover, the electronic settlement server 10 may be configured as a center into which all functions are integrated or as distributed servers divided by functions installed away from one another to enable a distributed process.

The electronic settlement server 10 shown in FIG. 5 has a network communication processing unit 401, a payment request processing unit 402, a database unit 403, a credit check unit 404, a transfer request unit 405, a provision instructing unit 406, a processing result notifying unit 407, and an electronic contract processing unit 408.

The network communication processing unit 401 has the function of communicating with the mobile communication terminal 20 and the negotiable-value providing apparatus 30 via the communication network 50. The network communication processing unit 401 is, for example, a communication board allowing the protocol stack to be carried out. Upon receiving a request message from the mobile communication terminal 20, the network communication processing unit 401 passes the request message to the payment request processing unit 402. Upon receiving a provision instruction message destined for the negotiable-value providing apparatus 30 from the provision instructing unit 406, the network communication processing unit 401 transmits the provision instruction message to the negotiable-value providing apparatus 30.

Upon receiving a settlement request message from the mobile communication terminal 20 via the network communication processing unit 401, the payment request processing unit 402 passes the settlement request message to the credit check unit 404 to allow the credit check unit 404 to inquire about the credit status of the user having issued the settlement request message. If the credit check unit 404 receives, from the financial institution system 40, a check result indicating that the user's credit status has no problem, that is, the payment request is acceptable, the payment request processing unit 402 allows the transfer request unit 405 to generate and transmit a transfer request message to the financial institution system 40. Moreover, the payment request processing unit 402 allows the provision instructing unit 406 to generate a provision instruction message destined for the negotiable-value providing apparatus 30 and to transmit the provision instruction message to the negotiable-value providing apparatus 30 via the network communication processing unit 401.

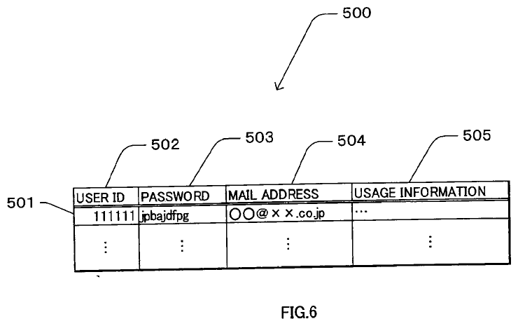

The database unit 403 generates a transfer request message based on the settlement request message. The database unit 403 further stores information required to generate a provision instruction message as well as the user's usage of the present electronic settlement system. FIG. 6 shows an example of the configuration of a user table stored in the database unit 403. A user table 500 is data having one record 501 for each user. Each record 501 stores a user ID 502, a password 503, a mail address 504, and usage information 505. The user ID 502 is information uniquely identifying the user. The password 503 is information required to prevent a third party from pretending to be the user to unfairly utilize the present electronic settlement system. The mail address 503 is information used as a destination address if the processing result notifying unit 407 utilizes an electronic mail to notify the user of the processing result of settlement. The usage information 505 includes various pieces of information such as the frequency at which the user has utilized the present electronic settlement system, the amount for which the user has utilized the system, and the places in which the user has utilized the system. The usage information 505 is utilized for marketing analysis and selective distribution of recommendation information to the user.

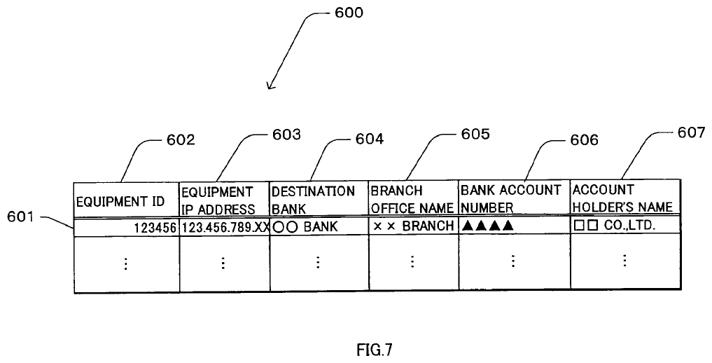

FIG. 7 shows an example of the configuration of a negotiable-value providing apparatus table stored in the database unit 403. A negotiable-value providing apparatus table 600 is data having one record 601 for each negotiable-value providing apparatus 30. Each record 601 stores an equipment ID 602, an equipment IP address 603, a destination bank 604, a branch office name 605, an account number 606, and an account holder's name 607.

The equipment ID 602 is information uniquely identifying the negotiable-value providing apparatus 30. The equipment IP address is information utilized as a destination address for a provision instruction message based on a received settlement request message having the corresponding equipment ID. The destination bank 604, the branch office name 605, the account number 606, and the account holder's name 607 are information required to identify the destination of the transfer amount from the user's bank account if the electronic settlement server 10 receives the settlement request message corresponding to the equipment ID.

FIG. 5 is referred to again, and the example of configuration of the electronic settlement server 10 will be continuously described.

The provision instructing unit 406 allows a provision instruction message destined for the negotiable-value providing apparatus 30 to be generated. The provision instructing unit 406 transmits the provision instruction message to the negotiable-value providing apparatus 30 via the network communication processing unit 401. The address of the negotiable-value providing apparatus 30 is acquired with reference to the above-described negotiable-value providing apparatus table 600.

Furthermore, the processing result notifying unit 407 serves to notify the user whether or not the settlement request message has been processed. The processing result notifying unit 407 generates an electronic mail destined for the mobile communication terminal 20 and transmits the electronic mail or describes information indicating the processing result on a web page that can be browsed via the mobile communication terminal 20 and wait for browsing via the mobile communication terminal 20. The content of the notification is, for example, the message “Settlement request has been processed. Thank you for allowing us to serve you” or “Short balance. Settlement has failed.”

The electronic contract processing unit 408 has the function of cooperating with the mobile communication terminal 20, more specifically the electronic contract applying unit 206 thereof, in allowing the user and the operator, administrator, or the like of the electronic settlement system 1 (hereinafter referred to as the settlement company) to electronically sign a contract specifying that the settlement company withdraws the specified amount from the user account before the utilization of the electronic settlement system 1 can be started.

Furthermore, the electronic contract processing unit 408 has the function of transmitting data from the computerized contract document original certifying the contract signed between the user and the settlement company, to the financial institution having the user account.

Specifically, the electronic contract processing unit 408 has the function of allowing the computerized contract document 713 to be downloaded into the mobile communication terminal 20, the function of receiving a computerized contract document 711 with an electronic signature and a user-side electronic certificate 711 both transmitted by the mobile communication terminal 20, the function of verifying the received electronic signature and user-side electronic certificate 711, and if the electronic signature and the user-side electronic certificate 711 are determined to be valid, transmitting the computerized contract document 713 with the user's electronic signature as well as the settlement company's electronic signature and the settlement company-side electronic certificate 712, to the mobile communication terminal 20, the function of receiving the computerized contract document original 714 transmitted by the mobile communication terminal 20 for storage, and the function of transmitting the computerized contract document original 714 to an apparatus specified by the financial institution (for example, the financial institution system 40 or a network terminal apparatus (for example, a PC) specified by the financial institution).

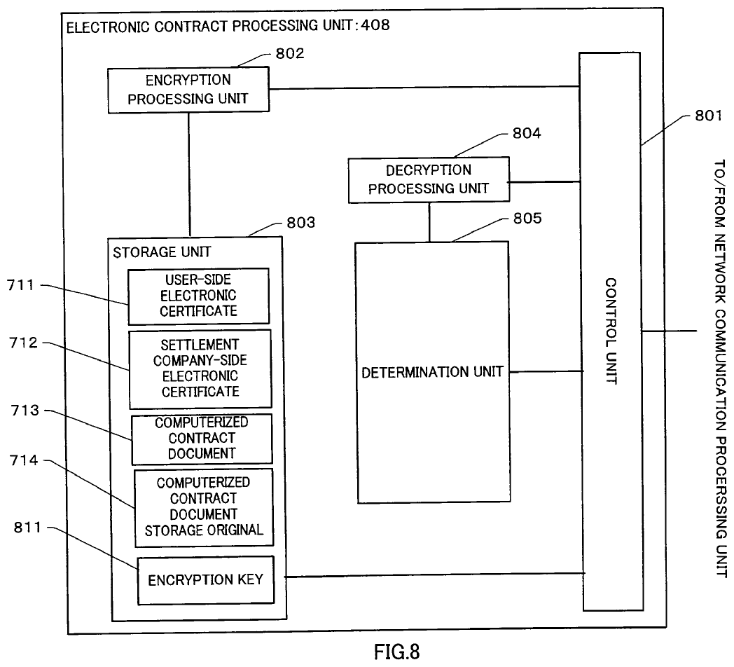

FIG. 8 is a function block diagram showing an example of the configuration of the electronic contract processing unit 408. As shown in FIG. 8, the electronic contract processing unit 408 has a control unit 801, an encryption processing unit 802, a storage unit 803, a decryption processing unit 804, and a determination unit 805.

The control unit 801 has the function of integrally controlling the operation of the encryption processing unit 802, storage unit 803, decryption processing unit 804, and determination unit 805 to order starting of each of these units, input and output of data to and from each unit, and the like.

The encryption processing unit 802 has the function of generating the settlement company's electronic signature by a predetermined encryption method using an encryption key 811.

The storage unit 803 has the function of storing the user-side electronic certificate 711, the settlement company-side electronic certificate 712, the computerized contract document 713, the computerized contract document original 714, the encryption key 811, and the like.

The user-side electronic certificate 711, settlement company-side electronic certificate 712, computerized contract document 713, and computerized contract document original 714 are the same as those stored in the storage unit 703 of the electronic contract applying unit 20. Thus, the description of these units is omitted.

The encryption key 811 is used by the electronic settlement company to generate an electronic signature or to decrypt encrypted information transmitted by the mobile communication terminal 20. The encryption key 811 is, for example, a secrete key for a public key scheme or a common encryption key for a common key scheme.

The settlement company-side electronic certificate 712 and the encryption key 811 may be pre-acquired from the authentication server 90, that is, the certification authority (CA), for storage.

The decryption processing unit 804 has the function of decrypting the user's electronic signature transmitted by the mobile communication terminal 20.

The determination unit 805 has the function of verifying the user's electronic certificate and electronic signature transmitted by the mobile communication terminal 20 together with the computerized contract document.

Upon receiving the computerized contract document storage original 714, corresponding to the computerized contract document with the time stamp and the electronic signature, the control unit 801 allows the storage unit 803 to store the computerized contract document storage original 714. The control unit 801 further transmits the computerized contract document storage original destined for the bank in which the user's account is present.

### I.1.4 Communication Network

FIG. 1 is referred to again, and the description of the components of the electronic settlement system 1 according to the present embodiment will be restarted.

Whether the communication network 50 is a wired or wireless network and uses a leased or switched circuit, the communication network 50 operates to enable information transmission between apparatuses connected to the communication network 50 when each of the apparatuses establishes a session with the target apparatus. The communication network 50 may be implemented by combining a plurality of networks via gateways as in the Internet. Furthermore, the connections may be temporary ones like PPP connections instead of direct connections to what is called a backbone provided that information can be transmitted between the apparatuses when each of the apparatuses establishes a session with the other. The “communication network” may be a communication network not using path switching means such as switching equipment, a switch, or a router which has fixedly distributed leased circuits.

### I.1.5 Mobile Communication Network, Gateway, and Base Station

In the example shown in FIG. 1, it is assumed that a cellular phone is used as the mobile communication terminal 20. Thus, in the figure, the cellular phone serving as the mobile communication terminal 20 connects first to the base station 60 through a radio circuit and then via the mobile communication network 70 and the gateway 80 to the communication network 50, to which the electronic settlement server 10 is connected. However, provided that the mobile communication terminal 20 can be connected directly to the communication network 50, the mobile communication terminal 20 may be connected to the electronic settlement server 10 without passing through the mobile communication network 70 or the gateway 80. For example, if the mobile communication terminal 20 has a radio LAN connection function, communication via the mobile communication network 70 and the gateway 80 is not required.

### I.1.6. Financial Institution System

In response to an inquiry about the user's credit status from the electronic settlement server 1, the financial institution system 40 replies to the electronic settlement server 1 with the credit status. In response to a transfer request from the electronic settlement server 10, the financial institution system 40 can execute a transfer process (a transfer of money from one account to another) or request a certain apparatus to execute the transfer process. The financial institution system 40 may be an accommodation system such as a multi-payment network (see, for example, http://www.jampa.gr.jp/pub/) which is not run directly by a financial institution. The system replying to the electronic settlement server 10 with the credit status need not necessarily be the same as that executing the transfer process. Furthermore, in the example shown in FIG. 1, the electronic settlement server 10 is connected to the financial institution system 40 via a leased circuit. However, the present embodiment can be implemented even when the electronic settlement server 10 and the financial institution system 40 are connected together via the communication network 50. If for example, the financial institution system 40 is a system prepared by what is called an Internet bank, the electronic settlement server 10 and the financial institution system 40 may be connected together via the communication network 50.

Furthermore, the financial institution system 40 may have the function of receiving and storing the computerized contract document original 714 transmitted, by the electronic settlement server 10, to the financial institution having the user's account. Based on the computerized contract document original 714, the financial institution can determine that the both the user and the settlement company agree that the settlement company withdraws the specified amount from the user's account. It is assumed that after the reception of the computerized contract document original 714, the settlement company receives a request message requesting that the settlement company withdraw the specified amount from the user's account. Then, the computerized contract document original 714 serves as a legal ground for the transfer, by the financial institution system 40, of the specified amount from the user's account in response to the request message even without any special instruction from the user.

### I.1.7. Authentication Server

The authentication server 90 is an apparatus including a central processing unit (CPU), a main memory (RAM), a read only memory (ROM), an I/O device (I/O), and an external storage device such as a hard disk device as required. The authentication server 90 is, for example, an information processing apparatus such as a computer or a workstation.

The authentication server 90 may further have the function of issuing the user-side electronic certificate 711 and/or the settlement company-side electronic certificate 712 and managing a CRL (Certificate Revocation List) that is a list of the validity of the user-side electronic certificate 711 and/or the settlement company-side electronic certificate 712 and replying to an inquiry about the validity.

### I.1.8. Time Stamp Service

The time stamp server 95 is an apparatus including a central processing unit (CPU), a main memory (RAM), a read only memory (ROM), an I/O device (I/O), and an external storage device such as a hard disk device as required. The time stamp server 95 is, for example, an information processing apparatus such as a computer or a workstation.

The time stamp server 95 has the function of, in response to a time stamp issuance request from the mobile communication terminal 90, generating and transmitting a time stamp token to the mobile communication terminal. The time stamp server 95 is an apparatus operating as a time stamp station (TSA: Time Stamping Authority) described in RFC 3161.

### I.2. Example of Operation of the Electronic Settlement System

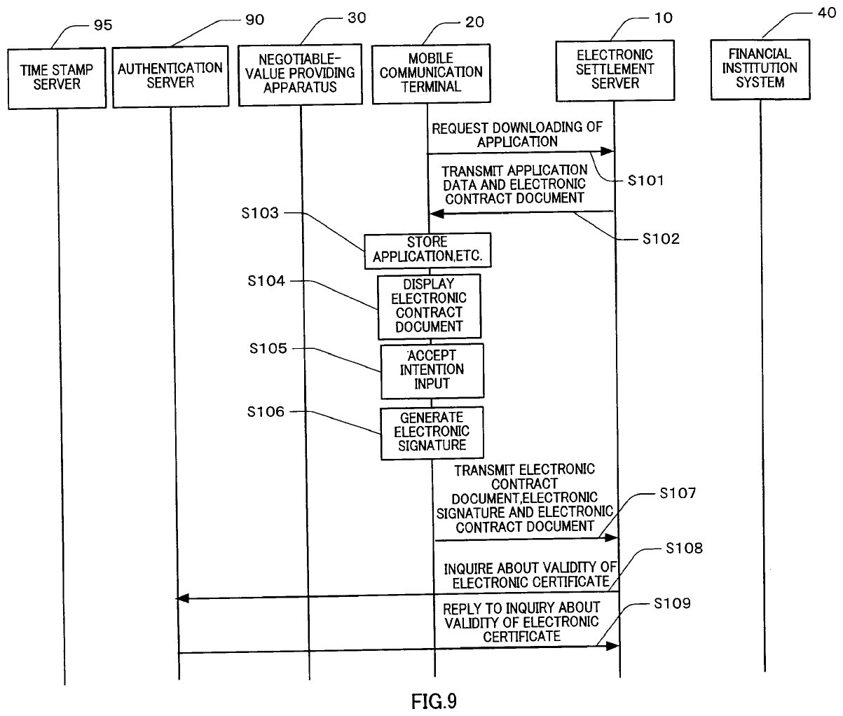

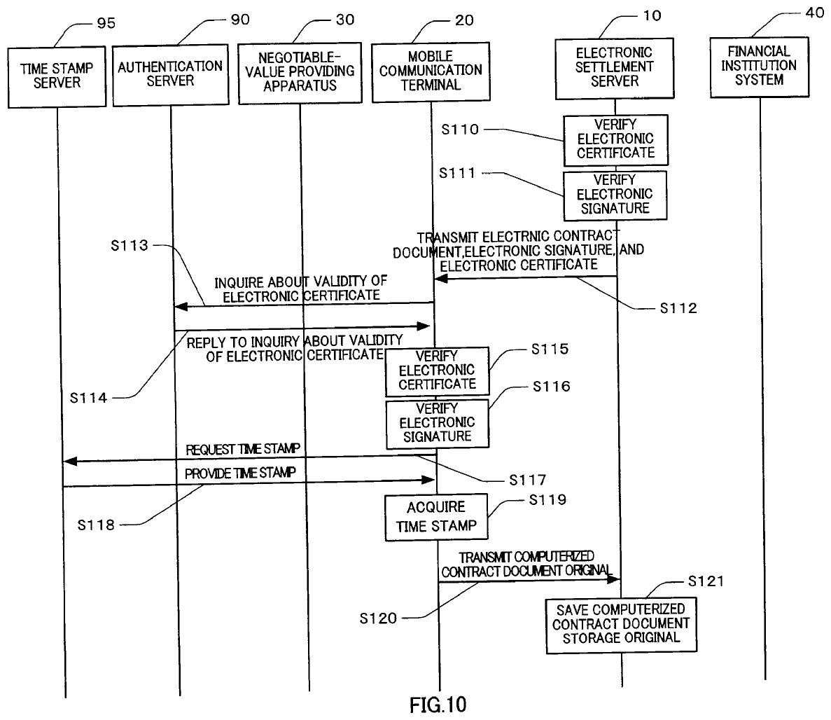

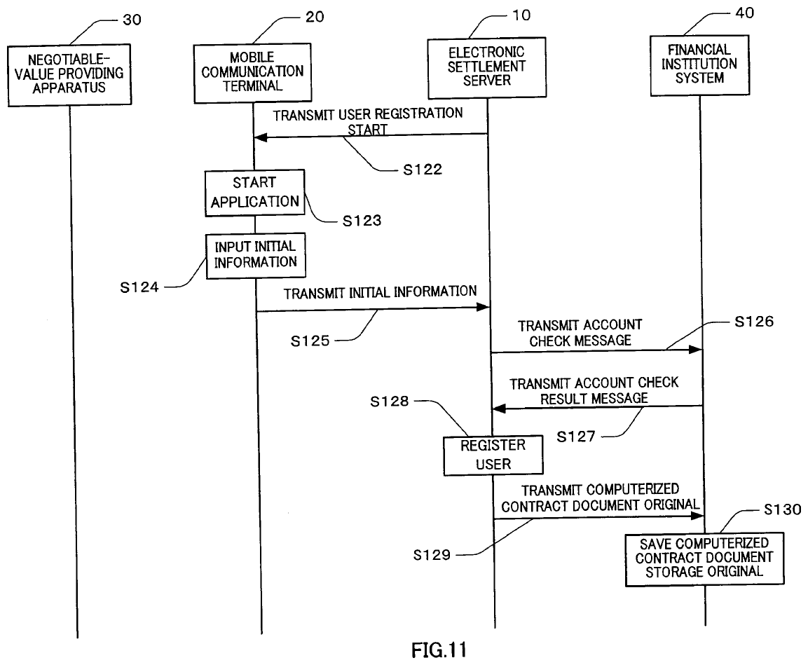

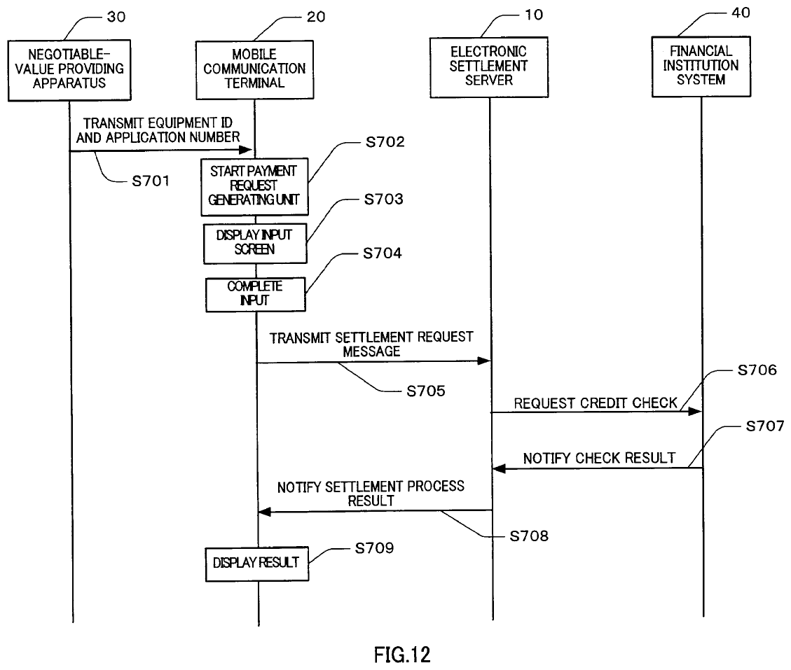

Now, the operation of the electronic settlement system 1 will be described with reference to FIGS. 9, 10, 11, and 12. FIGS. 9 and 10 are sequence diagrams showing an example of an operation performed by the electronic settlement system 1 during user registration. FIG. 11 shows an example of an operation performed when the user acquires a negotiable value through the electronic settlement system 1 after the user registration. FIG. 12 is a sequence diagram continued from FIG. 11.

First, the operation performed by the electronic settlement system 1 until the user is successfully registered will be described with reference to FIGS. 9 and 10 and the subsequent figures. FIGS. 9 and 10 are sequence diagrams showing an example of an operation performed by the electronic settlement system 1 when the user is registered in the electronic settlement system 1 using the mobile communication terminal 20.

First, the user connects the mobile communication terminal 20 to the electronic settlement server 10 and requests, from the electronic settlement server 10, software for the mobile communication terminal 20 (an application the function of which can be added to the mobile communication terminal 20 by downloading the application into the mobile communication terminal 20, for example, the i appli) which is required to receive services from the electronic settlement system 1 (S101). In response to the request, the electronic settlement server 10 allows the data of an application such as the i appli and the computerized contract document 713 to be downloaded into the mobile communication terminal 20 (S102). Upon receiving the i appli and the computerized contract document 713, the mobile communication terminal 20 allows the data of the i appli and the like to be stored in a storage device such as a memory, while allowing the computerized contract document 713 to be stored in the storage unit 703 (S103). The i appli is executed by the CPU in the mobile communication terminal 20 or the like to function as the above-described payment request generating unit 202, transfer request generating unit 207, electronic contract applying unit 206, or the like.

In the above-described embodiment, the electronic settlement server 10 is also used as a server for downloading of the application such as the i appli and a server for downloading of the computerized contract document 713. However, of course, the server for downloading of the application such as the i appli and/or the server for downloading of the computerized contract document 713 may be an apparatus or a system that is separate from the electronic settlement server 10.

The downloaded i appli is started by the user's predetermined operation via the mobile communication terminal 20 (S104). Upon being started for the first time after downloading, the electronic contract applying unit 206, that is, the i appli, allows the output unit 205 to display the computerized contract document 713 (S104). The electronic contract applying unit 206 thus urges the user to check the contents of the computerized contract document.

Then, the mobile communication terminal 20, more specifically the electronic contract applying unit 206, accepts an input indicating whether or not the user is to sign the electronic contract (S105). For example, the liquid crystal display, that is, the output unit 205, displays the message “Contents of contract are displayed. Will you sign contract? YES/NO” or the like to urge the user to input an answer. If the user opts to sign the contract according to the contents of the computerized contract document 713, the electronic contact applying unit 206, more specifically the encryption processing unit 702, uses the encryption key 715 to generate an electronic signature (S106). In the present embodiment, the electronic signature corresponds to a hash value for the computerized contract document 713 in which the user's address, name, and the like are filled, the hash value being encrypted according to an RSA encryption scheme using the encryption key 715. However, the present invention is not limited to this aspect. For example, information may be used which allows the user to be uniquely identified and which is obtained by encrypting data that cannot be easily known by the third party. However, in this case, the electronic certificate 711 is not utilized.

Then, the mobile communication terminal 20, more specifically the electronic contract applying unit 206, transmits the computerized contract document 713 (in which the user's address and name are additionally filled), the electronic signature generated in S106, and the user-side electronic certificate 711 to the electronic settlement server 10 (S107).

Upon receiving the computerized contract document 713 and others transmitted in the above-described S107, the electronic settlement server 10 inquires of the authentication server 90, that is, an institution issuing the user-side electronic certificate, about the validity of the user-side electronic certificate 711 (S108). The authentication server 90 references the CRL (Certified Revocation List) to determine the validity of the user-side electronic certificate 711. The authentication server 90 then transmits the result of the determination to the electronic settlement server 10 (S109).

If the result of the determination indicates that the user-side electronic certificate 711 is valid, the electronic settlement server 10 executes a process of verifying the user-side electronic certificate 711 (S110). That is, the electronic settlement server 10 uses the public key of the certification authority (CA) to decrypt the electronic signature on the user-side electronic certificate 711 to determine whether the electronic signature has been written by the certification authority (CA). The electronic settlement server 10 further determines whether or not the user-side electronic certificate 711 has been altered. If the verifications in S109 to S111 are all successful, the user-side electronic certificate 711 is determined to be credible, that is, the encryption key (for example, the public key according to the public encryption key scheme) described in the user-side electronic certificate 711 is determined to belong to the user.

If the verification of the user-side electronic certificate 711 is successful, the electronic settlement server 10 verifies the electronic signature attached to the computerized contract document 713 (S111). That is, the electronic settlement server 10 uses the encryption key described in the user-side electronic certificate 711 to decrypt the electronic signature attached to the computerized contract document 713. The electronic settlement server 10 thus verifies the electronic signature and determines the validity of the computerized contract document 713 (the computerized contract document 713 has not been altered).

If the verification of the electronic signature in S111 is successful, the electronic settlement server 10 determines that the computerized contract document 711 has been validly signed by the user. The electronic settlement server 10 further attaches the settlement company's electronic signature to the computerized contract document 713 (to which the user's electronic signature is already attached) received from the mobile communication terminal 20. The electronic settlement server 10 also attaches the settlement company-side electronic certificate 712 to the computerized contract document 713. The electronic settlement server 10 transmits the computerized contract document 713, the settlement company's electronic signature, and the settlement company-side electronic certificate 712 to the mobile communication terminal 20 (S112).

Upon receiving the computerized contract document 713 and others transmitted in step S112, the mobile communication terminal 20 inquires of the authentication server 90, that is, an institution issuing the settlement company-side electronic certificate 712, about the validity of the settlement company-side electronic certificate 712 (S113). The authentication server 90 references the CRL (Certified Revocation List) to determine the validity of the settlement company-side electronic certificate 712. The authentication server 90 then transmits the result of the determination to the mobile communication terminal 20 (S114).

If the result of the determination indicates that the settlement company-side electronic certificate 712 is valid, the mobile communication terminal 20 executes a process of verifying the settlement company-side electronic certificate 712 (S115). That is, the mobile communication terminal 20 uses the public key of the certification authority (CA) to decrypt the electronic signature on the settlement company-side electronic certificate 712 to determine whether the electronic signature has been written by the certification authority (CA). The mobile communication terminal 20 further determines whether or not the settlement company-side electronic certificate 712 has been altered. If the verifications in S113 to S115 are all successful, the settlement company-side electronic certificate 712 is determined to be credible, that is, the encryption key (for example, the public key according to the public encryption key scheme) described in the settlement company-side electronic certificate 712 is determined to belong to the settlement company.

If the verification of the settlement company-side electronic certificate 712 is successful, the mobile communication terminal 20 verifies the settlement company's electronic signature attached to the computerized contract document 713 (S116). That is, the mobile communication terminal 20 uses the encryption key described in the settlement company-side electronic certificate 712 to decrypt the settlement company's electronic signature attached to the computerized contract document 713. The mobile communication terminal 20 thus verifies the settlement company's electronic signature and determines the validity of the computerized contract document 713 (the computerized contract document 713 has not been altered).

If the verification of the settlement company's electronic signature in S116 is successful, the mobile communication terminal 20 determines that the computerized contract document 713 has been validly signed by the settlement company.

Then, the mobile communication terminal 20 transmits the computerized contract document 713 (or a hash value therefor) with the user's electronic signature and the settlement company's electronic signature, to the time stamp server 95. The mobile communication terminal 20 thus requests the time stamp server 95 to issue a time stamp (S117). Upon receiving the time stamp request, the time stamp server 95 applies a date and time to the hash value for the computerized contract document 713 with the user's electronic signature and the settlement company's electronic signature to generate a digitally signed time stamp token. The time stamp server 95 then transmits the time stamp token to the mobile communication terminal 20 (S118).

The mobile communication terminal 20 acquires the time stamp token (S119). Then, the mobile communication terminal 20 adds the time stamp token to the computerized contract document 713 with the user's electronic signature and the settlement company's electronic signature to obtain a computerized contract document storage original 714. The mobile communication terminal 20 stores the computerized contract document storage original 714 in the storage unit 703, and transmits the computerized contract document storage original 714 to the electronic settlement server 10 (S120).

Upon receiving the computerized contract document storage original 714, the electronic settlement server 10 stores the computerized contract document storage original 714 in the storage unit 803 (S121).

Thus, a contract for withdrawal substitution is signed between the user and the settlement company. Under the condition that the computerized contract document storage original 714 is stored in the electronic settlement server 10, the electronic settlement server 10 accepts the user registration. That is, if the computerized contract document storage original 714 is not stored in the electronic settlement server 10, the user is not registered and cannot start utilizing the electronic settlement system 1. In other words, storing the computerized contract document storage original 714 in the electronic settlement server 10 is essential for the user registration.

Now, the operation of the electronic settlement system 1 after step S121 will be described with reference to FIG. 11. In the sequence diagrams following FIG. 11, the illustration of the authentication server 90 and the time stamp server 95 is omitted.

Using the completion of step S121 as a trigger, the electronic settlement server 10 transmits a user registration start message to the mobile communication terminal 20 (S122).

Upon receiving the user registration start message, the mobile communication terminal 20 starts the i appli (S123). When started for the first time after downloading, the i appli allows the output unit 205 to display an initial input screen via which the user inputs initial information, thus urging the user to input the initial information (S124). Here, the requested initial information includes a user ID 602, a password 603, a mail address 604, a bank number 605, a branch office number 606, a account type 607, an account number 608, an account holder's name 609, and a personal identification number 610. The user ID 602 and the password 603 may be preset by the electronic settlement server 10 without the need for the user's input.

The user completes inputting the initial information using the input unit 204 of the mobile communication terminal 20. Then, the mobile communication terminal 20 connects to the electronic settlement server 10 via the communication network 50 and transmits the input initial information and the like to the electronic settlement server 10 (S125).

Upon receiving the initial information, the electronic settlement server 20 transmits, to the financial institution system 40, an account check request message inquiring of the financial institution system 40 whether or not the initial information is correct and whether or not the input user account is available (S126). Upon receiving the account check request message, the financial institution system 40 searches an account database or the like for the presence and validity of the user account indicated as a check target in the account check request message. The financial institution system 40 transmits the result of the determination to the electronic settlement server 10 as an account check result message (S127). If the account check result message indicates that the input account information is incorrect or the account is unavailable, the electronic settlement server 10 having received the account check result message transmits a message urging the initial information to be input again, to the mobile communication terminal 20 (not shown in FIG. 11). On the other hand, if the account check result message indicates that the input account information is correct and that the input account is available, the electronic settlement server 10 having received the account check result message registers the user based on the input initial information (S128). That is, the electronic settlement server 20 adds new records 601 and 701 to a user table 600 and a user retained amount data 700, respectively, both of which are located in the database unit 403. The electronic settlement server 20 thus writes the user ID 602, password 603, mail address 604, bank number 605, branch office number 606, account type 607, account number 608, account holder's name 609, personal identification number 610 and the like, into the records 601 and 701.

Once the above-described user registration (S128) is completed, the electronic settlement server 10 transmits the computerized contract document original 714 to the financial institution system 40 (129). The financial institution system 40 receives and stores the computerized contract document original 714 (130). In the present example, the financial institution system 40 receives the computerized contract document original 714. However, any apparatus can receive the computerized contract document original 714 provided that the apparatus enables the financial institution having the user account to confirm the signing of the contact based on the computerized contract document original 714.

Furthermore, in the above-described example, the transmission of the computerized contract document original 714 to the financial institution system 40 follows the user registration (S128). However, the present invention can be implemented regardless of the timing when the computerized contract document storage original 714 is transmitted to the financial institution system 40, provided that the transmission follows the generation of the computerized contract document original 714 (the transmission follows S119).

After the user registration (S128) is completed, the user can utilize the electronic settlement system 1. An example of the operation of the electronic settlement system 1 following the user registration will be described below with reference to FIG. 12.

It is assumed that the user first utilizes the present electronic settlement system to attempt to allow the negotiable-value providing apparatus 30 to provide a negotiable value.

In this case, the user allows the mobile communication terminal 20 and the negotiable-value providing apparatus 30 to carry out short-distance communication so that the mobile communication terminal 20 can acquire the equipment ID of the negotiable-value providing apparatus 30. For example, it is assumed that the terminal-side short-distance communication unit 201 is an IC chip for non-contact IC cards and that the providing apparatus-side short-distance communication unit 303 is a reader/writer. Then, upon sensing that the chip for non-contact IC cards is nearby, the reader/writer serving as the providing apparatus-side short-distance communication unit 303 transmits the equipment ID and the application number corresponding to the payment request generating unit 202 to the chip for non-contact IC cards serving as the terminal-side short-distance communication unit 201 (S701).

Upon receiving the equipment ID and the application number, the terminal-side short-distance communication unit 201 starts the application such as the i appli which corresponds to the application number, that is, the payment request generating unit 202 (S702). At this time, the equipment ID is passed to the payment request generating unit 202.

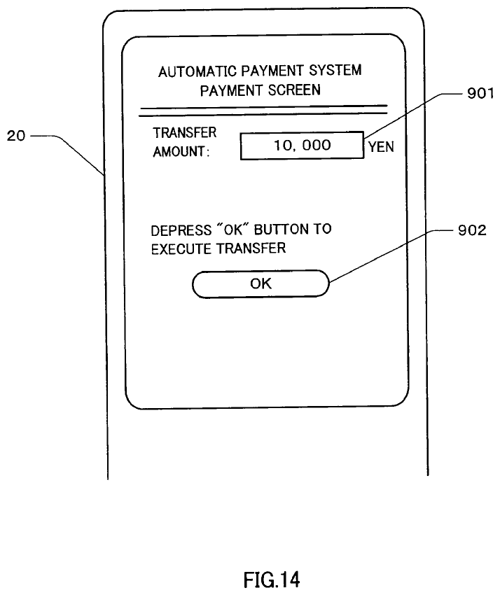

The started payment request generating unit 202 allows the liquid crystal display serving as the input unit 205 to display an input screen accepting user's inputs (S703). FIG. 14 is a diagram showing an example of the input screen displayed on the liquid crystal display serving as the input unit 205. The example of the input screen includes an amount input box 901 and an OK button 902. The user inputs the price of the negotiable value to be provided by the negotiable-value providing apparatus 30, to the amount input box 901. If any amount has already been input to the amount input box 901, the payment request generating unit 202 may store and automatically display the amount in the amount input box 901. The payment request generating unit 202 may thus generate a settlement request message with this amount unless the user changes the input. After the amount input to the amount input box 901 is confirmed, the user operates the input unit 204 to activate the OK button 902 to complete the user input (S704). Then, the payment request generating unit 202 generates and transmits a settlement request message to the electronic settlement server 10 (S705).

Here, the OK button 902 has the function of executing, in response to one operation, a process of determining a transfer amount specified as consideration for the negotiable value by the mobile communication terminal 20 and a process of executing a settlement request for provision of the negotiable value corresponding to the transfer amount.

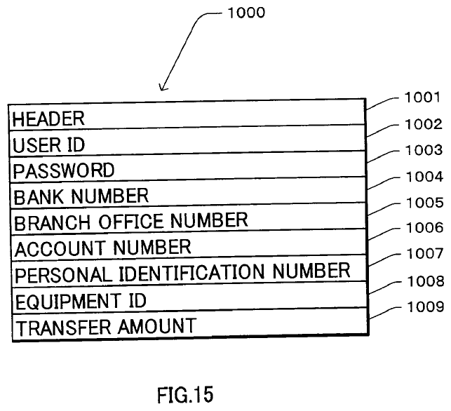

FIG. 15 shows an example of the data configuration of a settlement request message generated by the payment request generating unit 202. The settlement request message 1000 shown in FIG. 15 is data composed of a header 1001, a user ID 1002, a password 1003, a bank number 1004, a branch office number 1005, an account number 1006, a personal identification number 1007, an equipment ID 1008, and a transfer amount 1009. The header 1001 is data indicating that the data generated by the payment request generating unit 202 is a settlement request message. The user ID 1002, password 1003, bank number 1004, branch office number 1005, account number 1006, and personal identification number 1007 store the user ID 101, the password 102, used by the electronic settlement server 10 to authenticate the user, the bank number 103, branch office number 104, and account number 105, identifying the account from which the user withdraws the charge to be paid, and the personal identification number 106, set for the account (FIG. 3); all the pieces of information are pre-stored in the payment request generating unit 202 described above. Furthermore, the equipment ID 1008 has been transmitted by the negotiable-value providing apparatus 30 in S701. The transfer amount 1009 is information input to the amount input box 901 on the input screen.

FIG. 12 is referred to again, and the operation of the electronic settlement system 1 will be continuously described.

Upon receiving the settlement request message 1000, the electronic settlement server 10, more specifically the payment request processing unit 402 starts the credit check unit 404. The payment request processing unit 402 then allows the credit check unit 404 to transmit a credit check request to the financial institution system 40 (S706). The credit check request inquires of the financial institution system 40 about the paying capacity of the user corresponding to the user ID contained in the settlement request message 1000.

The financial institution system 40 examines the user's credit information to determine whether or not the user can pay the requested amount, by checking the account balance and the like. The financial institution system 40 then transmits the result of the determination to the electronic settlement server 10 as a check result notification (S707).

Upon receiving the check result notification from the financial institution system 40, the electronic settlement server 10, more specifically the payment request processing unit 402 starts a result notifying unit 407 to generate a processing result notification based on the check result notification received from the financial institution system 40. The payment request processing unit 402 then transmits the processing result notification to the mobile communication terminal 20 (S708).

Upon receiving the processing result notification, the mobile communication terminal 20 displays the contents of the processing result notification on the output unit 205 (S709). The displayed contents are, for example, “Settlement request has been processed. Thank you for allowing us to serve you.” or “Short balance. Settlement has failed.”

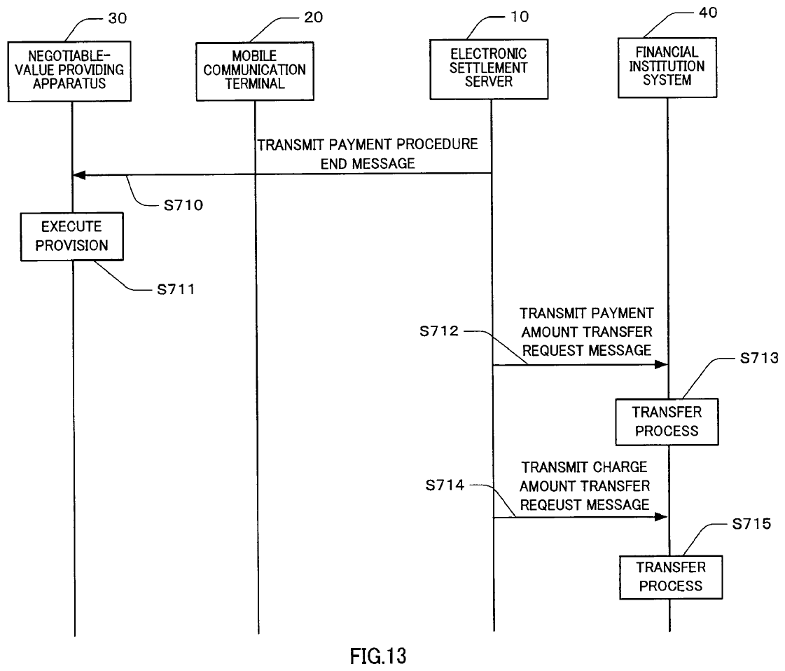

Now, the example of the operation of the electronic settlement system 1 will be continuously described with reference to FIG. 13. FIG. 13 is a sequence diagram continued from FIG. 12 and showing the example of the operation of the electronic settlement system 1. If the result of the determination of the credit status by the financial institution system 40 indicates that the user can pay the charge, the electronic settlement server 10, more specifically the provision instructing unit 406 transmits a payment procedure end message to the negotiable-value providing apparatus 30 (S710). The payment procedure end message corresponds to a telegram indicating that a payment procedure corresponding to the user specified amount is finished.

Destination information (for example, an IP address) on the negotiable-value providing apparatus 30, corresponding to the destination of the payment procedure end message, may be acquired from the negotiable-value providing apparatus table 600 stored in the database unit 403. The payment procedure end message contains amount information corresponding to a transfer amount 1009. However, the amount information may indicate the original amount from which an amount such as a transfer fee has been subtracted.

Upon receiving the payment procedure end message, the negotiable-value providing apparatus 30 provides the user with a negotiable value of a quantity corresponding to the amount information contained in the payment procedure end message (S711).

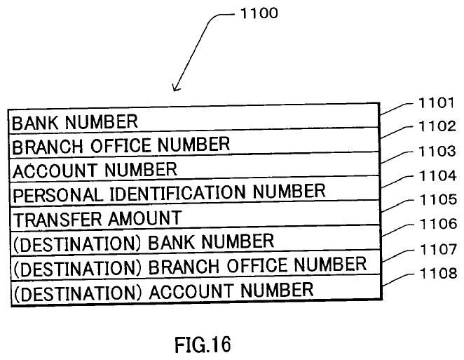

On the other hand, the electronic settlement server 10 transmits, to the financial institution system 40, a transfer request message requesting the financial institution system 40 to transfer the user specified amount from the user's account to the account of the administrator, operator, or the like of the negotiable-value providing apparatus 30 who is qualified to acquire sales of the negotiable-value providing apparatus 30 (hereinafter simply referred to as the “administrator”) (S712). FIG. 16 is a diagram showing an example of the data configuration of the transfer request message. A transfer request message 1100 contains a bank account 1101, a branch office number 1102, and an account number 1103 which are pieces of information identifying the user's debit account, and a personal identification number 1104 indicating that the user approves the withdrawal. The transfer request message 1100 further contains a transfer amount 1105, and a (destination) bank number 1106, a (destination) branch office number 1107, and a (destination) account number 1108 which are pieces of information indicating the administrator' account corresponding to the destination account.

The bank account 1101, branch office number 1102, account number 1103, and personal identification number 1104 are generated based on the bank account 1004, branch office number 1005, account number 1006, personal identification number 1007, and transfer amount 1009 contained in the settlement request message 1000. The (destination) bank number 1106, (destination) branch office number 1107, and (destination) account number 1108 are generated based on the equipment ID 1008 and data acquired from the negotiable-value providing apparatus table 600.

Upon receiving the above-described transfer request message, the financial institution system 40 executes a transfer process of transferring the specified transfer amount from the user's account to the administrator's account (S713). Thus, the payment of the consideration for the negotiable value the user has received from the negotiable-value providing apparatus 30 is completed.

The operator, administrator, or the like of the electronic settlement server 10 (hereinafter referred to as the settlement company) qualified to acquire profits through the operation of the electronic settlement server 10 may receive the charge from the user or the administrator. In this case, the electronic settlement server 10 transmits, to the financial institution system 40, a transfer request message requesting the financial institution system 40 to transfer the amount corresponding to the charge from the user's or administrator's account to the settlement company's account (S714). Upon receiving the transfer request message, the financial institution system 40 executes a transfer process of transferring the specified transfer amount from the user's or administrator's account to the settlement company's account (S715). Thus, the settlement company can gain profits through the operation of the present electronic settlement system.

### I.3. Advantages of the Present Electronic Settlement System

(1) Advantages for the User

The present settlement method is different from cash payment and can be used in game halls. Thus, even when running short of cash in hand in a game hall, the user can buy rental balls, rental medals, any product, or the like by an easy settlement action (the process of performing an easy input operation such as the activation of the OK button 902 on the mobile communication terminal 20). The user can feel secure to utilize the method through the function of, for example, requesting the user to input the personal identification number when a pre-settable usage accumulated amount for one month and/or the maximum usage amount per day is reached, in order to cope with the loss of the card and to inform the user of overspending of which the user knows nothing.

Furthermore, the user can feel secure to carry out the settlement action because the user's mobile communication terminal is used for the settlement action. The user can further feel secure to settle the account because of the non-need to input the card number or the personal identification number, preventing the record of the card number or the personal identification number from remaining in the shop or being unfairly acquired by a malicious person as is the case with ordinary credit and debit cards.

Furthermore, information distribution is available which is based on usage information acquired by the electronic settlement server 10. Thus, more various services are expected to be available.

(2) Advantages for the Shop (Administrator)

Even when running short of cash in hand as a result of playing games, the user can further buy a negotiable value via the present electronic settlement system. This increases the operation rate of the game machines and the possibility that such users make a purchase in the shop. Thus, the sales of the game hall are expected to increase. Furthermore, information is available which indicates the game machines on which the user has played and the amount of money for which the user has played. Consequently, based on the information, the operation status of the game machines can be determined in detail, and the user's preferences can also be known. Therefore, the information can be utilized for marketing.

The use of the present electronic settlement system avoids increasing cash used in the shop. This facilitates credit management and improves security management.

(3) Advantages for the Electronic Settlement Company

The operation of the present electronic settlement system enables the electronic settlement company to determine the playing statuses of players who are users. The electronic settlement company can thus accumulate data to be referenced for the development, sale, marketing, or the like of game machines.

### I.4. Variations and Others

(1) QR codes or the like may be displayed on the liquid crystal display provided in the negotiable-value providing apparatus 30. Furthermore, a bar code reader utilizing a CCD camera may be provided in the mobile communication terminal 20 to read bar codes. These arrangements may replace the providing apparatus-side short-distance communication unit 303 and the terminal-side short-distance communication unit 201. In this case, information indicated by the bar code may directly be the equipment ID.

(2) In the above-described embodiment, the user's credit check is carried out by the electronic settlement server 10 inquiring of the financial institution system 40. However, the present invention can also be implemented when the electronic settlement server 10 has a credit amount table in the database unit 403 to carry out credit checks by itself. A creditable amount and a credit balance are stored in the credit amount table for each user. If the credit balance is equal to or more than a transfer request amount, the amount is permitted to be paid.

(3) In the above-described embodiment, the transfer amount is transferred directly from the user's account to the shop's (administrator's) account. However, the present invention can also be implemented by transferring the transfer amount from the user's account to the electronic settlement company's account and then transferring the transfer amount from which the transfer fee is subtracted from the electronic settlement company's account to the shop's (administrator's) account.

(4) The present invention can be implemented regardless of whether the authentication server 90, serving as the certification agency (CA), is another company's server commonly used or a server constructed by the settlement company.

### II. Second Embodiment

Now, a second embodiment of the present invention will be described.

### I.1. Example of the Configuration of the Electronic Settlement System

An electronic settlement system 1A according to the second embodiment is configured almost similarly to the electronic settlement system 1 according to the first embodiment. The same components as those in the first embodiment are denoted by the same reference numerals and will not be described in detail.

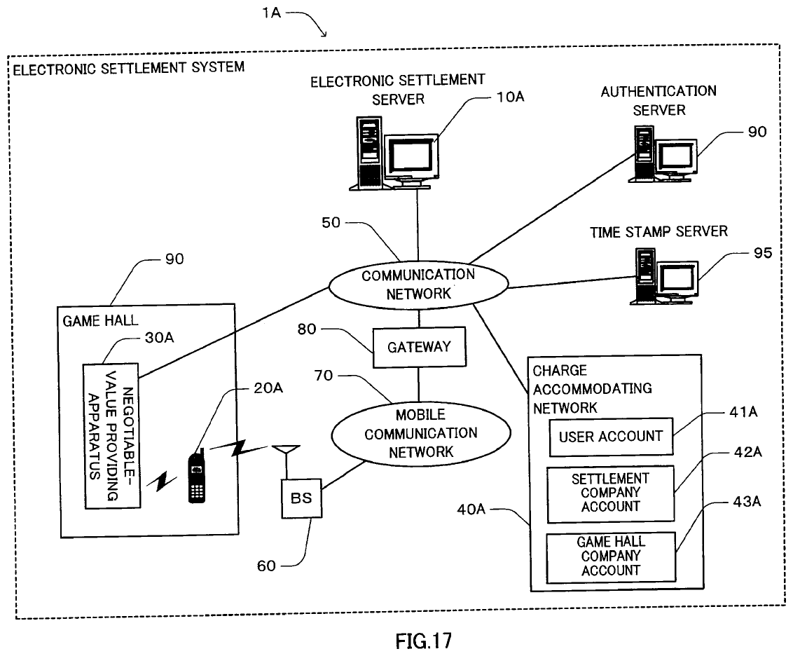

FIG. 17 is a network diagram showing an example of an electronic settlement system according to the second embodiment.

In the example shown in FIG. 17, the electronic settlement system 1A has an electronic settlement server 10A, a mobile communication terminal 20A, and a negotiable-value providing apparatus 30A. Furthermore, a charge accommodating network 40A, an authentication server 90, and a time stamp server 95 are connected to the electronic settlement system 1A so as to be able to communicate with the electronic settlement system 1A.

The electronic settlement server 10A is connected to the charge accommodating network 40A. The charge accommodating network 40A executes a process of transferring a specified amount from the user's account to a specified destination account based on an instruction from the electronic settlement server 10A. The charge accommodating network 40A is, for example, the “Multi-Payment Network” (see, for example, http://www.jampa.gr.jp/pub/) operated in Japan.

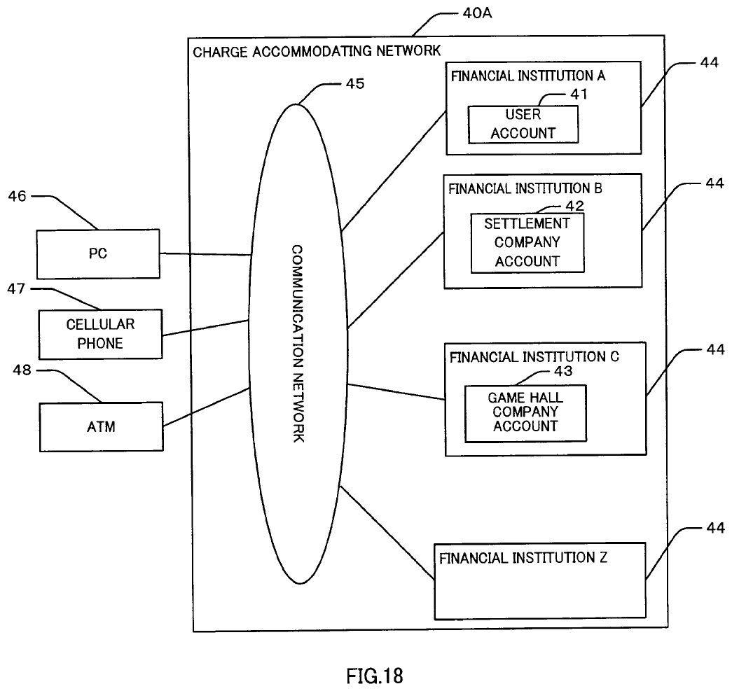

FIG. 18 is a block diagram showing the general configuration of the charge accommodating network 40A. A financial institution system 44 of a financial institution such as a bank (including a form such as a sharing center) is connected to the charge accommodating network 40A via a communication network 45 so that the financial institution system 44 and the charge accommodating network 40A can communicate with each other. The financial institution system 44 can electronically transfer money to and from the following accounts. The financial institution system 40 utilized by the present electronic settlement system 1A has an account (hereinafter referred to as a user account 41) of a party playing games on game machines (hereinafter referred to as a user) paying a charge using the present electronic settlement system, an account (hereinafter referred to as a settlement company account 42) of a party (hereinafter referred to as a settlement company) directly or indirectly operating and managing the present electronic settlement system 1A to receive consideration, a price, or a charge, or the like for the operation of the electronic settlement system 1A, and an account (hereinafter referred to as a game hall company account 43) of a party (hereinafter referred to as a game hall company) providing the user with games played on game machines and receiving the user's payment using the present electronic settlement system 1A. The accounts 41, 42, and 43 may be provided in the same financial institution system 44 or in separate financial institution systems 44. FIG. 18 shows that the accounts 41, 42, and 43 are provided in the different financial institution systems 44. However, the present embodiment is not limited to this aspect.

A terminal apparatus is connected to the communication network 45 so that a client can transmit a payment request to the charge accommodating network 40A. A personal computer (PC) 46, a cellular phone 47, an ATM (Automated Teller Machine) 48, or the like is used as the terminal apparatus. In the electronic settlement system 1A according to the present embodiment, the mobile communication terminal 20A or the electronic settlement server 10A operates as a terminal apparatus for the charge accommodating network 40A.

FIG. 17 is referred to again, and the configuration of the electronic settlement system 1A will be continuously described.

The electronic settlement server 10A is connected to a communication network 50 and can communicate with the negotiable-value providing apparatus 30A via the communication network 50. The mobile communication terminal 20A can communicate with the electronic settlement server 10A and the charge accommodating network 40A via a base station 60, a mobile communication network 70, and a gateway 80 connecting the mobile communication network 70 and the communication network 50 together. The mobile communication terminal 20A can also communicate with the negotiable-value providing apparatus 30A via short-distance communication means. The authentication server 90 can be connected to the electronic settlement server 10A and the mobile communication terminal 20A via the communication network 50 and the mobile communication network 70. The time stamp server 95 can be connected to the mobile communication terminal 20A via the communication network 50 and the mobile communication network 70. The components of the electronic settlement system 1A will be described below.

### II.1.1. Negotiable-Value Providing Apparatus

The negotiable-value providing apparatus 30A provides a certain negotiable value (a tangible object or an intangible object that can be bought in exchange for money) to the user as consideration for electronic settlement carried out by the user using the mobile communication terminal 20A. The negotiable-value providing apparatus 30A in the present embodiment need not necessarily provide a negotiable value directly to a user. The negotiable-value providing apparatus 30A may be an apparatus such as a CAT terminal for debit cards which provides a negotiable value indirectly to a user by notifying a game hall (shop) of the possibility of electronic settlement to allow the game hall to deliver an article or the like to the user.

Furthermore, the negotiable-value providing apparatus 30A may output, transmit, or write electronic data to another apparatus or a storage medium as a negotiable value similarly to the negotiable-value providing apparatus 30 according to the first embodiment.

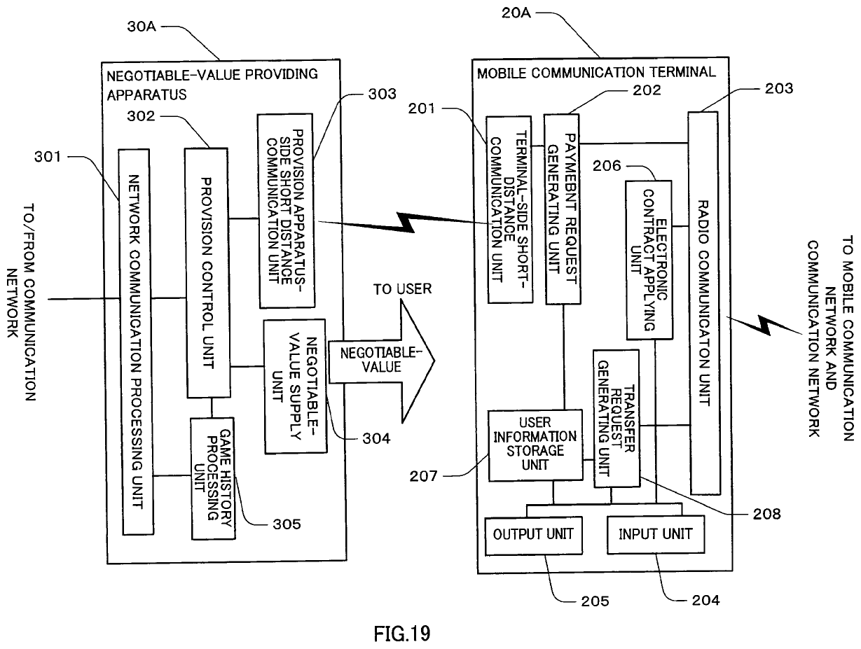

FIG. 19 is a function block diagram showing an example of the configuration of the negotiable-value providing apparatus 30A and the mobile communication terminal 20A. The configuration of the negotiable-value providing apparatus 30A will be described below with reference to FIG. 19. The same components as those of the negotiable-value providing apparatus 30 according to the first embodiment are denoted by the same reference numerals.

The negotiable-value providing apparatus 30A has a network communication processing unit 301, a provision control unit 302, a providing apparatus-side short-distance communication unit 303, a negotiable-value supply unit 304, and a game history processing unit 305. The network communication processing unit 301, provision control unit 302, providing apparatus-side short-distance communication unit 303, and negotiable-value supply unit 304 are the same as those of the negotiable-value providing apparatus 30 according to the first embodiment, and will thus not be described in detail.

The game history processing unit 305 has the function of generating game history data on the game history of a player based on the player's use of the negotiable-value providing apparatus 30A and transmitting the data to the server via the network communication processing unit 301.

It is assumed that the negotiable-value providing apparatus 30A is, for example, a ball renting machine provided in a particular game machine. To play games in the game machine in which ball renting machines are provided, the player obtains rental balls through settlement carried out by the present electronic settlement system 1A using the negotiable-value providing apparatus 30A, corresponding to the ball renting machine, and the player's cellular phone, corresponding to the mobile communication terminal 20A. The game history processing unit 305 generates game history data indicating which player played games, on which game machine the player played the games, when the player played the games, and how much the player spent in the games, based on the operational status of the provision control unit 302 and the operational status of the game machine. The game history processing unit 305 then transmits the game history data to the server managing the game history data. The game history data is transmitted to the server for storage every time each of all the negotiable-value providing apparatuses 30A is used. By analyzing the game history data and carrying out another analysis or the like according to a data mining technique or the like, the tendency of the player's action, the tendency of the popularity of the game machine, and an hourly use trend are clarified. As a result, useful information can be acquired which serves as a material for management of the shop and development of game machines.

In the configuration described in the present embodiment, the electronic settlement server 10A is used as the server managing the game history data. However, of course, the server managing the game history data may be incorporated into the present electronic settlement system 1A as a server apparatus different from the electronic settlement server.

### II.1.2. Mobile Communication Terminal

Now, the mobile communication terminal 20A will be described with reference to FIG. 19.

The mobile communication terminal 20A is a terminal apparatus that can communicate with the electronic settlement server 10A, the authentication server 90, the time stamp server 95, and/or the charge accommodating network 40A via the communication network 50 and also with the negotiable-value providing apparatus 30A using the short-distance communication means. The mobile communication terminal 20A is, for example, a cellular phone having a non-contact IC card (for example, FeliCa: Sony Corporation's registered trademark) function, a cellular phone including short-distance communication means and radio communication means, PDA (Personal Data Assistant), a portable game machine, or an IP telephone including a radio LAN communication apparatus.

The mobile communication terminal 20 has a terminal-side short-distance communication unit 201 allowing communication with the above-described providing apparatus-side short-distance communication unit 303, a payment request generating unit 202, a radio communication unit 203, an input unit 204, an output unit 205, and a user information storage unit 207, a transfer request generating unit 208, and an electronic contract applying unit 206. The same components of the mobile communication terminal 20 as those of the mobile communication terminal 30 according to the first embodiment are denoted by the same reference numerals, and will thus not be described in detail.

The user information storage unit 207 has the function of storing information required for the user's payment and settlement. The information stored in the user information storage unit 207 is similar to that shown in the first embodiment (see FIG. 19), and the description of the individual pieces of information is omitted.

The mobile communication terminal 20A has been described.

### II.1.3 Electronic Settlement Server

FIG. 17 is referred to again, and the components of the electronic settlement system 1A will be continuously described.

The electronic settlement system 1A has the electronic settlement server 10A as a core component. The electronic settlement server 10A is an apparatus including a central processing unit (CPU), a main memory (RAM), a read only memory (ROM), an I/O device (I/O), and an external storage device such as a hard disk device as required. The electronic settlement server 10A is, for example, an information processing apparatus such as a computer or a workstation. The ROM or the hard disk device or the like stores a program allowing the information processing apparatus to function as the electronic settlement server 10A or a program allowing an electronic settlement method to be executed by a computer. The program is placed on the main memory and executed by the CPU to implement the electronic settlement server 10A or the electronic settlement method. Furthermore, the program need not necessarily be stored in the storage device in the information processing apparatus. The program may be provided by an external apparatus (for example, a server such as an ASP (Application Service Provider)) and placed on the main memory. Moreover, the electronic settlement server 10A may be composed of a single apparatus or a plurality of apparatuses coupled together via a network. The electronic settlement server 10A may be configured as a center into which all functions are integrated or as distributed servers obtained by division according to functions so as to enable a distributed process.

The electronic settlement server 10A will be described below with reference to FIG. 20. FIG. 20 is a function block diagram showing an example of the configuration of the electronic settlement server 10A.

The electronic settlement server 10A shown in FIG. 20 has a network communication processing unit 401A, a payment request processing unit 402A, a database unit 403A, a transfer request processing unit 404A, a clearing processing unit 405A, provision instructing unit 406A, a result notifying unit 407A, a game information update unit 408A, and an electronic contract processing unit 409A. Each of these units is a component composed of, for example, a storage device in which a program is stored and a CPU executing the program.

The network communication processing unit 401A has the function of communicating with the mobile communication terminal 20A, the negotiable-value providing apparatus 30A, and the charge accommodating network 40A via the communication network 50. The network communication processing unit 401A is, for example, a communication board allowing the protocol stack to be carried out. Upon receiving a request message from the mobile communication terminal 20A, the network communication processing unit 401A passes the request message to the payment request processing unit 402A or the transfer request processing unit 404A. Furthermore, upon receiving a provision instruction message destined for the negotiable-value providing apparatus 30A from the provision instructing unit 406A, the network communication processing unit 401A transmits the provision instruction message to the negotiable-value providing apparatus 30A. Additionally, upon receiving a transfer request message destined for the charge accommodating network 40A from the clearing processing unit 405A, the network communication processing unit 401A transmits the transfer request message to the charge accommodating network 40A.

The payment request processing unit 402A has the function of processing a payment request message received from the mobile communication terminal 20A. The payment request processing unit 402A receives the payment request message from the mobile communication terminal 20A via the network communication processing unit 401A. Then, the payment request processing unit 402A checks the user's retained amount data stored in the database unit 403A described below. The payment request processing unit 402A compares the user's retained amount data with the payment request message, and if the user can pay the charge, starts the provision instructing unit 406A. The started provision instructing unit 406A generates and transmits a provision instruction message to the negotiable-value providing apparatus 30A via the network communication processing unit 401A.

Furthermore, if the user can pay the charge according to the payment request message, the payment request processing unit 402A updates (rewrites) user retained amount data 700A on the user and retained amount data 900A on the game hall company corresponding to the company providing the negotiable value through the negotiable-value providing apparatus 30A; both data 700A and 900A are stored in the database unit 403A.

The database unit 403A stores the retained amount data 700A on each of the users registered in the present electronic settlement system 1A, and the retained amount data 900A on the game hall company. The database unit 403A also stores a user table 600A, the user retained amount data 700A, a game hall company table 800A, the game hall company retained amount data 900A, a negotiable-value providing apparatus table 1000A, and game history information 1100A; all the data 600A to 1100A are required for transfers from and to the charge accommodating network 40A.

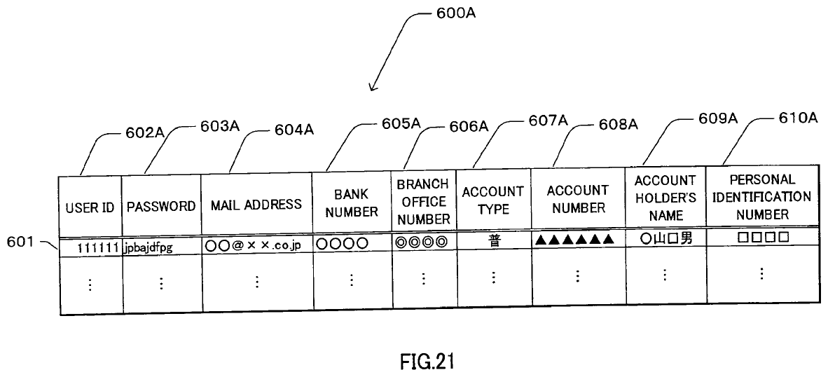

FIG. 21 shows an example of the configuration of the user table 600A stored in the database unit 403A. The user table 600A is data storing information about users (players). The user table 600A is data having one record 601 for each user. Each record 601A stores a user ID 602A, a password 603A, and a mail address 604A. The record 601A further stores a bank number 605A, a branch office number 606A, an account type 607A, an account number 608A, an account holder's name 609A, and a personal identification information 610A; all of these pieces of information are required to identify the user's account corresponding to the debit account. The user ID 602A is information uniquely identifying the user. The password 603A is information required to prevent a third party from pretending to be the user to unfairly utilize the present electronic settlement system 1A. The mail address 604A is used as the destination address to which an electronic mail is transmitted when the processing result notifying unit 407A notifies the user of the processing result of a payment process. The bank number 605A, branch office number 606A, account type 607A, account number 608A, account holder's name 609A, and personal identification information 610A are information required to indicate a debit account to the charge accommodating network 40A.

The information stored in the user table 600A is input to the electronic settlement server 10A when the user is registered in the electronic settlement server 10A.

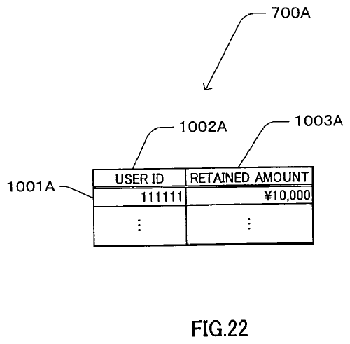

FIG. 22 shows an example of the configuration of the user retained amount data 700A stored in the database unit 403A. The user retained amount data 700A is data having one record 1001A for each user. Each record 1001A has a user ID field 1002A in which the user ID is stored, and a retained amount field 1003A in which a retained amount corresponding to an amount deposited in the electronic settlement system 1A by the user is stored. The value stored in the retained amount field 1003A is rewritten so as to increase by a deposited amount when the user deposits money in the electronic settlement system 1A and to decrease by a payment amount when the user carries out payment utilizing the negotiable-value providing apparatus 30A.

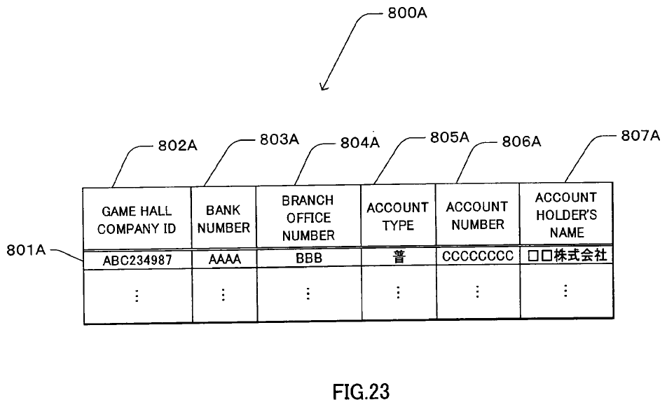

FIG. 23 shows an example of the configuration of the game hall company table 800A stored in the database unit 403A. The game hall company table 800A is data storing information on game hall companies. The game hall company table 800A is data having one record 801A for each of the game hall companies having signed up with the electronic settlement system 1A. Each record 801A stores a game hall company ID 802A in which a game hall company ID is stored. The record 801A further stores a bank number 803A, a branch office number 804A, an account type 805A, an account number 806A, and an account holder's name 807A; all of these pieces of information are required to identify the game hall company's account, to which an amount paid to the negotiable-value providing apparatus 30A is transferred. The game hall company ID 802A is information uniquely identifying the game hall company. The bank number 803A, branch office number 804A, account type 805A, account number 806A, and account holder's name 807A are information required to indicate a destination account to the charge accommodating network 40A.

The information stored in the game hall company table 800A is input to the electronic settlement server 10A when the game hall company signs up with and is registered in the electronic settlement system 1A.

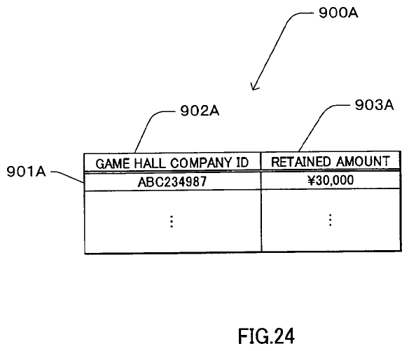

FIG. 24 shows an example of the configuration of the game hall company retained amount data 900A stored in the database unit 403A. The game hall company retained amount data 900A is data having one record 901A for each of the game hall companies registered in the electronic settlement system 1A. Each record 901A has a game hall company ID 902A, and a retained amount 903A in which a retained amount corresponding to an amount transferred to game hall company by the electronic settlement system 1A is stored. The value stored in the retained amount 903A is rewritten so as to increase by an amount paid by the user for the use of the negotiable-value providing apparatus 30A and to decrease by an amount transferred to the game hall company account 43 utilizing the charge accommodating network 40A.

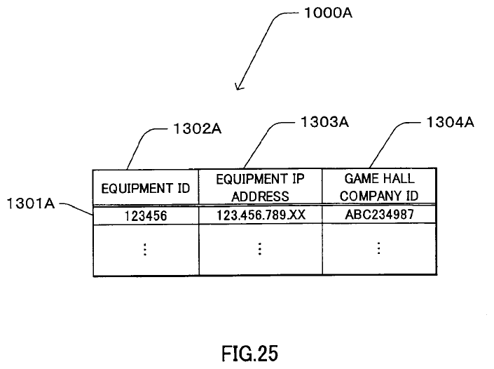

FIG. 25 shows an example of the configuration of the negotiable-value providing apparatus table 1000A stored in the database unit 403A. The negotiable-value providing apparatus table 1000A is data having one record 1301A for each negotiable-value providing apparatus 30A. Each record 1301A stores an equipment ID 1302A, an equipment IP address 1303A, and a game hall company ID 1304A.

The equipment ID 1302A is information uniquely identifying the negotiable-value providing apparatus 30A. The equipment IP address 1303A is information utilized, in response to a payment request message received by the electronic settlement server 10A and containing a certain equipment ID 1302A, as a destination address required to transmit a provision instruction message to the negotiable-value providing apparatus 30A having the equipment ID 1302A. The game hall company ID 1304A is information identifying the game hall company qualified to receive the user's money paid to the negotiable-value providing apparatus 30A having the equipment ID 1302A. The game hall company ID 1304A is the same as the game hall company ID 802 in the game hall company table 800A.

The game history information 1100A includes the history of games indicating when and where the player played games, on which game machine the player played the games, and how much the player spent in the games. The game history information 1100A is generated by accumulating and storing game history data generated and transmitted by a history information processing unit 305 of each negotiable-value providing apparatus 30A. Various pieces of useful information can be obtained by analyzing the game history information 1100A by well-known marketing analysis or the well-known data mining technique.

FIG. 20 is referred to again, and the example of configuration of the electronic settlement server 10A will be continuously described.

The provision instructing unit 406A allows a provision instruction message destined for the negotiable-value providing apparatus 30A to be generated. The provision instructing unit 406A transmits the provision instruction message to the negotiable-value providing apparatus 30A via the network communication processing unit 401A. The address of the negotiable-value providing apparatus 30A, corresponding to the destination of the provision instruction message, is acquired with reference to the above-described negotiable-value providing apparatus table 1000A.

Furthermore, the result notifying unit 407A has the function of notifying the user whether or not a payment request message has been properly processed. By way of example, the result notifying unit 407A generates an electronic mail destined for the mobile communication terminal 20A and transmits the electronic mail. Alternatively, the result notifying unit 407A may describe information indicating the processing result on a web page that can be browsed via the mobile communication terminal 20A and wait for browsing via the mobile communication terminal 20A. The contents of the notification from the result notifying unit 407A are, for example, the message “Settlement request has been processed. Thank you for allowing us to serve you” or “Short balance. Settlement has failed.”

Now, the transfer request processing unit 404A will be described. The transfer request processing unit 404A has the function of processing a transfer request message received from the mobile communication terminal 20A. The transfer request processing unit 404A receives the transfer request message from the mobile communication terminal 20A via the network communication processing unit 401A. The contents of the transfer request message correspond to a request that a specified amount be withdrawn from the user account 41 so that the electronic settlement system 1A can use the specified amount. Upon receiving the transfer request message, the transfer request processing unit 404A checks the user table 600A stored in the database unit 403A. The transfer request processing unit 404A acquires, from the user table 600A, the bank number 605A, branch office number 606A, account type 607A, account number 608A, account holder's name 609A, and personal identification information 610A, which are the information identifying the user's account, corresponding to the source account. The transfer request processing unit 404A transmits these pieces of information as well as information identifying the settlement company account 43, corresponding to the destination account, to the charge accommodating network 40A via the network communication processing unit 401A as a transfer request message. Upon receiving the transfer request message, the charge accommodating network 40A transfers a specified amount of money from the user account 41 to the settlement company account 42. The transferred money (except for the charge) can be used by the user utilizing the present electronic settlement system 1A.

Now, the clearing processing unit 405A will be described. The clearing processing unit 405A request the charge accommodating network 40A to transfer an amount indicated by the game hall company retained amount data 900A, from the settlement company account 42 to the game hall company account 43 of each game hall company. The amount of money transferred corresponds to the amount of the user's money kept by the electronic settlement system 1A and which is to be paid to the game hall company, that is, the game hall company retained amount 903A in the game hall company retained amount data 900A. In the present embodiment, the clearing processing unit 405A executes autonomous processing. For example, the clearing processing unit 405A is automatically started at a predetermined timing (for example, at the end of every month or week). The started clearing processing unit 405A checks all the game hall company retained amount data 900A stored in the database unit 403A. The clearing processing unit 405A then transmits, to the charge accommodating network 40A, a transfer request requesting the charge accommodating network 40A to carry out a transfer of money not yet transferred from the settlement company account 42 to the corresponding game hall company account 43.

The game information update unit 408A has the function of accumulating and storing, from moment to moment, game history data received from the history information processing unit 305 of the negotiable-value providing apparatus 30A, to update the game history information 1100A.

The electronic contract processing unit 409A cooperates with the mobile communication terminal 20A, more specifically the electronic contract applying unit 206 in allowing the user and the operator, administrator, or the like of the electronic settlement system 1A (hereinafter referred to as the settlement company) to electronically sign a contract specifying that the settlement company withdraws the specified amount from the user account, before the use of the electronic settlement system 1A can be started.

Furthermore, the electronic contract processing unit 409A has the function of transmitting data from a computerized contract document original certifying the contract signed between the user and the settlement company, to the financial institution having the user account.

Specifically, the electronic contract processing unit 409A has the function of allowing a computerized contract document 713 to be downloaded into the mobile communication terminal 20A, the function of receiving a computerized contract document 711 with an electronic signature and a user-side electronic certificate 711 both transmitted by the mobile communication terminal 20A, the function of verifying the received electronic signature and user-side electronic certificate 711, and if the electronic signature and the user-side electronic certificate 711 are determined to be valid, transmitting the computerized contract document 713 with the user's electronic signature and the settlement company's electronic signature and a settlement company-side electronic certificate 712 to the mobile communication terminal 20A, the function of receiving a computerized contract document original 714 transmitted by the mobile communication terminal 20A for storage, and the function of transmitting the computerized contract document original 714 to an apparatus specified by the financial institution (for example, the charge accommodating network 40A or a network terminal apparatus (for example, a PC) specified by the financial institution).

The electronic contract processing unit 409A is configured similarly to the electronic contract processing unit 408 of the electronic settlement server 10 according to the first embodiment (see FIG. 8). Thus, the detailed description of the individual arrangements is omitted.

### II.1.3.1. Distributed Server Configuration of the Electronic Settlement Server

In the example shown in FIG. 20, the electronic settlement server 10A is implemented by one server apparatus. However, of course, the electronic settlement server 10A is not limited to the configuration of such a server apparatus.

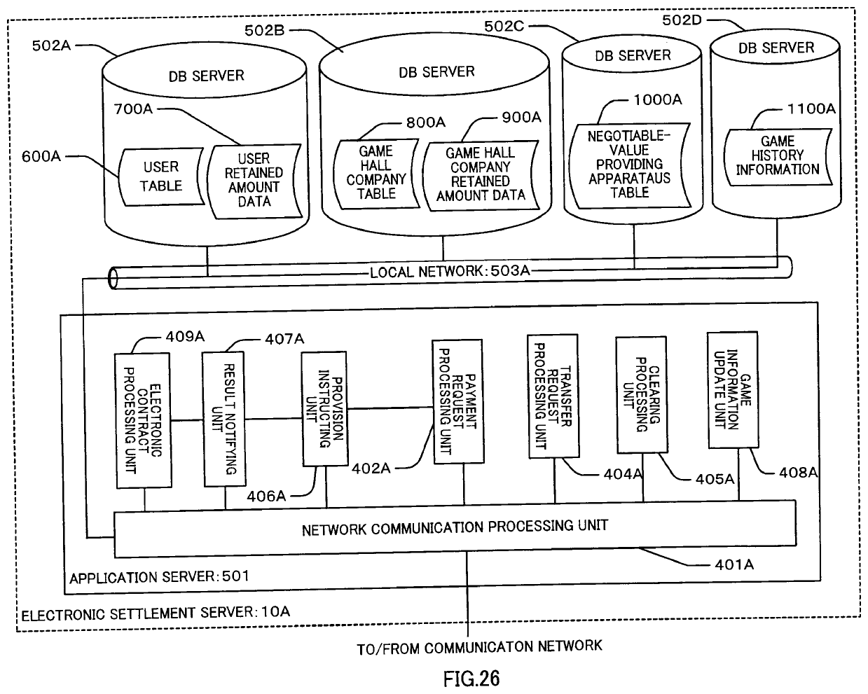

FIG. 26 is a function block diagram showing an example of configuration in which the electronic settlement server 10A has a distributed server configuration. The same components of the electronic settlement server 10A as those shown in FIG. 20 are denoted by the same reference numerals, and will thus not be described in detail.

The electronic settlement server 10A of the distributed server configuration serves to reduce the possibility that information on the user or the game hall company leaks or is stolen. The electronic settlement server 10A configured as distributed servers also enables the reliability of security of the present electronic settlement system 1A to be improved.

The electronic settlement server 10A of the distributed server configuration is composed of an application server 501 and a plurality of database servers 502A to 502D. The application server 501 has the network communication processing unit 401A, the payment request processing unit 402A, the transfer request processing unit 404A, the clearing processing unit 405A, the provision instructing unit 406A, the result notifying unit 407A, the game information update unit 408A, and the electronic contract processing unit 409A.

It is possible to optionally specify how to divide the database unit 403A, how many database servers 502 are provided, and how to assign stored contents (tables and data) to the respective database servers. Thus, the present invention is not limited to the configuration shown in FIG. 26.

### II.1.4. Others

FIG. 17 is referred to again, and the description of the components of the electronic settlement system 1A according to the present embodiment will be resumed. The communication network 50, the base station 60, the mobile communication network 70, the gateway 80, the authentication server 90, and the time stamp server 95 are similar to those in the first embodiment. The detailed description of these components is omitted.

### II.1.5. Charge Accommodating Network

The charge accommodating network 40A is a system having the function of transferring the specified amount from the user account 41 to the settlement company account 42 and from the settlement company account 42 to the game hall company account 43 according to a transfer request from the electronic settlement server 10A. In the example shown in FIG. 17, the electronic settlement server 10A is connected to the charge accommodating network 40A via the communication network 50. However, the present embodiment can be implemented even when the electronic settlement server 10A and the charge accommodating network 40A are connected together via a leased circuit (not shown in the drawings) without passing through the communication network 50.

Furthermore, the charge accommodating network 40A may have the function of receiving and storing the computerized contract document original 714 transmitted, by the electronic settlement server 10A, to the financial institution having the user's account. Based on the computerized contract document original 714, the financial institution can determine that the both the user and the settlement company agree that the settlement company withdraws the specified amount from the user's account. It is assumed that after the reception of the computerized contract document original 714, the settlement company receives a request message requesting that the settlement company withdraw the specified amount from the user's account. Then, the computerized contract document original 714 serves as a legal ground for the transfer, by the charge accommodating network 40A, of the specified amount from the user's account in response to the request message even without any special instruction from the user.

### II.2. Example of Operation of the Electronic Settlement System

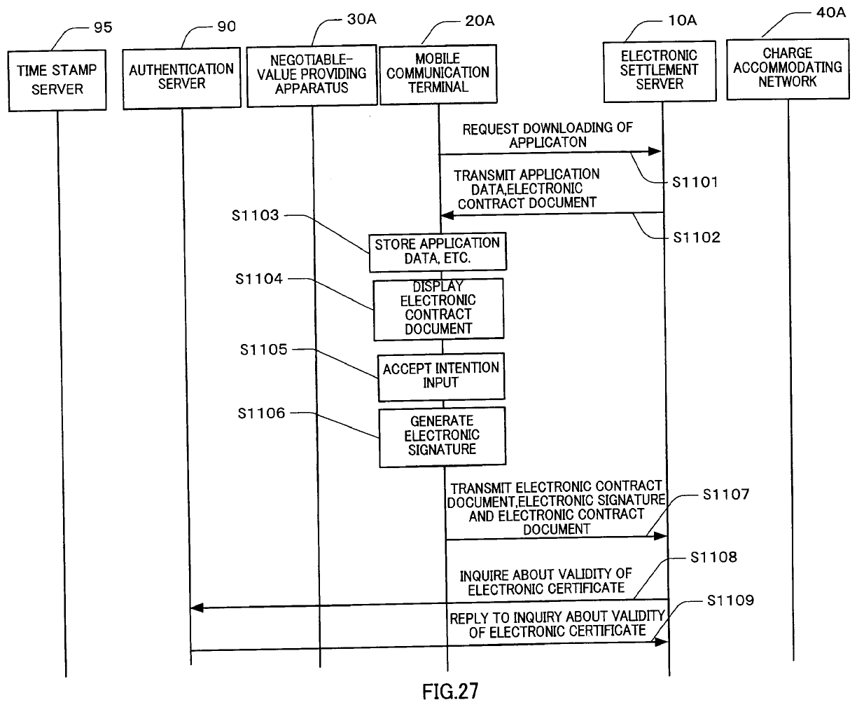

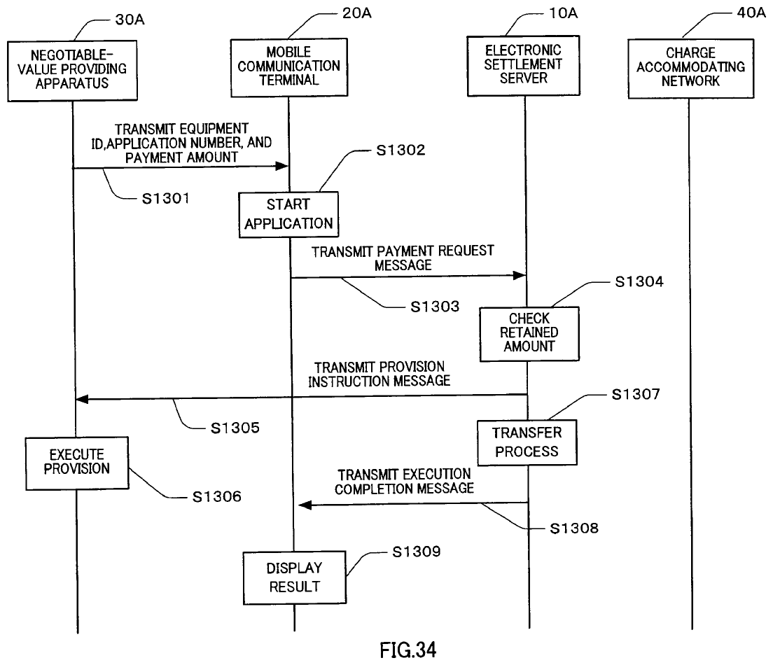

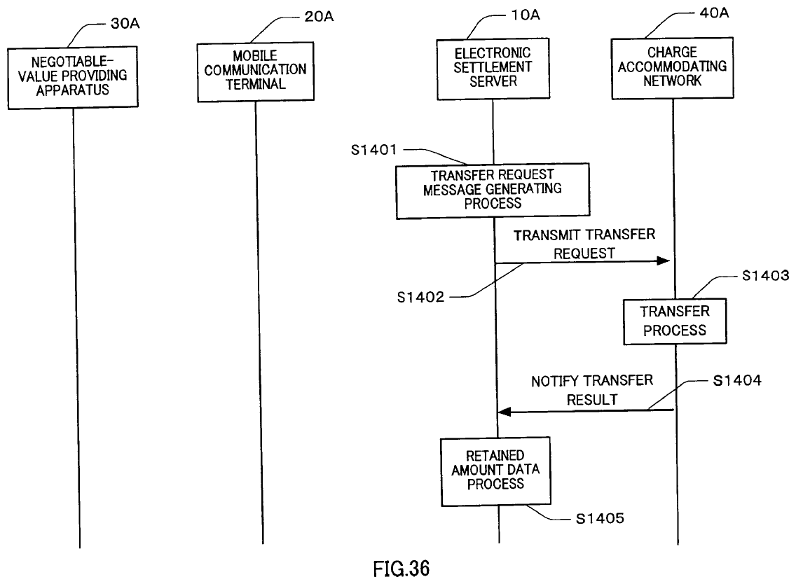

Now, the operation of the electronic settlement system 1A will be described with reference to FIGS. 27, 28, 29, 30, 34, and 36. FIGS. 27, 28, 29, and 30 are sequence diagrams showing an example of an operation performed by the electronic settlement system 1A during user registration. FIGS. 34 and 36 show an example of an operation performed when the user acquires a negotiable value through the present electronic settlement system 1A after the user registration.

First, the operation performed by the electronic settlement system 1A until the user is registered will be described with reference to FIGS. 27, 28, 29, and 30.

First, the unregistered user uses the mobile communication terminal 20A to connect to the electronic settlement server 10. The user then requests, from the electronic settlement server 10A, software for the mobile communication terminal 20A (an application such as an i appli) which is required to receive services from the electronic settlement system 1A (FIG. 27; S1101). In response to the request, the electronic settlement server 10A allows the data of the i appli and the computerized contract document 713 to be downloaded into the mobile communication terminal 20A (S1102). Upon receiving the i appli and the computerized contract document 713, the mobile communication terminal 20A allows the data of the i appli and the like to be stored in a storage device such as a memory, while allowing the computerized contract document 713 to be stored in a storage unit 703 (S1103). The i appli is executed by the CPU in the mobile communication terminal 20A or the like to function as the above-described payment request generating unit 202, transfer request generating unit 208, electronic contract applying unit 206, or the like.

In the above-described embodiment, the electronic settlement server 10A is also used as a server for downloading of the application such as the i appli and a server for downloading of the computerized contract document 713. However, of course, the server for downloading of the application such as the i appli and/or the server for downloading of the computerized contract document 713 may be an apparatus or a system that is separate from the electronic settlement server 10A.

The downloaded i appli is started by the user's predetermined operation via the mobile communication terminal 20A (S1104). Upon being started for the first time after downloading, the electronic contract applying unit 206, that is, the i appli, allows the output unit 205 to display the computerized contract document 713 (S1104). The electronic contract applying unit 206 thus urges the user to check the contents of the computerized contract document 713.

Then, the mobile communication terminal 20A, more specifically the electronic contract applying unit 206, accepts an input indicating whether or not the user is to sign the electronic contract (S105). For example, the liquid crystal display, that is, the output unit 205, displays the message “Contents of contract are displayed. Will you sign contract? YES/NO” or the like to urge the user to input an answer. If the user opts to sign the contract according to the contents of the computerized contract document 713, the electronic contact applying unit 206, more specifically an encryption processing unit 702, uses an encryption key 715 to generate an electronic signature (S1106). In the present embodiment, the electronic signature corresponds to a hash value for the computerized contract document 713 in which the user's address, name, and the like are filled, the hash value being encrypted using the encryption key 715 according to an RSA encryption scheme. However, the present invention is not limited to this aspect. For example, information may be used which allows the user to be uniquely identified and which is obtained by encrypting data that cannot be easily known by the third party. However, in this case, the electronic certificate 711 is not utilized.

Then, the mobile communication terminal 20A, more specifically the electronic contract applying unit 206, transmits the computerized contract document 713 (in which the user's address and name are additionally filled), the electronic signature generated in S1106, and the user-side electronic certificate 711 to the electronic settlement server 10A (S1107).

Upon receiving the computerized contract document 713 and others transmitted in the above-described S1107, the electronic settlement server 10A, more specifically the electronic contract processing unit 409A, inquires of the authentication server 90, that is, an institution issuing the user-side electronic certificate 711, about the validity of the user-side electronic certificate 711 (S108). The authentication server 90 references a CRL (Certified Revocation List) to determine the validity of the user-side electronic certificate 711. The authentication server 90 then transmits the result of the determination to the electronic settlement server 10A (S1109).

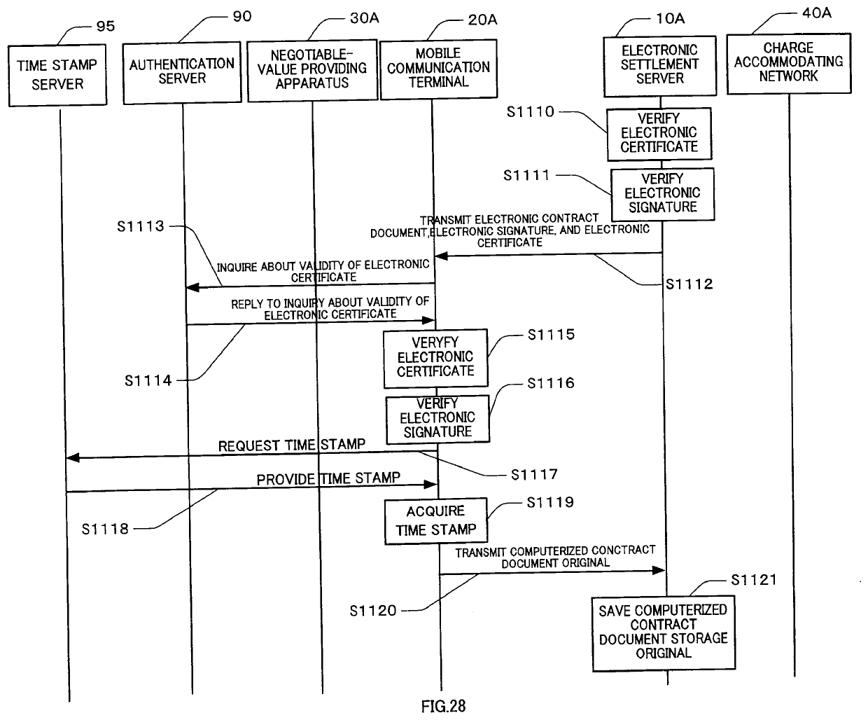

The description will be continued with reference to FIG. 28.

If the result of the determination indicates that the user-side electronic certificate 711 is valid, the electronic settlement server 10A, more specifically the electronic contract processing unit 409A, executes a process of verifying the user-side electronic certificate 711 (S1110). That is, the electronic settlement server 10A uses the public key of a certification authority (CA) to decrypt the electronic signature on the user-side electronic certificate 711 to determine whether the electronic signature has been written by the certification authority (CA). The electronic settlement server 10A further determines whether or not the user-side electronic certificate 711 has been altered. If the verifications in S1109 to S1111 are all successful, the user-side electronic certificate 711 is determined to be credible, that is, the encryption key (for example, the public key according to the public encryption key scheme) described in the user-side electronic certificate 711 is determined to belong to the user.

If the verification of the user-side electronic certificate 711 is successful, the electronic settlement server 10A, more specifically the electronic contract processing unit 409A, verifies the electronic signature attached to the computerized contract document 713 (S1111). That is, the electronic settlement server 10A uses the encryption key described in the user-side electronic certificate 711 to decrypt the electronic signature attached to the computerized contract document 713. The electronic settlement server 10A thus verifies the electronic signature and determines the validity of the computerized contract document 713 (that the computerized contract document 713 has not been altered).

If the verification of the electronic signature in S1111 is successful, the electronic settlement server 10A, more specifically the electronic contract processing unit 409A, determines that the computerized contract document 711 has been validly signed by the user. The electronic settlement server 10A, more specifically the electronic contract processing unit 409A, further attaches the settlement company's electronic signature to the computerized contract document 713 (to which the user's electronic signature is already attached) received from the mobile communication terminal 20A. The electronic settlement server 10A also attaches the settlement company-side electronic certificate 712 to the computerized contract document 713. The electronic settlement server 10A then transmits the computerized contract document 713, the settlement company's electronic signature, and the settlement company-side electronic certificate 712 to the mobile communication terminal 20A (S1112).

Upon receiving the computerized contract document 713 and others transmitted in step S1112, the mobile communication terminal 20A, more specifically the electronic contract applying unit 206, inquires of the authentication server 90, that is, an institution issuing the settlement company-side electronic certificate 712, about the validity of the settlement company-side electronic certificate 712 (S1113). The authentication server 90 references the CRL (Certified Revocation List) to determine the validity of the settlement company-side electronic certificate 712. The authentication server 90 then transmits the result of the determination to the electronic settlement server 10A (S1114).

If the result of the determination indicates that the settlement company-side electronic certificate 712 is valid, the mobile communication terminal 20A, more specifically the electronic contract applying unit 206, executes a process of verifying the settlement company-side electronic certificate 712 (S1115). That is, the mobile communication terminal 20A, more specifically the electronic contract applying unit 206, uses the public key of the certification authority (CA) to decrypt the electronic signature on the settlement company-side electronic certificate 712 to determine whether the electronic signature has been written by the certification authority (CA). The mobile communication terminal 20A further determines whether or not the settlement company-side electronic certificate 712 has been altered. If the verifications in S1113 to S1115 are all successful, the settlement company-side electronic certificate 712 is determined to be credible, that is, the encryption key (for example, the public key according to the public encryption key scheme) described in the settlement company-side electronic certificate 712 is determined to belong to the settlement company.

If the verification of the settlement company-side electronic certificate 712 is successful, the mobile communication terminal 20A, more specifically the electronic contract applying unit 206, verifies the settlement company's electronic signature attached to the computerized contract document 713 (S1116). That is, the mobile communication terminal 20A uses the encryption key described in the settlement company-side electronic certificate 712 to decrypt the settlement company's electronic signature attached to the computerized contract document 713. The mobile communication terminal 20 thus verifies the settlement company's electronic signature and determines the validity of the computerized contract document 713 (that the computerized contract document 713 has not been altered).

If the verification of the settlement company's electronic signature in S1116 is successful, the mobile communication terminal 20A, more specifically the electronic contract applying unit 206, determines that the computerized contract document 713 has been validly signed by the settlement company.

Then, the mobile communication terminal 20A, more specifically the electronic contract applying unit 206, transmits the computerized contract document 713 (or a hash value therefore) with the user's electronic signature and the settlement company's electronic signature, to the time stamp server 95. The mobile communication terminal 20 thus requests the time stamp server 92 to issue a time stamp (S1117). Upon receiving the time stamp request, the time stamp server 95 applies a date and time to the hash value for the computerized contract document 713 with the user's electronic signature and the settlement company's electronic signature to generate a digitally signed time stamp token. The time stamp server 95 then transmits the time stamp token to the mobile communication terminal 20A (S1118).

The mobile communication terminal 20A, more specifically the electronic contract applying unit 206, acquires the time stamp token (S1119). Then, the mobile communication terminal 20A adds the time stamp token to the computerized contract document 713 with the user's electronic signature and the settlement company's electronic signature to obtain a computerized contract document storage original 714. The mobile communication terminal 20A stores the computerized contract document storage original 714 in the storage unit 703, and also transmits the computerized contract document storage original 714 to the electronic settlement server 10A (S1120).

Upon receiving the computerized contract document storage original 714, the electronic settlement server 10A, more specifically the electronic contract processing unit 409A, stores the computerized contract document storage original 714 in a storage unit 803 (S1121).

Thus, a contract for withdrawal substitution is signed between the user and the settlement company. Under the condition that the computerized contract document storage original 714 is stored in the electronic settlement server 10A, the electronic settlement server 10 accepts the user registration. That is, if the computerized contract document storage original 714 is not stored in the electronic settlement server 10A, the user is not registered and cannot start utilizing the electronic settlement system 1A. In other words, storing the computerized contract document storage original 714 in the electronic settlement server 10A is essential for the user registration.

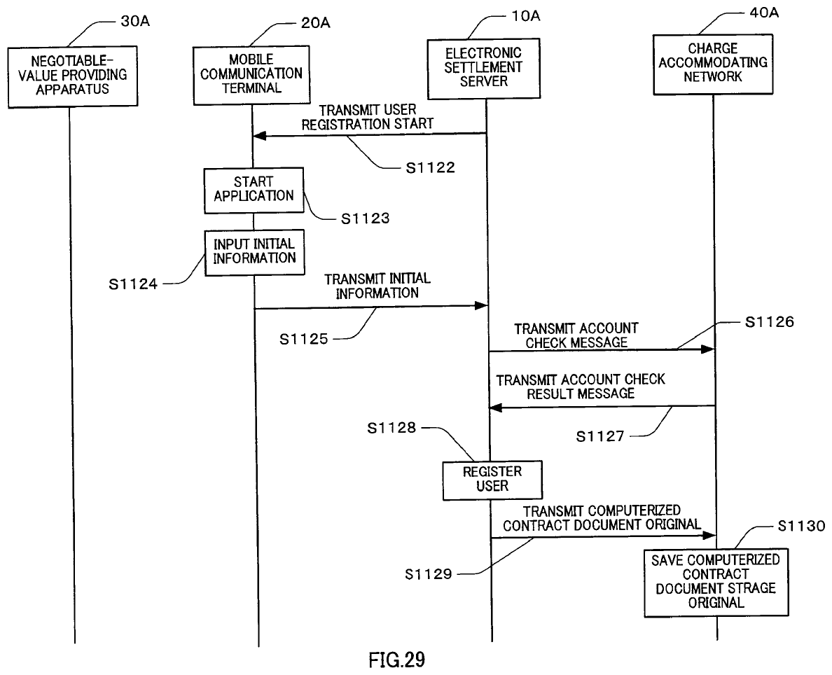

Now, the operation of the electronic settlement system 1A after step S1121 will be described with reference to FIG. 29. In the sequence diagrams following FIG. 29, the illustration of the authentication server 90 and the time stamp server 95 is omitted.

Using the completion of step S1121 as a trigger, the electronic settlement server 10A transmits a user registration start message to the mobile communication terminal 20A (S1122).

Upon receiving the user registration start message, the mobile communication terminal 20A starts the i appli (S1123). When started for the first time after downloading, the i appli allows the output unit 205 to display an initial input screen via which the user inputs initial information, thus urging the user to input the initial information (S1124). Here, the requested initial information includes the user ID 602A, password 603A, mail address 604A, bank number 605A, branch office number 606A, account type 607A, account number 608A, account holder's name 609A, and personal identification number 610A (see FIG. 21). The user ID 602A and the password 603A may be preset by the electronic settlement server 10A without the need for the user's input.

The user completes inputting the initial information using the input unit 204 of the mobile communication terminal 20A. Then, the mobile communication terminal 20A connects to the electronic settlement server 10A via the communication network 50 and transmits the input initial information and the like to the electronic settlement server 10A (S1125).

Upon receiving the initial information, the electronic settlement server 20 transmits, to the charge accommodating network 40A, an account check request message inquiring of the charge accommodating network 40A whether or not the initial information is correct and whether or not the input user account is available (S1126). Upon receiving the account check request message, the charge accommodating network 40A searches an account database or the like for the presence and validity of the user account indicated to be a check target in the account check request message. The charge accommodating network 40A then transmits the result of the determination to the electronic settlement server 10A as an account check result message (S1127). If the account check result message indicates that the input account information is incorrect or the account is unavailable, the electronic settlement server 10A having received the account check result message transmits a message urging the initial information to be input again, to the mobile communication terminal 20A (not shown in FIG. 29). On the other hand, if the account check result message indicates that the input account information is correct and that the input account is available, the electronic settlement server 10A having received the account check result message registers the user based on the input initial information (S1128). That is, the electronic settlement server 20 adds new records 601A and 1001A to the user table 600A and the user retained amount data 700A, respectively, both of which are located in the database unit 403A. The electronic settlement server 20 thus writes the user ID 602A, password 603A, mail address 604A, bank number 605A, branch office number 606A, account type 607A, account number 608A, account holder's name 609A, personal identification number 610A, user ID 1002A, retained amount 1003A, and the like into the records 601A and 1001A.

Once the above-described user registration (S1128) is completed, the electronic settlement server 10A transmits the computerized contract document original 714 to the charge accommodating network 40A (S1129). The charge accommodating network 40A receives and stores the computerized contract document original 714 (S1130). In the present example, the charge accommodating network 40A receives the computerized contract document original 714. However, any apparatus can receive the computerized contract document original 714 provided that the apparatus enables the financial institution having the user account to confirm the signing of the contract based on the computerized contract document original 714.

Furthermore, in the above-described example, the transmission of the computerized contract document original 714 to the charge accommodating network 40A follows the user registration (S1128). However, the present invention can be implemented regardless of the timing when the computerized contract document original 714 is transmitted to the charge accommodating network 40A, provided that the transmission follows the generation of the computerized contract document original 714 (the transmission follows S1119).

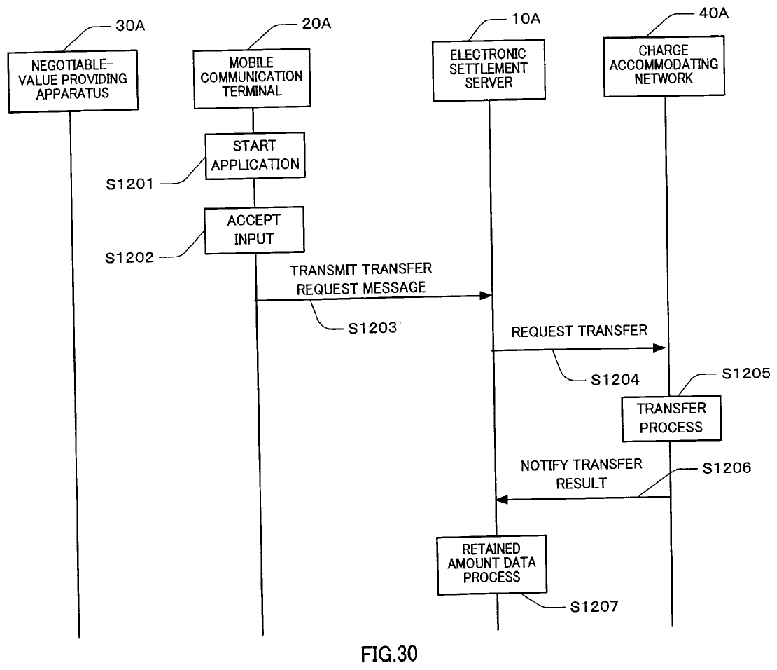

After the user registration (S1128) is completed, the user can utilize the electronic settlement system 1A. An example of the operation of the electronic settlement system 1A following the user registration will be described below with reference to FIG. 30.

Simply finishing the above-described user registration does not allow the user to utilize the electronic settlement system 1A to make a purchase (receive a negotiable value) via the negotiable-value providing apparatus 30A. The user needs to use the mobile communication terminal 20A to request the electronic settlement system 1A, more specifically the electronic settlement server 10A, to transfer an appropriate amount of the deposit in the user account 41 to the settlement company account 42. The amount consumed by the user as a result of the provision of the negotiable value by the negotiable-value providing apparatus 30A is subtracted from the deposit. The amount resulting from the subtraction is equal to that paid to the negotiable-value providing apparatus 30A, and is transferred later to the game hall company's account, corresponding to the recipient of the payment, as a result of processing by the charge accommodating network 40A. Now, with reference to FIG. 30, description will be given of an example of an operation performed by the electronic settlement system 1A when the user requests the electronic settlement server 10A to carry out a transfer from the user account 41, that is, the user's own account, to the settlement company account 42. FIG. 30 is a sequence diagram showing an example of an operation performed by the electronic settlement system 1A when the user requests a transfer from the user account 41 to the settlement company account 42.

First, the user uses the mobile communication terminal 20A to start the i appli, more specifically the transfer request generating unit 208 (S1201). The started i appli, more specifically the transfer request generating unit 208, allows the output unit 205 of the mobile communication terminal 20A to display an input interface screen or the like. The i appli thus urges the user to input information required for a transfer request message, for example, the transfer amount and the personal account identification number.

Upon receiving the input (S1202), the mobile communication terminal 20A, more specifically the transfer request generating unit 208, generates and transmits a transfer request message to the electronic settlement server 10A via the communication network 50 and the like (S1203). The transfer request message stores the user ID 206, the password 207, the personal account identification number 211, the input transfer amount, and the like.

Upon receiving the transfer request message, the electronic settlement server 10A, more specifically the transfer request processing unit 404A, searches the user table 600A using the user ID 206 contained in the transfer request message as a key. The electronic settlement server 10A thus acquires the bank number 605A, branch office number 606A, account type 607A, account number 608A, and account holder's name 609A, which are the information specifying the user account 41, from the record 601A matching the user ID 206. Moreover, the electronic settlement server 10A reads another stored information (not shown in the drawings) identifying the settlement company account, that is, the bank number, branch office number, account type, and account number of the settlement company account. Then, based on these pieces of information, the electronic settlement server 10A generates and transmits a transfer request to the charge accommodating network 40A (S1204). A data configuration, a communication procedure, and the like for the transmission of the transfer request may comply with a scheme adopted for the charge accommodating network 40A.

Upon receiving the transfer request, the charge accommodating network 40A executes a transfer process according to the contents of the transfer request so as to transfer a specified amount (hereinafter referred to as a “user transfer amount”) from the user account 41 to the settlement company account 42 (S1205). If the transfer process (S1205) is executed normally, the charge accommodating network 40A transmits a transfer result notification to the electronic settlement server 10A to notify the electronic settlement server 10A that the transfer process has been executed normally (S1206). If the transfer process fails to be properly executed because of insufficient balance in the user account 41 or the like, the charge accommodating network 40A transmits a transfer result notification indicating the failure in the transfer to the electronic settlement server 10A.

Upon receiving the transfer result notification indicating the transfer process has been executed normally, the electronic settlement server 10A executes a retained amount data process of reflecting the user transfer amount in the corresponding record 1001A in the user retained amount data 700A (S1207). The retained amount data process allows the user to use the amount corresponding to the user transfer amount, via the electronic settlement system 1A.

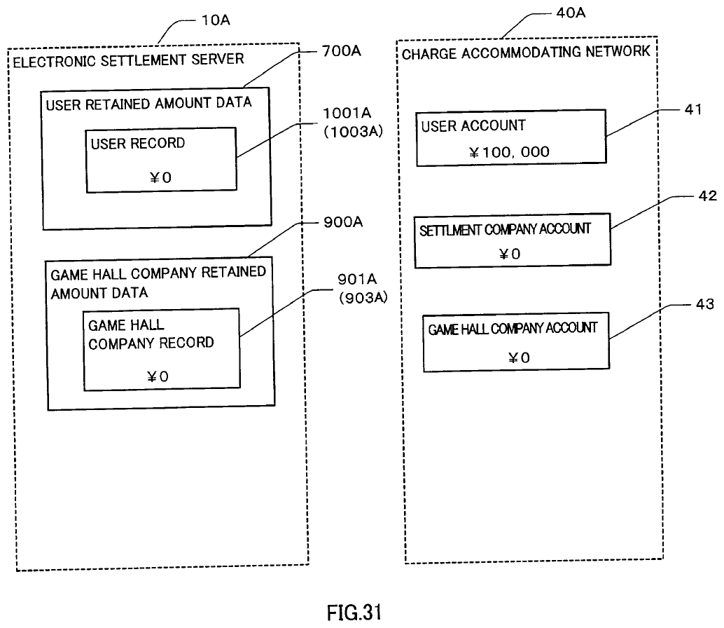

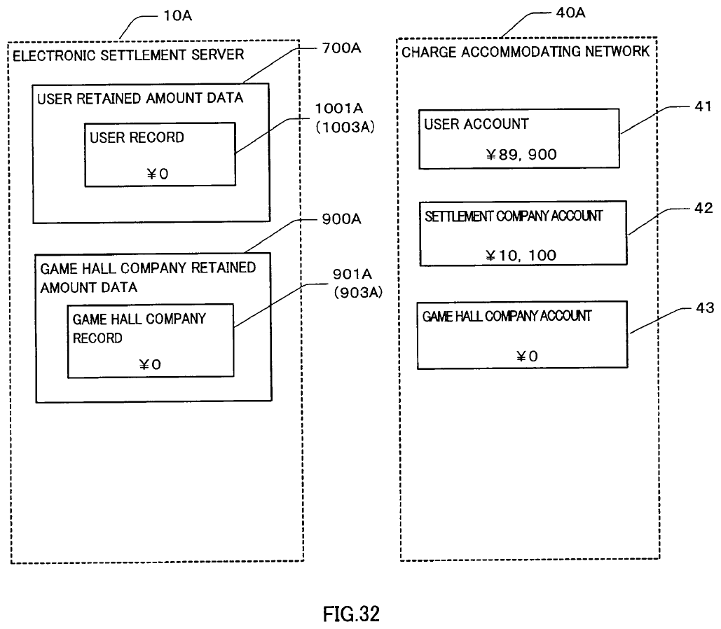

FIGS. 31 and 32 are diagrams illustrating an example of an operation performed between the electronic settlement server 10A and the charge accommodating network 40A to process the user transfer amount.

FIG. 31 shows an example of a state observed before the user transmits a transfer request message to the electronic settlement server 10A (FIG. 30, S1203). In the example, the charge accommodating network 40A has the user account 41, the settlement company account 42, and the game hall company account 43.

By way of example, it is assumed that the balance of the user account 41 is 100,000 yen and that the balance of both the settlement company account 42 and the game hall company account 43 is 0 yen. In actuality, a plurality of users and a plurality of game hall companies have accounts in the charge accommodating network 40A. However, FIGS. 31 and 32 show one user account 41 and one game hall company account 43 as typical examples.

As described above, the electronic settlement server 10A stores the user retained amount data 700A and the game hall company retained amount data 900A. The user retained amount data 700A has the record 1001A for each user. The game hall company retained amount data 900A has the record 901A for each game hall company. In the figures, the record 1001A is data corresponding to the user having the user account 41. The record 901A is data corresponding to the game hall company having the game hall company account 43. The retained amounts stored in the records 1001A and 901A are both assumed to be currently 0 yen.

Here, it is assumed that the user desires to use 10,000 yen from the user account 41 via the electronic settlement system 1A. FIG. 32 shows a state observed after the user has transmitted a transfer request message for a transfer of a user transfer amount of 10,000 yen, from the mobile communication terminal 20A to the electronic settlement server 10A; the transmission follows the state shown in FIG. 31. In response to the transfer request message, the electronic settlement server 10A transmits the following transfer request to the charge accommodating network 40A. The transfer request is transmitted to the charge accommodating network 40A, requesting that the user transfer amount of 10,000 yen and the charge to be paid to the settlement company (for example, 100 yen) be transferred from the user account 41 to the settlement company account 42.

Upon receiving the transfer request, the charge accommodating network 40A executes a process of transferring 10,000 yen from the user account 41 to the settlement company account 42. As a result, as shown in FIG. 32, the balance of the user account 41 is 100,000 yen-10,100 yen=89,900 yen. The balance of the settlement company account 42 is 0 yen+10,100 yen=10,100 yen. The charge accommodating network 40A changes the balances of the accounts 41 and 42 as described above according to the transfer request.

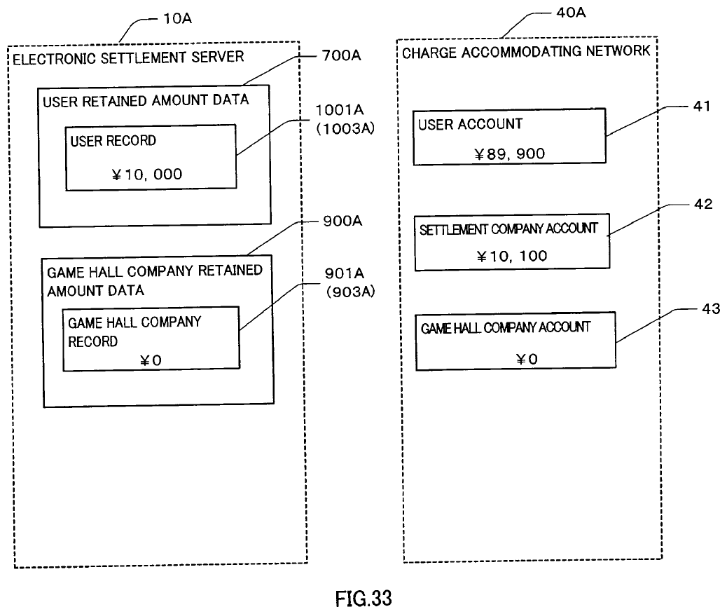

FIG. 33 shows a state observed after the electronic settlement server 10A has executed a retained amount data process (FIG. 30, S1207); the execution follows the state shown in FIG. 32. As shown in FIG. 32 described above, after executing the transfer process, the charge accommodating network 40A transmits a transfer result notification indicating that 10,100 yen has been transferred normally, to the electronic settlement server 10A (FIG. 30, S1206). In response to the transfer result notification, the electronic settlement server 10A, more specifically the transfer request processing unit 404A, adds the transferred amount to the value of the user retained amount 1003A stored in the record 1001A corresponding to the user account 41 subjected to the transfer. However, 100 yen, corresponding to the charge, is not added. As a result of the retained amount data process (S1207) based on the addition, 0 yen+10,000 yen=10,000 yen is recorded in the record 1001A. The 10,000 yen is the amount that the user can use via the electronic settlement system 1A.

Now, with reference to FIG. 34, description will be given of an example of an operation performed by the electronic settlement system 1A when the user attempts to obtain a negotiable value from the negotiable-value providing apparatus 30A. FIG. 34 is a sequence diagram showing an example of an operation performed by the electronic settlement system 1A when the user allows the mobile communication terminal 20A and the negotiable-value providing apparatus 30A to communicate via the short-distance communication means 201303A in order to obtain a negotiable value from the negotiable-value providing apparatus 30A.

It is assumed that the user first attempts to obtain a negotiable value from the negotiable-value providing apparatus 30A utilizing the present electronic settlement system 1A.

In this case, the user allows the mobile communication terminal 20A and the negotiable-value providing apparatus 30A to carry out short-distance communication so that the mobile communication terminal 20A can acquire the equipment ID and the like of the negotiable-value providing apparatus 30A. For example, it is assumed that the terminal-side short-distance communication unit 201 is an IC chip for non-contact IC cards and that the providing apparatus-side short-distance communication unit 303 is a reader/writer. Then, upon sensing that the chip for non-contact IC cards is nearby, the reader/writer, serving as the providing apparatus-side short-distance communication unit 303, transmits the equipment ID, an application number specifying an application such as the i appli, and a user payment amount, which are all stored in the reader/writer, to the chip for non-contact IC cards, serving as the terminal-side short-distance communication unit 201 (S1301). Here, the equipment ID is identification information allowing the negotiable-value providing apparatus 30A to be uniquely identified. The application number is identification information uniquely identifying the application such as the i appli which operates in the mobile communication terminal 20A. The user payment amount is information indicative of the value of consideration for the negotiable value provided to the user by the negotiable-value providing apparatus 30A. When the purchase of a negotiable value is requested via the mobile communication terminal 20A, the negotiable-value providing apparatus 30A considers the request to be a purchase request for a negotiable value for a pre-specified payment amount. For example, if the negotiable-value providing apparatus 30A is a ball renting machine, the user moves the mobile communication terminal 30 closer to the ball renting machine, corresponding to the negotiable-value providing apparatus 30A, to allow the negotiable-value providing apparatus 30A to read data from the chip for non-contact IC cards. Then, the negotiable-value providing apparatus 30A considers the request to be a purchase request for rental balls for a payment amount (for example, 1,000 yen) specified for the negotiable-value providing apparatus 30A. The user payment amount may vary with the negotiable-value providing apparatus 30A. For example, the payment amount may be set to 1,000 yen for a ball renting machine A installed in the game hall and to 5,000 yen for another ball renting machine B installed in the same game hall. Alternatively, the user payment amount may be selectively determined by the user. For example, if the negotiable-value providing apparatus 30A is a prepaid card issuing apparatus, the prepaid card issuing apparatus can issue prepaid cards for a plurality of different amounts (for example, 1,000 yen, 3,000 yen, 5,000 yen, and 10,000 yen), and has a plurality of amount determination buttons used to specify the respective amounts. The user depresses the amount determination button for the desired amount to buy the prepaid card for the desired amount. In this case, the amount selected by the user via the amount determination button may be considered by the electronic settlement system 1A to be the user payment amount.

The above-described user payment amount need not necessarily be transmitted from the negotiable-value providing apparatus 30A to the mobile communication terminal 20A in step S1301. The payment amount may be determined by the electronic settlement server 10A based on the equipment ID using a prepared table.

Upon receiving the equipment ID, the application number, and the user payment amount, the terminal-side short-distance communication unit 201 starts the application such as the i appli which corresponds to the application number, that is, the payment request generating unit 202 (S1302). At this time, the equipment ID and the user payment amount are passed from the terminal-side short-distance communication unit 201 to the payment request generating unit 202.

The started payment request generating unit 202 generates a payment request message containing the equipment ID and user payment amount received from the negotiable-value providing apparatus 30A and the user ID 206 and password 207 stored in the user information storage unit 207. The payment request generating unit 202 then transmits the payment request message to the electronic settlement server 10A (S1303).

Upon receiving the payment request message, the electronic settlement server 10A, more specifically the payment request processing unit 402A first searches for the user retained amount data 700A using the user ID 206 as a search key. The electronic settlement server 10A thus acquires the retained amount 1003A from the record 1001A corresponding to the user ID 206. The payment request processing unit 402A compares the user payment amount with the retained amount 1003A to determine whether or not the user payment amount can be withdrawn from the retained amount 1003A (S1304).

In step S1304, upon determining that the user payment amount cannot be withdrawn, the payment request processing unit 402A starts the result notifying unit 407A. The result notifying unit 407A generates and transmits a processing result notification based on the determination to the negotiable-value providing apparatus 30A and/or the mobile communication terminal 20A. Upon receiving the processing result notification, the mobile communication terminal 20A displays the contents of the processing result notification on the output unit 205 thereof. The contents of the processing result notification are, for example, “Settlement request has been processed. Thank you for allowing us to serve you” or “Short balance. Settlement has failed.”

On the other hand, upon determining in step S1304 that the user payment amount can be withdrawn, the payment request processing unit 402A starts the provision instructing unit 406A. The started provision instructing unit 406A transmits a provision instruction message to the negotiable-value providing apparatus 30A (S1305). The negotiable-value providing apparatus 30A provides the user with a negotiable value corresponding to the user payment amount (S1306). The destination address of the provision instruction message is determined based on the equipment IP address 1303A in the corresponding record 1301A obtained by searching the negotiable-value providing apparatus table 1000A using the equipment ID as a key.

Furthermore, upon determining in step S1304 that the user payment amount can be withdrawn, the payment request processing unit 402A rewrites the user retained amount data 700A, more specifically the retained amount 1003A in the record 1001A with the corresponding user ID, and the game hall company retained amount data 900A, more specifically the retained amount 903A in the record 901A with the corresponding game hall company ID, so as to allow the user payment amount to be transferred.

Furthermore, upon determining in step S1304 that the user payment amount can be withdrawn, the electronic settlement server 10A, more specifically the payment request processing unit 402A, starts the result notifying unit 407A. The started result notifying unit 407A transmits an execution completion message notifying the mobile communication terminal 20A that the specified payment amount has been paid (S1308). The execution completion message indicates that a payment procedure corresponding to the user's specified payment amount has ended. The destination address of the execution completion message is determined based on the mail address 604A in the corresponding record 601A obtained by searching the user table 600A using the user ID as a key.

Upon receiving the execution completion message, the mobile communication terminal 20A allows the output unit 205 to provide a result display showing the contents of the execution completion message (S1309). For example, as the result display, the output unit 205 of the mobile communication terminal 20A shows the message “1,000 yen has been paid from XX's retained amount”. Alternatively, during the result display, the value of the retained amount 1003A resulting from the withdrawal of the payment amount, that is, the balance in the electronic settlement server 10A, may be displayed. However, the retained amount 1003 is not stored in the mobile communication terminal 20A. The electronic settlement server 10A stores the retained amount 1003A.

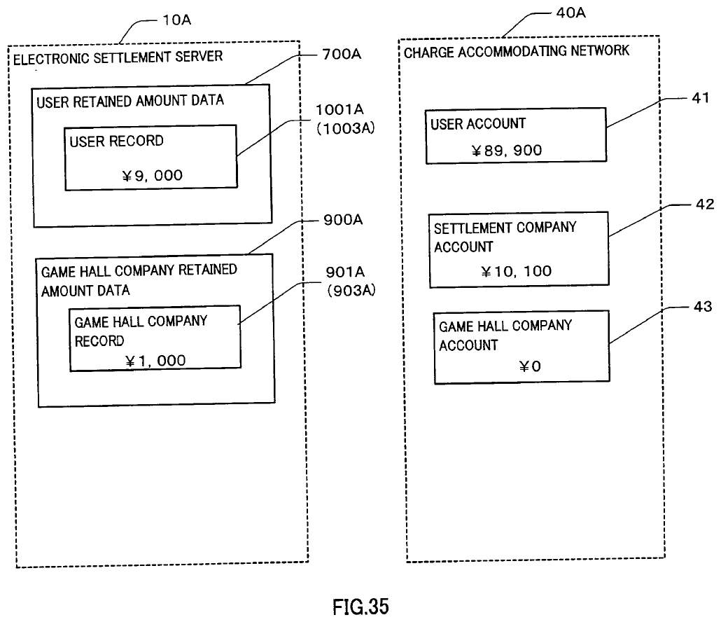

FIG. 35 is a diagram showing the storage state of the electronic settlement server 10A and the charge accommodating network 40A resulting from the processing from step S1301 to step S1307 following the state shown in FIG. 33. In the state shown in FIG. 33 and in which the user payment amount has not been transferred yet, the retained amount 1003A in the corresponding record 1001A in the user retained amount data 700A is 10,000 yen. The retained amount 903A in the corresponding record 901A in the game hall company retained amount data 900A is 0 yen.

FIG. 35 shows a state observed after the transfer process (S1307) has been executed if the user payment amount is 1,000 yen. In the transfer process (S1307), the payment request processing unit 402 of the electronic settlement server 10A subtracts the user payment amount of 1,000 yen from 10,000 yen, that is, the value of the retained amount 1003A, corresponding to the user's retained amount, to rewrite the value of the retained amount 1003 to 9,000 yen. Furthermore, the payment request processing unit 402 adds the user payment amount of 1,000 yen to 0 yen, that is, the value of the retained amount 903A, corresponding to the game hall company's retained amount, to rewrite the value of the retained amount 903A to 1,000 yen.

The rewriting of the retained amounts 1003A and 903A based on the transfer process (S1307) allows the electronic settlement server 10A to pay consideration for the provision of a negotiable value by the negotiable-value providing apparatus 30A, that is, allows the user to pay to the game hall company.

The processing from step S1301 to step S1309 described above is executed every time each user buys a negotiable value utilizing the negotiable-value providing apparatus 30A. Each user payment amount is added and recorded as the retained amount of the corresponding game hall company. That is, every time the user buys a negotiable value utilizing the negotiable-value providing apparatus 30A, the value of the retained amount 903A of the game hall company owning or operating the negotiable-value providing apparatus 30A increases.

The game hall company's retained amount 903A needs to be transferred to the game hall company account 43 on the charge accommodating network 40A. The transfer to the game hall company account 43 in the electronic settlement system 1A will be described below with reference to FIG. 36. FIG. 36 is a sequence diagram showing an example of the process of a transfer to the game hall company account 43 in the electronic settlement system 1A.

The electronic settlement server 10A, more specifically the clearing processing unit 405A, is automatically started at a predetermined timing to execute a transfer request generating process (S1401). The resulting transfer request is a message requesting the charge accommodating network 40A to transfer the amount corresponding to the retained amount 903A from the settlement company account 42 to the game hall company account 43. The details of the message are set so as to meet the specifications of the charge accommodating network 40A.

In the transfer request generating process (S1401), one transfer request is generated for each record 901A in the game hall company retained amount table 900A. The transfer request stores information identifying the game hall company account 43, corresponding to a destination account, that is, the bank number 803A, branch office number 804A, account type 805A, account number 806A, and account holder's name 807A. The transfer request also stores the bank number, branch office number, account type, account number, and account holder's name of the settlement company account 42, as information identifying the settlement company account 42, corresponding to a source account. The transfer request further stores the value of an amount based on the retained amount 903A as a transfer amount. The amount based on the retained amount 903A need not necessarily be the same as the retained amount but is, for example, the retained amount minus the charge for the settlement company.

The clearing processing unit 405A may be automatically started at any predetermined timing provided that the CPU can determine the timing. For example, the timing may be based on a temporal condition (the thirtieth day of every month, the fourth Monday of every month, the fifth, tenth, fifteenth, twentieth, twenty-fifth, and thirtieth of every month, or the like) or on the amount condition; the clearing processing unit 405A may be started when the retained amount reaches a predetermined value. The clearing processing unit 405A need not necessarily be automatically started. The present invention can be implemented even when the clearing processing unit 405A is manually operated by the administrator or operator of the electronic settlement server 10A.

The clearing processing unit 405A generates transfer requests for the respective records 901A and transmits the generated transfer request to the charge accommodating network 40A (S1402). Upon receiving the transfer requests, the charge accommodating network 40A executes the process of a transfer from the settlement company account 42 to the game hall company account 43 according to the contents of each of the transfer requests (S1403). The processing from step S1401 to step S1403 allows the total amount paid by each user as consideration for the use of the negotiable-value providing apparatus 30A to be transferred to the corresponding game hall company account 43.

Upon receiving a transfer result notification indicating the transfer process has been executed normally, the electronic settlement server 10A executes a retained amount data process of reflecting the transfer amount in the corresponding record 901A in the game hall company retained amount data 900A (S1405). The retained amount data process sets the value of the game hall company's retained amount 903A back to “zero”.

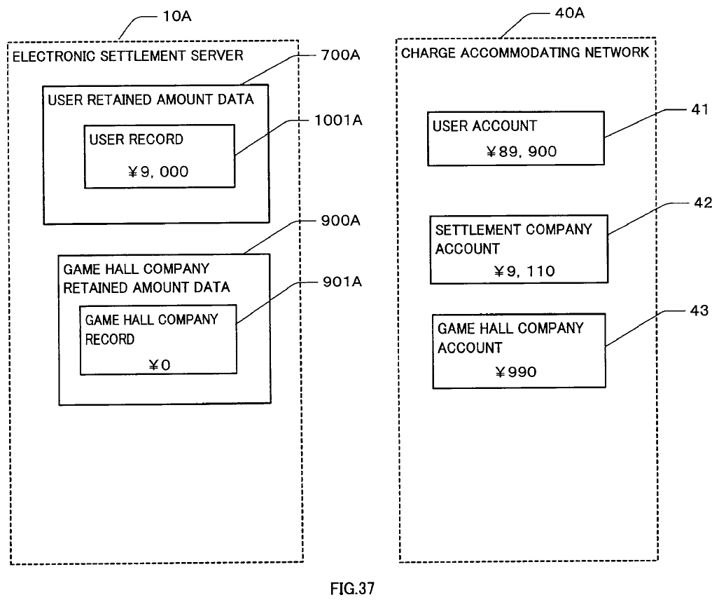

FIG. 37 is a diagram showing the storage state of the electronic settlement server 10A and the charge accommodating network 40A resulting from the processing from step S1401 to step S1405 following the state shown in FIG. 35. In the state shown in FIG. 35, the retained amount 903A in the record 901A is 1,000 yen. The clearing processing unit 405A generates a transfer request requesting that the value of the retained amount 903A minus the charge for the settlement company (for example, 10 yen), that is, 990 yen, be transferred from the settlement company account 42 to the game hall company account 43. The clearing processing unit 405A transmits the transfer request to the charge accommodating network 40A (S1402).

Upon receiving the transfer request, the charge accommodating network 40A executes a transfer process of transferring 990 yen from the settlement company account 42 to the game hall company account 43 (S1403). As a result, 10,100 yen minus 990 yen, that is, 9,110 yen, is stored in the settlement company account 42 as the balance. On the other hand, 0 yen plus 990 yen, that is, 990 yen, is stored in the game hall company account 43 as the balance. In the balance of the settlement company account 42, that is, 9,110 yen, 9,000 yen is deposited by the user, and the remaining 110 yen is the settlement company's profit. Thus, the electronic settlement company can gain a profit from the operation of the present electronic settlement system 1A.

### III. Third Embodiment

Now, a third embodiment of the present invention will be described.

### III.1. Example of Configuration of the Electronic Settlement System

The electronic settlement system 1A according to the second embodiment differs from an electronic settlement system 1A according to the second embodiment in that the former deals with payment to a plurality of different game hall companies, whereas the latter copes with payment to a single game hall company. Thus, according to the second embodiment, one electronic settlement system 1A is provided for each game hall company. However, a plurality of game halls operated by the same game hall company can be dealt with by the same electronic settlement system 1A.

Furthermore, an electronic settlement server 10A according to the third embodiment differs from the electronic settlement server according to the first embodiment in that the former eliminates the need for the clearing processing unit 405A.

Example of Configuration of the Electronic Settlement System According to the Third Embodiment

The configuration of the electronic settlement system according to the third embodiment is basically similar to that according to the second embodiment, and will thus not be described below in detail. Since the electronic settlement server 10A according to the third embodiment deals with a single game hall company, a database unit 403A of the electronic settlement server 10A need not have a game hall company table 800A or a game hall company retained amount table 900A.

### III.2. Example of Operation of the Electronic Settlement System According to the Third Embodiment

Now, an example of the operation of the electronic settlement system according to the second embodiment will be described.

Also in the electronic settlement system 1A according to the second embodiment, the user first needs to download an application such as the i appli and be registered in the electronic settlement system 1A, more specifically the electronic settlement server 10A. This processing is similar to that in the example of the operation according to the second embodiment shown in FIG. 27 to FIG. 29. Thus, the processing according to the third embodiment will not be described below in detail.

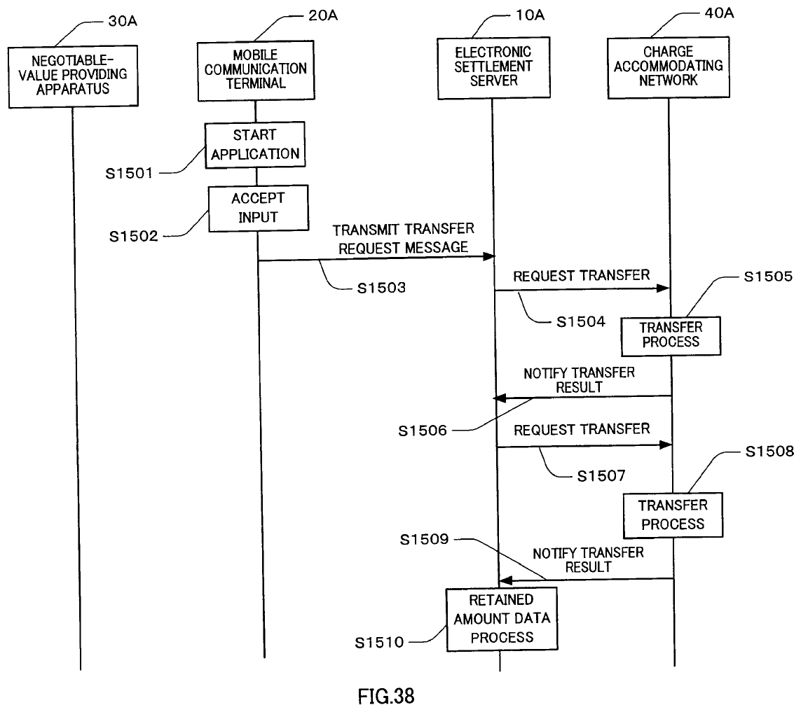

As in the case of the second embodiment, in the third embodiment, simply finishing the above-described user registration does not allow the user to make a purchase (receive a negotiable value) utilizing the electronic settlement system 1A from a negotiable-value providing apparatus 30A. The user needs to use a mobile communication terminal 20A to request the electronic settlement system 1A, more specifically the electronic settlement server 10A, to transfer an appropriate amount of the deposit in a user account 41 to a settlement company account 42. The amount consumed by the user for the negotiable-value providing apparatus 30A is subtracted from the deposit. The amount resulting from the subtraction is equal to that paid to the negotiable-value providing apparatus 30A, and is transferred to the game hall company account 43, corresponding to the recipient of the payment, as a result of processing by a charge accommodating network 40A. Now, with reference to FIG. 38, description will be given of an example of an operation performed by the electronic settlement system 1A according to the second embodiment when the user requests the electronic settlement server 10A to carry out a transfer from the user account 41, that is, the user's own account, to the settlement company account 42. FIG. 38 is a sequence diagram showing an example of an operation performed by the electronic settlement system 1A when the user requests a transfer from the user account 41 to the settlement company account 42.

First, the user uses the mobile communication terminal 20A to start an i appli, more specifically a transfer request generating unit 208 (S1501). The started i appli, more specifically the transfer request generating unit 208, allows an output unit 205 of the mobile communication terminal 20A to display an input interface screen or the like. The i appli thus urges the user to input information required for a transfer request message, for example, a transfer amount and a personal account identification number.

Upon receiving the input (S1502), the mobile communication terminal 20A, more specifically the transfer request generating unit 208, generates and transmits a transfer request message to the electronic settlement server 10A via a communication network 50 and the like (S1503). The transfer request message stores a user ID 206, a password 207, the input transfer amount and personal account identification number, and the like.

Upon receiving the transfer request message, the electronic settlement server 10A, more specifically a transfer request processing unit 404A, searches a user table 600A using the user ID 206 contained in the transfer request message as a key. The electronic settlement server 10A thus acquires a bank number 605A, a branch office number 606A, an account type 607A, an account number 608A, and an account holder's name 609A, which are the information specifying the user account 41, from a record 601A matching the user ID 206. Moreover, the electronic settlement server 10A reads another stored information (not shown in the drawings) identifying the settlement company account, that is, the bank number, branch office number, account type, and account number of the settlement company account 42. Then, based on these pieces of information, the electronic settlement server 10A generates and transmits a transfer request to the charge accommodating network 40A (S1504). A data configuration, a communication procedure, and the like for the transmission of the transfer request may comply with a scheme adopted for the charge accommodating network 40A.

Upon receiving the transfer request, the charge accommodating network 40A executes a transfer process according to the contents of the transfer request so as to transfer a specified amount (hereinafter referred to as a “user transfer amount”) from the user account 41 to the settlement company account 42 (S1505). If the transfer process (S1505) is executed normally, the charge accommodating network 40A transmits a transfer result notification to the electronic settlement server 10A to notify the electronic settlement server 10A that the transfer process has been executed normally (S1506). If the transfer process fails to be properly executed because of insufficient balance in the user account 41 or the like, the charge accommodating network 40A transmits a transfer result notification indicating the failure in the transfer to the electronic settlement server 10A.

The processing from S1501 to S1506 is similar to that from S1201 to S1206 according to the first embodiment.

After S1506, the electronic settlement server 10A, more specifically the transfer request processing unit 404A, generates and transmits a transfer request requesting a transfer of an amount corresponding to the user transfer amount from the settlement company account 42 to a game hall company account 43, to the charge accommodating network 40A (S1507).

The electronic settlement server 10A, more specifically the transfer request processing unit 404A, reads pre-stored information identifying the settlement company account 42, that is, the bank number, branch office number, account type, and account number of the settlement company account 42, and information identifying the game hall company account 43, that is, the bank number, branch office number, account type, account number, and account holder's name of the game hall company account 43. The electronic settlement server 10A generates a transfer request from the above-described pieces of information and an amount based on a user payment amount. The electronic settlement server 10A then transmits the transfer request to the charge accommodating network 40A (S1507). In the present embodiment, the “amount based on the user payment amount” refers to the amount (hereinafter referred to as the “game hall company transfer amount”) obtained by subtracting a charge to be paid to the settlement company from the user payment amount. A data configuration, a communication procedure, and the like for the transmission of the transfer request may comply with the scheme adopted for the charge accommodating network 40A.

Upon receiving the transfer request, the charge accommodating network 40A executes a transfer process according to the contents of the transfer request so as to transfer the game hall company transfer amount from the settlement company account 42 to the game hall company account 43 (S1508). If the transfer process (S1508) is executed normally, the charge accommodating network 40A transmits a transfer result notification to the electronic settlement server 10A to notify the electronic settlement server 10A that the transfer process has been executed normally (S1509).

Upon receiving the transfer result notification indicating the transfer process has been executed normally, the electronic settlement server 10A executes a retained amount data process of reflecting the user transfer amount in a corresponding record 1001A in a user retained amount data 700A (S1510). The retained amount data process allows the user to use the amount corresponding to the user transfer amount, via the electronic settlement system 1A.

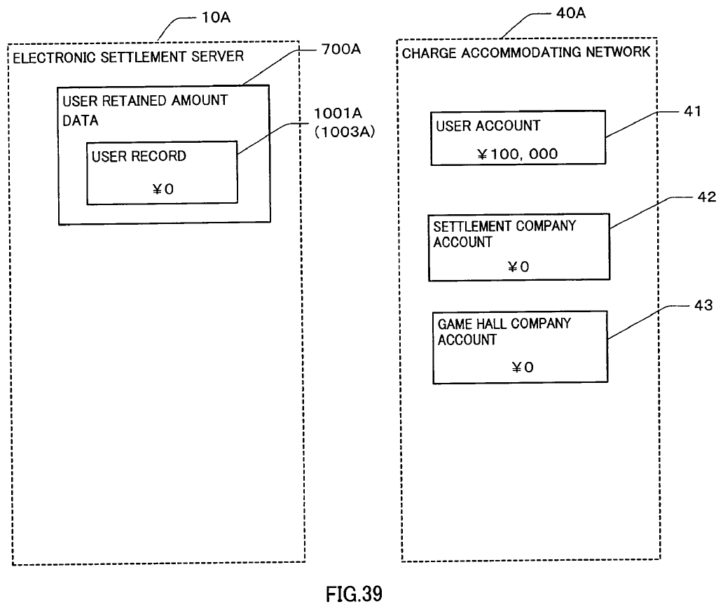

FIG. 39 to FIG. 42 are diagrams illustrating the storage state of the electronic settlement server 10A and charge accommodating network 40A according to the second embodiment observed when processing of the user transfer amount is executed between the electronic settlement server 10A and the charge accommodating network 40A.

FIG. 39 shows an example of a state observed before the user transmits a transfer request message to the electronic settlement server 10A (FIG. 38, S1503). In the example, the charge accommodating network 40A has the user account 41, the settlement company account 42, and the game hall company account 43.

It is assumed that the balance of the user account 41 is 100,000 yen and that balance of both the settlement company account 42 and the game hall company account 43 is 0 yen. In actuality, a plurality of users and a plurality of game hall companies have accounts in the charge accommodating network 40A. However, FIG. 39 to FIG. 42 show one user account 41 and one game hall company account 43 as typical examples.

As described above, the electronic settlement server 10A stores the user retained amount data 700A. However, unlike in the case of the second embodiment, in the third embodiment, the electronic settlement server 10A need not store game hall company retained amount data 900A.

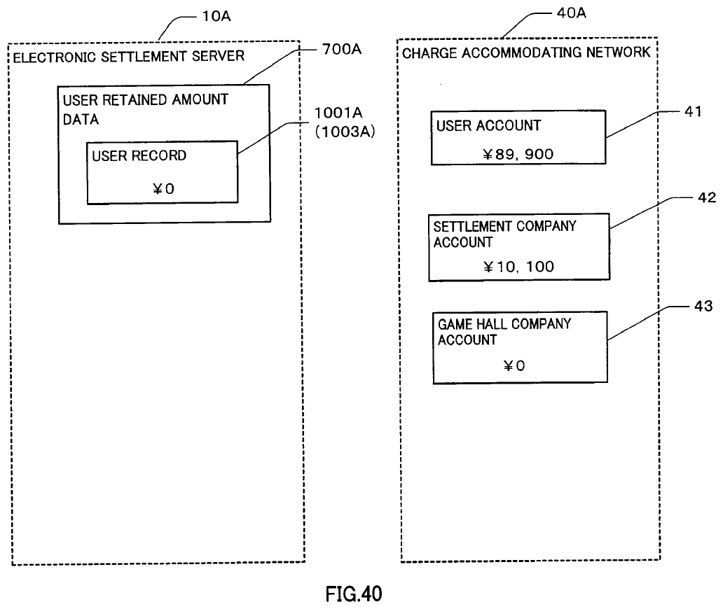

FIG. 40 shows a state observed after the user has transmitted a transfer request message from the mobile communication terminal 20A to the electronic settlement server 10A, requesting a transfer of a user transfer amount of 10,000 yen; the transmission follows the state shown in FIG. 39. In response to the transfer request message, the electronic settlement server 10A transmits the following transfer request to the charge accommodating network 40A (see S1504). The transfer request is transmitted to the charge accommodating network 40A, requesting that the user transfer amount of 10,000 yen and a charge to be paid to the settlement company (for example, 100 yen) be transferred from the user account 41 to the settlement company account 42.

Upon receiving the transfer request, the charge accommodating network 40A executes a process of transferring 10,100 yen from the user account 41 to the settlement company account 42 (see S1505). As a result, as shown in FIG. 40, the balance of the user account 41 is 100,000 yen-10,100 yen=89,900 yen. The balance of the settlement company account 42 is 0 yen+10,100 yen=10,100 yen. The charge accommodating network 40A changes the balances of the accounts 41 and 42 as described above according to the transfer request.

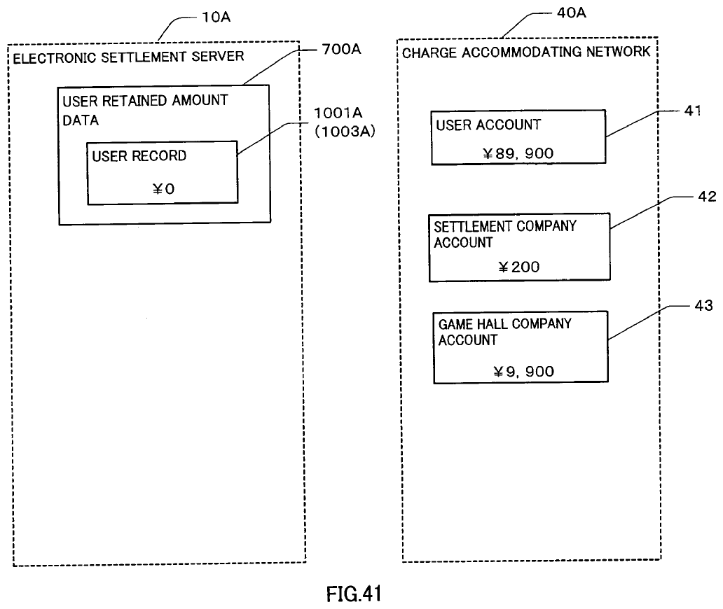

FIG. 41 shows a state observed after the electronic settlement server 10A has transmitted a transfer request for a transfer of the transfer amount to the game hall company account 43, to the charge accommodating network 40A (S1507) and the charge accommodating network 40A has executed a transfer process (S1508) corresponding to the transfer request; the transmission and execution follow the state shown in FIG. 40.

The electronic settlement server 10A transmits the following transfer request requesting a transfer of the transfer amount to the game hall company account 43 to the charge accommodating network 40A (see S1507). The transfer request is transmitted to the charge accommodating network 40A, requesting that a game hall company transfer amount (10,000 yen-100 yen=9,900 yen) corresponding to the user transfer amount of 10,000 yen minus the charge to be paid to the settlement company (for example, 100 yen) be transferred from the settlement company account 42 to the game hall company account 43.

Upon receiving the transfer request, the charge accommodating network 40A executes a process of transferring 9,900 yen from the settlement company account 41 to the game hall company account 43 (see S1508). As a result, as shown in FIG. 41, the balance of the settlement company account 42 is 10,100 yen-9,900 yen=200 yen. The balance of the game hall company account 43 is 0 yen+9,900 yen=9,900 yen. The balance of the user account 41 remains to be 89,900 yen. The charge accommodating network 40A changes the balances of the accounts 41 and 42 according to the transfer request as described above.

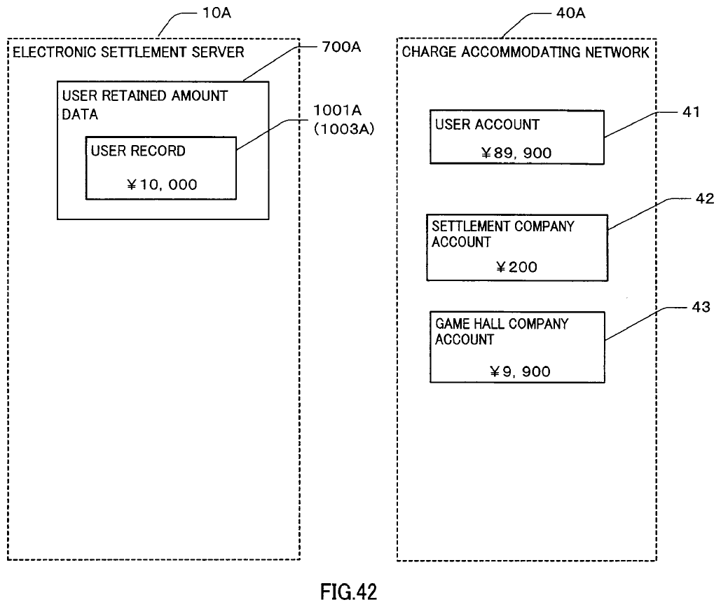

FIG. 42 is a diagram showing the storage state of the electronic settlement server 10A and the charge accommodating network 40A resulting from execution of a retained amount data process (S1510) by the electronic settlement server 10A following the state shown in FIG. 41. As shown in FIG. 38, after executing the transfer process (S1508), the charge accommodating network 40A transmits a transfer result notification indicating that the game hall company transfer amount has been transferred normally, to the electronic settlement server 10A (S1509).

In response to the transfer result notification, the electronic settlement server 10A, more specifically the transfer request processing unit 404A, executes a retained amount data process (S1510) of adding the user transfer amount to the user retained amount stored in the record 1001A corresponding to the user account 41 subjected to the transfer. However, 100 yen, corresponding to the charge, is not added. As a result of the retained amount data process (S1510) based on the addition, 0 yen+10,000 yen=10,000 yen is recorded in the record 1001A. The 10,000 yen is the amount that the user can use via the electronic settlement system 1A.

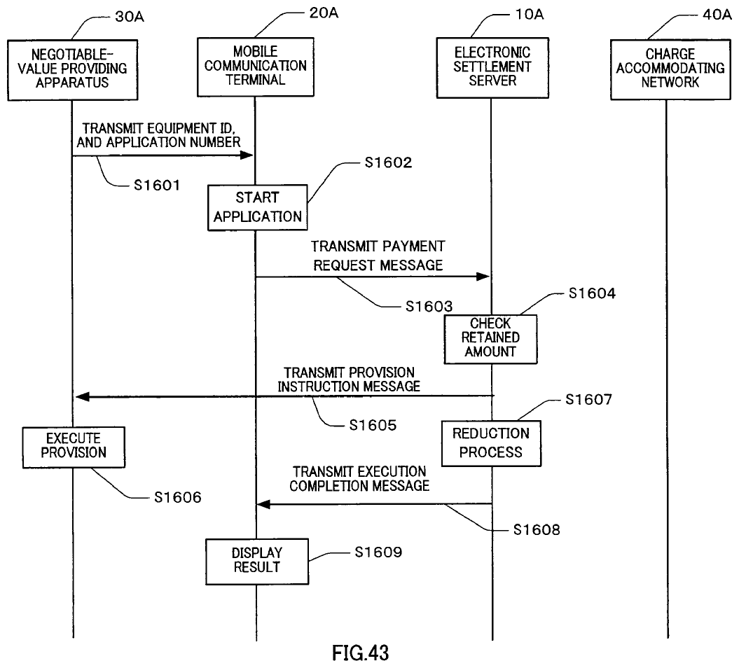

Now, with reference to FIG. 43, description will be given of an example of an operation performed by the electronic settlement system 1A when the user attempts to obtain a negotiable value from the negotiable-value providing apparatus 30 in the electronic settlement system 1A according to the third embodiment. FIG. 43 is a sequence diagram showing an example of an operation performed by the electronic settlement system 1A when the user allows the mobile communication terminal 20A and the negotiable-value providing apparatus 30A to communicate via short-distance communication means in order to obtain a negotiable value from the negotiable-value providing apparatus 30A.

It is assumed that the user first attempts to obtain a negotiable value from the negotiable-value providing apparatus 30A utilizing the present electronic settlement system 1A.

In this case, the user allows the mobile communication terminal 20A and the negotiable-value providing apparatus 30A to carry out short-distance communication so that the mobile communication terminal 20A can acquire the equipment ID and the like of the negotiable-value providing apparatus 30A. For example, it is assumed that a terminal-side short-distance communication unit 201 is an IC chip for non-contact IC cards and that a providing apparatus-side short-distance communication unit 303 is a reader/writer. Then, upon sensing that the chip for non-contact IC cards is nearby, the reader/writer, serving as the providing apparatus-side short-distance communication unit 303, transmits the equipment ID, an application number, and a user payment amount, which are all stored in the reader/writer, to the chip for non-contact IC cards, serving as the terminal-side short-distance communication unit 201 (S1601). Here, the equipment ID is identification information allowing the negotiable-value providing apparatus 30A to be uniquely identified. The application number is identification information uniquely identifying the application such as the i appli which operates in the mobile communication terminal 20A. The user payment amount is information indicative of the value of consideration for the negotiable value provided to the user by the negotiable-value providing apparatus 30A. When the purchase of a negotiable value is requested via the mobile communication terminal 20A, the negotiable-value providing apparatus 30A considers the request to be a purchase request for a negotiable value for a pre-specified payment amount. For example, if the negotiable-value providing apparatus 30A is a ball renting machine, the user moves the mobile communication terminal 30 closer to the ball renting machine to allow the ball renting machine to read data from the chip for non-contact IC cards. Then, the negotiable-value providing apparatus 30A considers the request to be a purchase request for rental balls for a payment amount (for example, 1,000 yen) specified for the negotiable-value providing apparatus 30A. The user payment amount may vary with the negotiable-value providing apparatus 30A. For example, the payment amount may be set to 1,000 yen for a ball renting machine A installed in the game hall and to 2,000 yen for another ball renting machine B installed in the same game hall. Alternatively, the user payment amount may be selectively determined by the user. For example, if the negotiable-value providing apparatus 30A is a prepaid card issuing apparatus, the prepaid card issuing apparatus can issue prepaid cards for a plurality of different amounts (for example, 1,000 yen, 3,000 yen, 5,000 yen, and 10,000 yen), and has a plurality of amount determination buttons used to specify the respective amounts. The user depresses the amount determination button for the desired amount to buy the prepaid card for the desired amount. In this case, the amount selected by the user via the amount determination button may be considered by the electronic settlement system 1A to be the user payment amount.

The above-described user payment amount need not necessarily be transmitted from the negotiable-value providing apparatus 30A to the mobile communication terminal 20A in step S1601. The payment amount may be determined by the electronic settlement server 10A based on the equipment ID using a prepared table.

Upon receiving the equipment ID, the application number, and the payment amount, the terminal-side short-distance communication unit 201 starts the application such as the i appli which corresponds to the application number, that is, a payment request generating unit 202 (S1602). At this time, the equipment ID and the user payment amount are passed from the terminal-side short-distance communication unit 201 to the payment request generating unit 202.

The started payment request generating unit 202 generates a payment request message containing the equipment ID and user payment amount received from the negotiable-value providing apparatus 30A and a user ID 206 and a password 207 stored in a user information storage unit 207. The payment request generating unit 202 then transmits the payment request message to the electronic settlement server 10A (S1603).

In step S1604, upon determining that the user payment amount cannot be withdrawn, a payment request processing unit 402A starts a result notifying unit 407A. The result notifying unit 407A generates and transmits a processing result notification based on the determination to the negotiable-value providing apparatus 30A and/or the mobile communication terminal 20A. Upon receiving the processing result notification, the mobile communication terminal 20A displays the contents of the processing result notification on the output unit 205 thereof. The contents of the processing result notification are, for example, “Short balance. Settlement has failed.”

On the other hand, upon determining in step S1604 that the user payment amount can be withdrawn, the payment request processing unit 402A starts a provision instructing unit 406A. The started provision instructing unit 406A transmits a provision instruction message to the negotiable-value providing apparatus 30A (S1605). The provision instruction message contains the payment amount. The negotiable-value providing apparatus 30A provides the user with a negotiable value corresponding to the payment amount (S1606). The destination address of the provision instruction message is determined based on an equipment IP address 1003 in a corresponding record 1001 obtained by searching a negotiable-value providing apparatus table 1000A using the equipment ID as a key.

Furthermore, upon determining in step S1604 that the user payment amount can be withdrawn, the payment request processing unit 402A rewrites the user retained amount data 700A, more specifically the retained amount 1003 in the record 1001 with the corresponding user ID so as to reduce the retained amount 1003 by the payment amount (S1607).

Furthermore, upon determining in step S1604 that the user payment amount can be withdrawn, the electronic settlement server 10A, more specifically the payment request processing unit 402A, starts a result notifying unit 407A. The started result notifying unit 407A transmits an execution completion message notifying the mobile communication terminal 20A that the specified payment amount has been paid (S1608). The execution completion message indicates that a payment procedure corresponding to the user's specified payment amount has ended. The destination address of the execution completion message is determined based on a mail address 604A in a corresponding record 601A obtained by searching a user table 600A using the user ID as a key.

Upon receiving the execution completion message, the mobile communication terminal 20A allows the output unit 205 to provide a result display corresponding to the contents of the execution completion message (S1609). For example, as the result display, the output unit 205 of the mobile communication terminal 20A shows the message “1,000 yen has been paid from XX's retained amount”. Alternatively, during the result display, the value of the retained amount 1003A resulting from the withdrawal of the payment amount, that is, the balance in the electronic settlement server 10A, may be displayed. However, the retained amount 1003A is not stored in the mobile communication terminal 20A. The electronic settlement server 10A stores the retained amount 1003A.

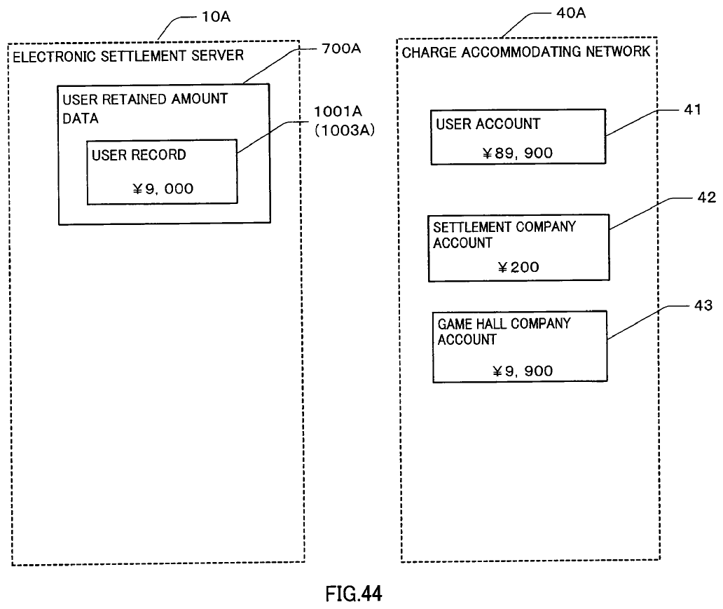

FIG. 44 is a diagram showing the storage state of the electronic settlement server 10A and the charge accommodating network 40A resulting from execution of the processing from step S1601 to step S1607 following the state shown in FIG. 42. In the state shown in FIG. 42 and in which the transfer of the payment amount has not been carried out yet, the retained amount 1003A in the corresponding record 1001A in the user retained amount data 700A is 10,000 yen.

FIG. 44 shows a state observed after the transfer process (S1607) has been executed if the payment amount is 1,000 yen. In the transfer process (S1607), the payment request processing unit 402 of the electronic settlement server 10A subtracts the payment amount of 1,000 yen from 10,000 yen, that is, the value of the retained amount 1003A, corresponding to the user's retained amount, to rewrite the value of the retained amount 1003A to 9,000 yen.

The rewriting of the retained amount 1003A based on the transfer process (S1607) allows the electronic settlement server 10A to pay consideration for the provision of a negotiable value by the negotiable-value providing apparatus 30A, that is, allows the user to pay to the game hall company.

The processing from step S1601 to step S1609 described above is executed every time each user buys a negotiable value utilizing the negotiable-value providing apparatus 30A. However, unlike in the case of the second embodiment, each user's payment amount is not added or recorded as the retained amount of the corresponding game hall company. Furthermore, unlike the second embodiment, the third embodiment eliminates the need to transfer the retained amount 903A of the game hall company to the game hall company account 43 on the charge accommodating network 40A according to a transfer request from the electronic settlement server 10A. That is, the third embodiment eliminates the need for a transfer to the game hall company account 43 in the electronic settlement system 1A as shown in FIG. 36 (see S1401 to S1405).

### IV. Variations and Others

Variations of the second and third embodiments will be described below.

(1) QR codes or the like may be displayed on a liquid crystal display provided in the negotiable-value providing apparatus 30A. Furthermore, a bar code reader utilizing a CCD camera may be provided in the mobile communication terminal 20A to read bar codes. These arrangements replace the providing apparatus-side short-distance communication unit 303 and the terminal-side short-distance communication unit 201. In this case, information indicated by the bar code may directly be the equipment ID.

(2) In the above-described first and second embodiments, for a transfer from the user account 41 to the settlement company account, a transfer request is transmitted from the mobile communication terminal 20A to the charge accommodating network 40A via the electronic settlement server 10A. However, the present invention can be implemented even when the transfer request is transmitted from the mobile communication terminal 20A directly to the charge accommodating network 40A.

### V. Advantages of the Present Electronic Settlement System

(1) Advantages for the User

The present settlement method is different from cash payment and can be used in game halls. Thus, even when running short of cash in hand in a game hall, the user can buy rental balls, rental medals, any product, or the like by an easy settlement action (a process of performing such an easy input operation as holds the mobile communication terminal 20A over the negotiable-value providing apparatus 30A).

While playing games, the user may hit a bull's eye with no or little cash in hand but be likely to run short of balls or medals in hand. In this case, the user can additionally buy rental balls or the like by an easy operation. The user can thus feel secure to continue games without worrying about the cash balance.

Furthermore, the user can feel secure to carry out the settlement action because the user's mobile communication terminal is used for the settlement action. The user can further feel secure to settle the account because of the non-need to input the card number or the personal identification number, preventing the record of the card number or the personal identification number from remaining in the shop or being unfairly acquired by a malicious person as is the case with ordinary credit and debit cards.

Furthermore, information distribution is available which is based on usage information acquired by the electronic settlement server 10A. Thus, more various services are expected to be available.

(2) Advantages for the Shop (Administrator)

Even when running short of cash in hand as a result of playing games, the user can further buy rental balls or rental medals via the present electronic settlement system. This increases the operation rate of the game machines and the possibility that such users make a purchase in the shop. Thus, the sales of the game hall are expected to increase. Furthermore, information is available which indicates the game machines on which the user has played and the amount of money for which the user has played. Consequently, based on the information, the operation status of the game machines can be determined in detail, and the user's preferences can also be known. Therefore, the information can be utilized for marketing.

The use of the present electronic settlement system avoids increasing cash used in the shop. This facilitates credit management and improves security management.

(3) Advantages for the Settlement Company

The operation of the present electronic settlement system enables the settlement company to determine the playing statuses of players who are users. The settlement company can thus accumulate data to be referenced for the development, sale, marketing, or the like of game machines.

(4) The present invention can be implemented regardless of whether the authentication server 90, serving as the certification agency (CA), is another company's server commonly used or a server constructed by the settlement company.

### VI. Fourth Embodiment

Now, a fourth embodiment of the present invention will be described. The fourth embodiment has a configuration and functions basically similar to those of the second or third embodiment. The fourth embodiment is further characterized by having the function of adding casino chips in hand or the amount, level, or cash stored in a prepaid card, an IC card, or the like to a user retained amount 1003A stored in an electronic settlement server 10A. This addition is carried out using a terminal apparatus that can communicate with the electronic settlement server. The terminal apparatus is the user's mobile communication terminal or a computer installed at an appropriate location such as a casino reception desk.

In the fourth embodiment, the above-described function allows the present electronic settlement system to hold remaining casino chips or the remaining amount, level, or the like in the prepaid card instead of the user if the user ends or suspends the game. The user's convenience is thus improved.

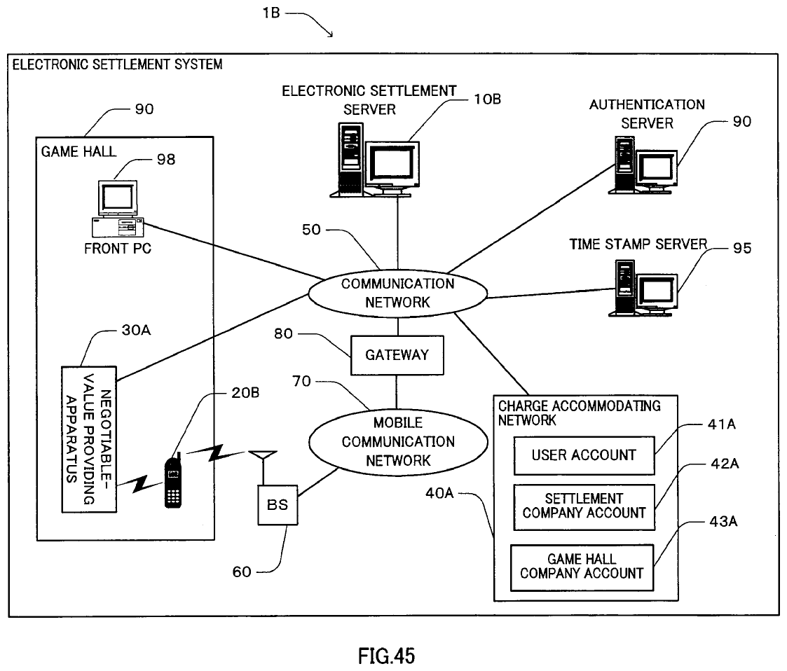

FIG. 45 shows an example of the configuration of the electronic settlement system according to the fourth embodiment. An electronic settlement system 1B according to the fourth embodiment is different from the electronic settlement system 1A (see FIG. 17) according to the second and third embodiments in that the electronic settlement system 1B further has a computer 98 configured to request an electronic settlement server 10B to carry out addition (credit). Furthermore, the configurations of the electronic settlement server 10B and a mobile communication terminal 10B are different from those of the electronic settlement servers 10A and mobile communication terminals 10A according to the second and third embodiments. The mobile communication terminal 10B has functions similar to those of the mobile communication terminal 10A and the function of serving as a terminal apparatus configured to request the electronic settlement server 10B to carry out an addition (credit).

The computer 98 is an apparatus having the function of communicating with the electronic settlement server 10B. The computer 98 includes a central processing unit (CPU), a main memory (RAM), a read only memory (ROM), an I/O device (I/O), and an external storage device such as a hard disk device as required.

Upon receiving a request for an addition (credit) from a user (player), the operator of the computer 98 checks the amount, level, or the like to be added (credited). For example, for a request for an addition (credit) of casino chips, the operator performs, for example, an operation of counting casino chips. Furthermore, for a request for an addition (credit) with a prepaid card, the operator reads the remaining amount using a separately prepared prepaid card reading apparatus. Additionally, if the remaining amount in the prepaid card is managed by a managing apparatus such as a hall computer, the operator reads the ID number of the card instead of the remaining amount.

Then, the operator inputs information (for example, a user ID) identifying the user and information indicating the amount, level, or the like to be added, to the computer 98. The computer 98 executes an addition (credit) process to generate a message requesting an addition of a value corresponding to information indicative of the amount, level, or the like to be added to the value of the user retained amount 1003A in a user record 1001A corresponding to the information identifying the user. The computer 98 then transmits the message to the electronic settlement server 10B via a communication network 50.

Upon receiving the message, the electronic settlement server 10B executes a process of adding the value corresponding to the information indicative of the amount, level, or the like to be added to the value of the user retained amount 1003A in the user record 1001A corresponding to the information identifying the user.

Now, the mobile communication terminal 20B according to the fourth embodiment will be described. As described above, the mobile communication terminal 20B functions as the mobile communication terminals 20A according to the second and third embodiments. The mobile communication terminal 20B further has the function of generating a message requesting an addition of the value corresponding to information indicative of the amount, level, or the like to be added to the value of the user retained amount 1003A in the user record 1001A and transmitting the message to the electronic settlement server 10B via the communication network 50, similarly to the above-described computer 98. The information indicative of the amount, level, or the like to be added need not directly indicate the amount, level, or the like but may be information that can be used as a search key to acquire information directly indicating the amount, level, or the like. For example, the IC number of the prepaid card may be the “information indicating the amount, level, or the like” as used herein. In this case, upon receiving the ID number of the prepaid card or the like, the electronic settlement server 10B may inquire of the managing apparatus (for example, a casino hall computer) managing the remaining amount in the prepaid card, about the remaining amount corresponding to the ID number of the prepaid card. The electronic settlement server 10B may then execute an addition (credit) process using the remaining amount transmitted in response to the inquiry as the amount or level.

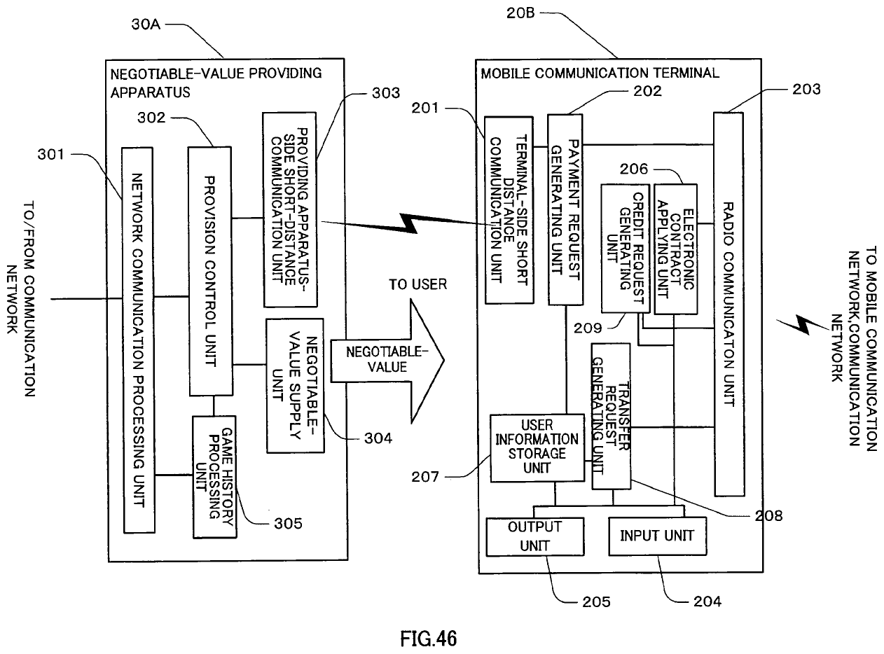

FIG. 46 shows an example of the configuration of the mobile communication terminal 20B according to the fourth embodiment. The configuration of the negotiable-value providing apparatus 30A is the same as those according to the second and third embodiments. Furthermore, the same components as those of the mobile communication terminal 20A (see FIG. 19) are denoted by the same reference numerals and will thus not be described below in detail.

The mobile communication terminal 20B has a terminal-side short-distance communication unit 201, a payment request generating unit 202, a radio communication unit 203, an input unit 204, an output unit 205, a user information storage unit 207, a transfer request generating unit 208, an electronic contract applying unit 206, and a credit request generating unit 209.

Based on information input via an output unit 204 and identifying the user and information also input via the input unit 204 and indicating an amount, a level, or the like to be added, the credit request generating unit 209 generates a message requesting an addition of a value corresponding to the information indicative of the amount, level, or the like to be added to the value of the user retained amount 1003A in the user record 1001A corresponding to the information identifying the user. The generated request message is passed to the radio communication unit 203, which then transmits a radio signal modulated based on the request message.

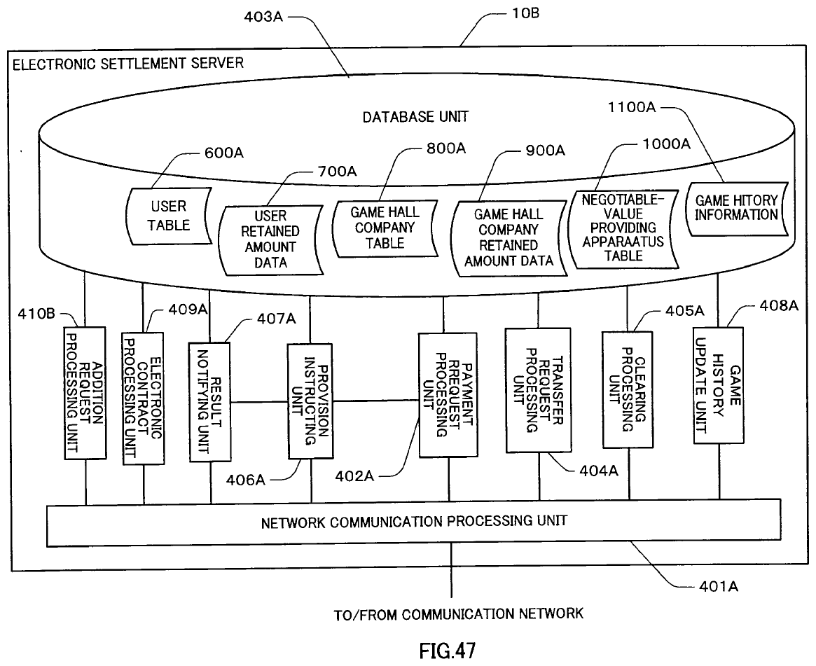

Now, the electronic settlement server 10B according to the fourth embodiment will be described. FIG. 47 is a diagram showing an example of the configuration of the electronic settlement server 10B in the fourth embodiment. The electronic settlement server 10B includes the components of the electronic settlement servers 10A according to the second and third embodiments and further includes a credit request processing unit 410B. The same components as those of the electronic settlement server 10A according to the second and third embodiments are denoted by the same reference numerals and will thus not be described below in detail.

The addition request processing unit 410B acquires a message requesting an addition from the computer 98 or the mobile communication terminal 20B via a network communication processing unit 401A. Upon receiving the message, the addition request processing unit 410B searches user retained amount data 700A and adds a value corresponding to information indicative of an amount, a level, or the like to be added, to the value of the user retained amount 1003A in the user record 1001A corresponding to information contained in the message and identifying the user. The addition request processing unit 410B then allows the result of the addition to be stored.

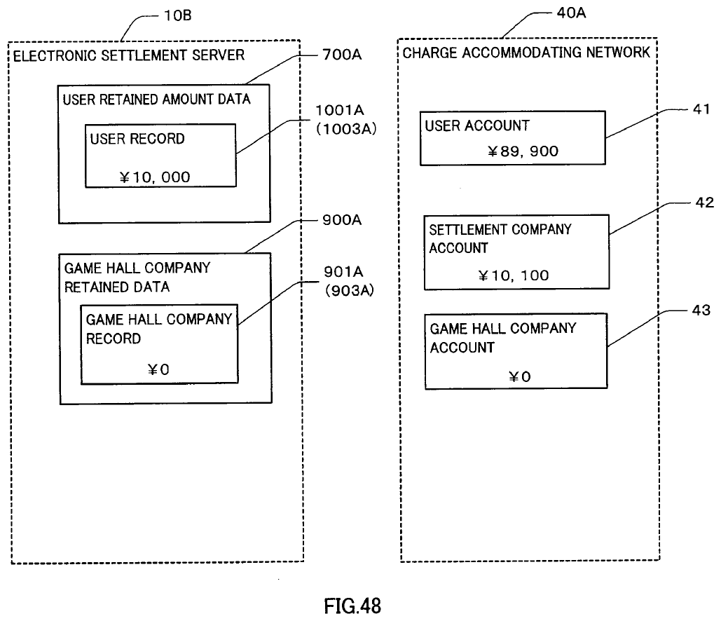

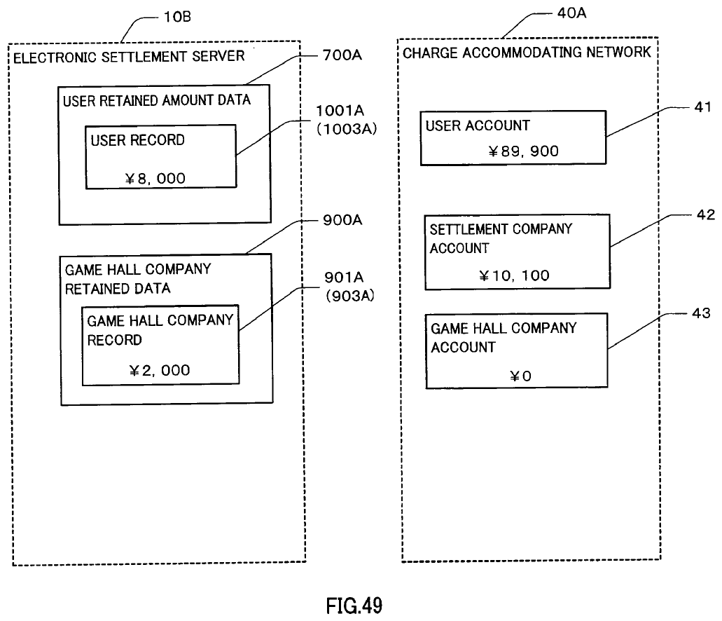

Now, a specific example of an addition process in the electronic settlement system 10B according to the fourth embodiment based on the second embodiment will be described. FIGS. 48 and 49 are diagrams showing an example of an addition process in the electronic settlement system 1B according to the fourth embodiment based on the second embodiment.

FIG. 48 shows that “10,000 yen” is stored in the electronic settlement server 10B as the user retained amount 1003A. The other conditions are similar to those described with reference to FIG. 33.

It is assumed that in this state, the user is provided with 2,000 yen of prepaid card by the negotiable-value providing apparatus 30A. FIG. 49 shows an example of the stored contents of the electronic settlement server 20B and a charge accommodating network 40A obtained after the user has acquired 2,000 yen of prepaid card. The user retained amount 1003A has been rewritten from “10,000 yen” to “8,000 yen”, obtained by subtracting 2,000 yen from the 10,000 yen. Furthermore, a game hall company retained amount 903A has been rewritten from “0 yen” to “2,000 yen”.

It is assumed that the user having acquired the 2,000 yen of prepaid card then spends 1,000 yen, ends playing games, and then in order to return the remaining amount of 1,000 yen to the electronic settlement system 1B, requests the electronic settlement server 10B to add 1,000 yen, via the computer 98 or the mobile communication terminal 20B.

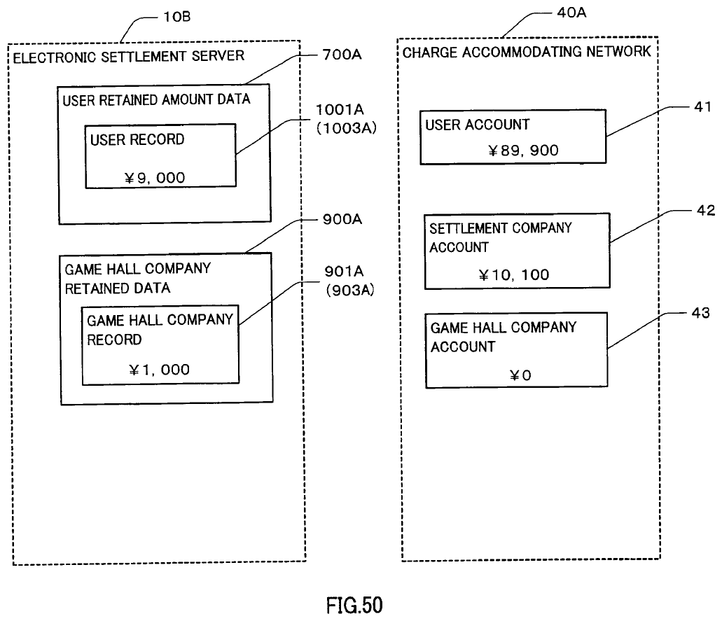

Upon receiving the message transmitted by the computer 98 or the mobile communication terminal 20B and requesting an addition of 1,000 yen, the electronic settlement server 10B, more specifically the addition request processing unit 410B, rewrites the user retained amount 1003A and the game hall company retained amount 903A according to the contents of the request message. FIG. 50 shows an example in which the user retained amount 1003A and the game hall company retained amount 903A have been rewritten according to the contents of the request message. The user retained amount 1003A has been rewritten to “9,000 yen”, obtained by adding 1,000 yen to “8,000 yen”. Furthermore, the game hall company retained amount 903A has been rewritten from 2,000 yen to 1,000 yen.

The above-described processing enables the user to reuse the negotiable value the user has not spent, later via the electronic settlement system 1B.

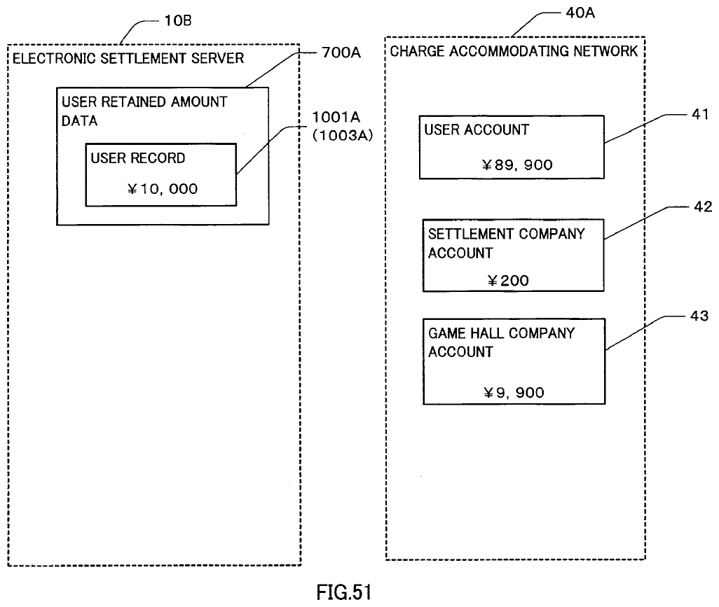

Now, a specific example of an addition process in the electronic settlement system 1B according to the fourth embodiment based on the third embodiment will be described. FIG. 51 to FIG. 53 are diagrams showing an example of an addition process in the electronic settlement system 1B according to the fourth embodiment based on the third embodiment.

FIG. 51 shows that “10,000 yen” is stored in the electronic settlement server 10B as the user retained amount 1003A. The other conditions are similar to those described with reference to FIG. 42.

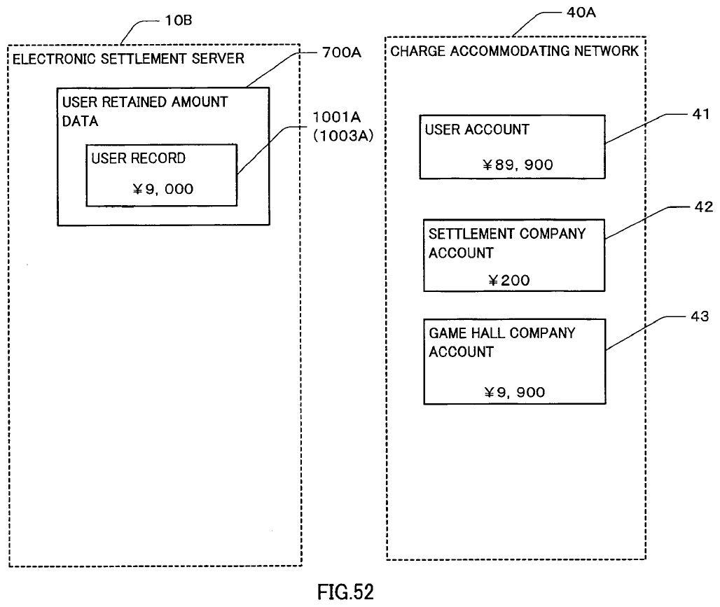

It is assumed that in this state, the user is provided with 1,000 yen of prepaid card by the negotiable-value providing apparatus 30A. FIG. 52 shows an example of the stored contents of the electronic settlement server 20B and the charge accommodating network 40A obtained after the user has acquired 1,000 yen of prepaid card. The user retained amount 1003A has been rewritten from “10,000 yen” to “9,000 yen”, obtained by subtracting 1,000 yen from the 10,000 yen.

It is assumed that the user having acquired the 1,000 yen of prepaid card then spends 500 yen, ends playing games, and then in order to return the remaining amount of 500 yen to the electronic settlement system 1B, requests the electronic settlement server 10B to add 500 yen, via the computer 98 or the mobile communication terminal 20B.

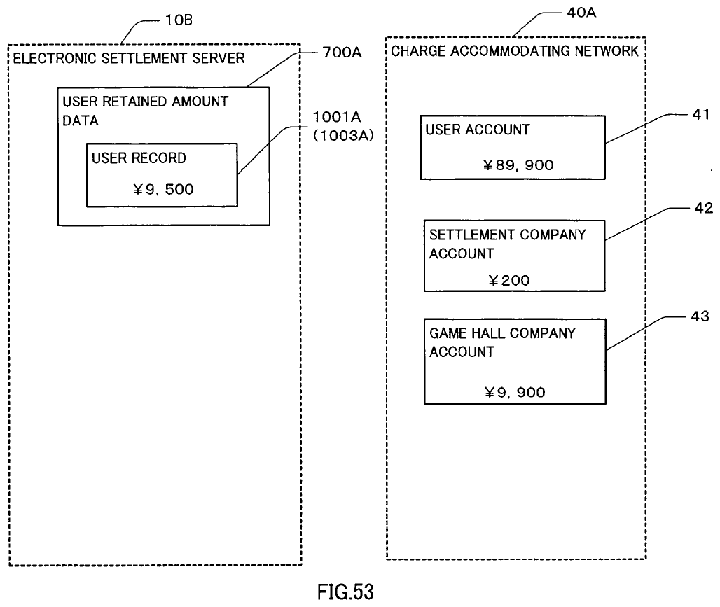

Upon receiving the message transmitted by the computer 98 or the mobile communication terminal 20B and requesting an addition of 500 yen, the electronic settlement server 10B, more specifically the addition request processing unit 410B, rewrites the user retained amount 1003A according to the contents of the request message. FIG. 53 shows an example in which the user retained amount 1003A has been rewritten according to the contents of the request message. The user retained amount 1003A has been rewritten to “9,500 yen”, obtained by adding 500 yen to “9,000 yen”.

The above-described processing enables the user to reuse the negotiable value the user has not spent yet, later via the electronic settlement system 1B.

The fourth embodiment may be varied similarly to the first to third embodiments.

What is claimed is:

1. A negotiable-value providing apparatus transmitting equipment identification information identifying the negotiable-value providing apparatus to a mobile communication terminal, and upon receiving a provision instruction message transmitted in response to a settlement request message containing user identification information identifying a user, a transfer amount corresponding to consideration for a negotiable value, and the equipment identification information, providing the negotiable value corresponding to the transfer amount.

2. A mobile communication terminal acquiring equipment identification information identifying a negotiable-value providing apparatus, from the negotiable-value providing apparatus, generating a settlement request message containing user identification information identifying a user, a transfer amount corresponding to consideration for provision of a negotiable value, and the equipment identification information, transmitting the settlement request message to an electronic settlement server, and according to a result of a check of a credit status of the user carried out by the electronic settlement server, allowing the electronic settlement server to transmit, to the negotiable-value providing apparatus, a provision instruction message instructing the negotiable-value providing apparatus to provide a negotiable value corresponding to the transfer amount.

3. The mobile communication terminal according to claim 2, further comprising, in response to one operation, a process of determining the transfer amount specified as consideration for the negotiable value and a process of carrying out the settlement request requesting provision of the negotiable value corresponding to the transfer amount.

4. A mobile communication terminal carrying out communication via short-distance communication means to acquire equipment identification information identifying a negotiable-value providing apparatus from the negotiable-value providing apparatus, generating a payment request message containing user identification information identifying a user and the equipment identification information, and transmitting the payment request message to an electronic settlement server to allow the electronic settlement server to instruct the negotiable-value providing apparatus to provide a negotiable value corresponding to a user payment amount.
